(19) United States
(12) Patent Application Publication
(10) Pub. No.: US 2014/0057060 A1
(43) Pub. Date: Feb. 27, 2014

(54) POLARIZING PLATE AND LIQUID CRYSTAL DISPLAY DEVICE

(71) Applicant: FUJIFILM Corporation, Tokyo (JP)

(72) Inventors: Nobutaka FUKAGAWA, Kanagawa (JP); Yu NAITO, Kanagawa (JP); Akio TAMURA, Kanagawa (JP); Yutaka NOZOE, Kanagawa (JP)

(73) Assignee: FUJIFILM Corporation, Tokyo (JP)

(21) Appl. No.: 13/973,538

(22) Filed: Aug. 22, 2013

(30) Foreign Application Priority Data
Aug. 23, 2012 (JP) 2012-184372
Jun. 21, 2013 (JP) 2013-131162

(51) Int. Cl. G02F 1/1335

(52) U.S. Cl. CPC G02F 1/133528
USPC 428/1.31

(57) ABSTRACT

A polarizing plate includes, in the following order: a transparent protective film; an adhesive layer; and a polarizer, and the transparent protective film has a thickness of from 5 to 60 μm and contains at least one resin and a compound (A) having at least one hydrogen bond-forming hydrogen-donating group and a ratio of a molecular weight to an aromatic ring number of 190 or less.

### CROSS-REFERENCE TO RELATED APPLICATIONS

This application claims the benefits of Japanese Patent Application JP 2012-184372, filed Aug. 23, 2012 and Japanese Patent Application JP 2013-131162, filed Jun. 21, 2013, the entire contents of which are hereby incorporated by reference, the same as if set forth at length.

### FIELD OF THE INVENTION

The present invention relates to a polarizing plate and a liquid crystal display device. In particular, it relates to a polarizing plate which is excellent in polarizer durability even in a high temperature and high humidity environment, has a small amount of curl and hardly causes warp or distortion of a liquid crystal panel and display unevenness resulting therefrom depending on usage environment, when assembled in a liquid crystal display device, and a liquid crystal display device.

### BACKGROUND OF THE INVENTION

A liquid crystal display device has been used widely more and more year by year as a space-saving image display device having low power consumption. With the expansion of the market for so-called mobile usage, for example, mobile phone or tablet PC, in addition to the market in which an image of high definition is required, for example, TV, the need for reduction in thickness of the device has been increased more and more.

The basic constitution of liquid crystal display device comprises polarizing plates disposed on the both sides of a liquid crystal cell. Since the polarizing plate takes a role for passing only light of polarization in the definite direction, the performance of liquid crystal display device is greatly influenced with the performance of the polarizing plate. The polarizing plate ordinarily has a constitution of a polarizer comprising, for example, a polyvinyl alcohol film in which iodine or a dye is adsorbed and oriented and transparent protective films stacked on the front and rear sides of the polarizer. As the protective film for polarizing plate, a protective film for polarizing plate of cellulose acylate which is typified by cellulose acetate is widely employed because it has high transparency and can easily ensure an adhesion property to polyvinyl alcohol which is used as the polarizer.

In recent years, with the reduction in thickness of the liquid crystal display device, the need for reduction in thickness on respective members has been increased.

In response thereto, a method of reducing the thickness of polarizing plate by disposing a protective film for polarizing plate only on one side of the polarizing film is disclosed in JP-A-2009-251177 (the term “JP-A” as used herein means an “unexamined published Japanese patent application”) or JP-A-2010-9027.

### SUMMARY OF THE INVENTION

However, it has been found according to the investigations by the inventors that the polarizing plate described in JP-A-2009-251177 and JP-A-2010-9027 has the certain effect of improving the display unevenness, but degradation of display quality in the case where the polarizing plate is used in a high temperature and high humidity environment for a long period of time. Further, it has been found that when the protective film for polarizing plate is disposed on only one surface of the polarizing film, since an amount of curl of the polarizing plate increases, the warp of a liquid crystal panel increases and the display unevenness is apt to occur, when the polarizing plate is assembled in a liquid crystal display device.

In short, a polarizing plate, in case it is formed with a protective film whose thickness is decreased, wherein the deterioration of the polarizer performance under high temperature and high humidity is inhibited and the warp of a liquid crystal panel and the display unevenness resulting from such warp can be improved when the polarizing plate is assembled in a liquid crystal display device, has not been known so that further improvements of the performance of a polarizing plate has been needed.

An object of the present invention is to provide a polarizing plate which is excellent in polarizer durability even in a high temperature and high humidity environment and hardly causes warp or distortion of a liquid crystal panel and display unevenness resulting therefrom depending on usage environment, when assembled in a liquid crystal display device, and a liquid crystal display device.

As a result of the intensive investigations to solve the problems described above, the inventors have found that a polarizing plate in which the polarization performance is hardly deteriorated even when stored in a high temperature and high humidity environment can be obtained by setting a thickness of protective film for polarizing plate from 5 to 60 μm and incorporating into the protective film for polarizing plate an additive having at least one hydrogen bond-forming hydrogen-donating group and a ratio of molecular weight/aromatic ring number of 190 or less.

Specifically, the problems described above are solved by the constitutions described below.

(1) A polarizing plate having a transparent protective film through an adhesive layer on only one surface of a polarizer, wherein the transparent protective film has a thickness from 5 to 60 μm and contains at least one resin and a compound (A) having at least one hydrogen bond-forming hydrogen-donating group and a ratio of molecular weight/aromatic ring number of 190 or less.
(2) The polarizing plate as described in (1) above, wherein an aromatic ring in the compound (A) is a hydrocarbon aromatic ring.
(3) The polarizing plate as described in (1) or (2) above, wherein the compound (A) is a compound represented by formula (1) shown below.

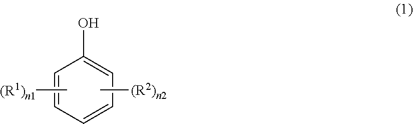

In formula (1), R¹ represents a substituent, R² represents a substituent represented by formula (1-2) shown below, n1 represents an integer from 0 to 4, when n1 represents 2 or more, plural R¹s may be the same or different from each other, and n2 represents an integer from 1 to 5, when n2 represents 2 or more, plural R²s may be the same or different from each other.

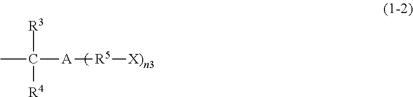

In formula (1-2), A represents a substituted or unsubstituted aromatic ring, R³ and R⁴ each independently represents a hydrogen atom, an alkyl group having from 1 to 5 carbon atoms or a substituent represented by formula (1-3) shown below, R⁵ represents a single bond or an alkylene group having from 1 to 5 carbon atoms, X represents a substituted or unsubstituted aromatic ring, and n3 represents an integer from 0 to 10, when n3 represents 2 or more, plural R⁵s and Xs may be the same or different from each other.

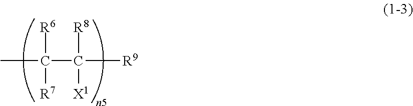

In formula (1-3), X¹ represents a substituted or unsubstituted aromatic ring, R⁶, R⁷, R⁸ and R⁹ each independently represents a hydrogen atom or an alkyl group having from 1 to 5 carbon atoms, and n5 represents an integer from 1 to 11, when n5 represents 2 or more, plural R⁶s, R⁷s, R⁸s, and X¹s may be the same or different from each other, respectively.

(4) The polarizing plate as described in (3) above, wherein the group represented by formula (1-2) is a group represented by formula (1-2′) shown below.

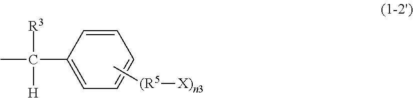

In formula (1-2′), R³ represents a hydrogen atom, an alkyl group having from 1 to 5 carbon atoms or the substituent represented by formula (1-3) shown above, R⁵ represents a single bond or an alkylene group having from 1 to 5 carbon atoms, X represents a substituted or unsubstituted aromatic ring, and n3 represents an integer from 0 to 5, when n3 represents 2 or more, plural R⁵s and Xs may be the same or different from each other.

(5) The polarizing plate as described in (1) or (2) above, wherein the compound (A) is a compound represented by formula (2) shown below.

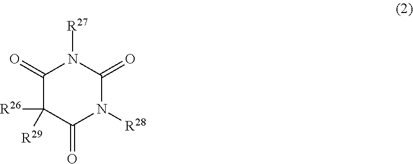

In formula (2), R²⁶ represents an alkyl group, an alkenyl group or an aryl group, R²⁷ and R²⁸ each independently represents a hydrogen atom, an alkyl group, an alkenyl group, an aryl group or a heteroaryl group, and R²⁹ represents a hydrogen atom. R²⁶, R²⁷ and R²⁸ each may have a substituent.

(6) The polarizing plate as described in any one of (1) to (5) above, wherein the resin contained in the transparent protective film is cellulose acylate.
(7) The polarizing plate as described in any one of (1) to (6) above, wherein the transparent protective film contains a hydrophobizing agent.
(8) The polarizing plate as described in any one of (1) to (7) above, which has a cohesive agent layer on a side of the polarizer opposite to the transparent protective film side.
(9) A liquid crystal display device comprising at least one of the polarizing plates as described in any one of (1) to (8) above.

According to the present invention, a polarizing plate which is excellent in polarizer durability even in a high temperature and high humidity environment, has a small amount of curl and hardly causes warp or distortion of a liquid crystal panel and display unevenness resulting therefrom depending on usage environment, when assembled in a liquid crystal display device, and a liquid crystal display device can be provided.

### BRIEF DESCRIPTION OF THE DRAWINGS

FIG. 1 is a view schematically showing an example of the liquid crystal display device according to the invention.

### DESCRIPTION OF REFERENCE NUMERALS AND SIGNS

1 Upper polarizing plate
2 Direction of absorption axis of upper polarizing plate
3 Liquid crystal cell upper electrode substrate
4 Upper substrate orientation control direction
5 Liquid crystal layer
6 Liquid crystal cell lower electrode substrate
7 Lower substrate orientation control direction
8 Lower polarizing plate
9 Direction of absorption axis of lower polarizing plate
10 Liquid crystal display device

### DETAILED DESCRIPTION OF THE INVENTION

### [Polarizing Plate]

The polarizing plate according to the invention is a polarizing plate having a transparent protective film through an adhesive layer on only one surface of a polarizer, wherein the transparent protective film has a thickness from 5 to 60 μm and contains at least one resin and a compound (A) having at least one hydrogen bond-forming hydrogen-donating group and a ratio of molecular weight/aromatic ring number of 190 or less.

In a conventional polarizing plate, a boric acid content in a polarizer decreases with the lapse of time in a high temperature and high humidity environment to often result in destabilization of a complex between a hydrophilic polymer (for example, polyvinyl alcohol) and a dichroic dye (for example, iodine) and this is a reason for degradation of the polarization performance. On the contrary, in the polarizing plate according to the invention the decrease in boric acid content in a polarizer is prevented by means of incorporating into a protective film for polarizing plate an additive having at least one hydrogen bond-forming hydrogen-donating group and a ratio of molecular weight/aromatic ring number of 190 or less, and in addition, the iodine complex is stabilized by means of uneven distribution of the additive at the interface between the polarizer and the protective film for polarizing plate with the lapse of time in a high temperature and high humidity environment.

The polarizing plate according to the invention will be described in detail below.

### <Performance of Polarizing Plate>

### (Orthogonal Transmittance CT)

As to the polarizing plate according to the invention, the orthogonal transmittance CT is preferably CT≦2.0, more preferably CT≦1.3, and most preferably CT≦0.6 (unit in percentage).

### (Variation of Orthogonal Transmittance)

A smaller variation amount of the orthogonal transmittance before and after durability test of polarizing plate is more preferred.

As to the polarizing plate according to the invention, it is preferred that the variation amount (%) of orthogonal single plate transmittance when the polarizing plate has been allowed to stand still for 1,000 hours under conditions of 60° C. and 90% relative humidity is less than 3%.

The variation amount (%) of orthogonal transmittance when the polarizing plate has been allowed to stand still for 1,000 hours under conditions of 60° C. and 90% relative humidity is preferably less than 3.0%, more preferably less than 1.0%, and still more preferably less than 0.5%.

The variation amount of orthogonal transmittance is calculated according to the formula shown below.

Variation amount (%) of orthogonal transmittance=Variation amount (%) of orthogonal transmittance after durability test−Variation amount (%) of orthogonal transmittance before durability test

It is preferred to satisfy the range of variation amount of orthogonal transmittance described above because stability of the polarizing plate during use or storage for a long period of time under high temperature and high humidity conditions or under high temperature and low humidity conditions is ensured.

In the invention, the orthogonal transmittance CT of polarizing plate is measured using automatic polarizing film measuring device VAP-7070 produced by JASCO Corp. at a wavelength of 410 nm according to the method shown below.

Two samples (5 cm×5 cm) in which the polarizing plate according to the invention is stuck on a glass through a cohesive agent are prepared. In this case, the protective film for polarizing plate according to the invention is stuck so that it faced on the opposite side of the glass (on the air interface side). The orthogonal transmittance measurement is carried out by setting the glass side of the sample so as to face a light source. The two samples are measured, respectively, and the average value thereof is taken as the orthogonal transmittance.

(Other characteristics)

With respect to other preferred optical characteristics and the like of the polarizing plate according to the invention, there are described in Paragraph Nos. [0238] to [0255] of JP-A-2007-86748 and it is preferred to fulfil these characteristics.

### <Shape and Constitution>

With respect to the shape of the polarizing plate, the polarizing plate includes not only a film sheet cut to have a size which can be directly assembled in a liquid crystal display device but also a long film continuously produced and rolled up into a roll (for example, an embodiment having a roll length of 2,500 m or more, or 3,900 m or more). For use in a large screen liquid crystal display device, a width of the polarizing plate is preferably 1,470 mm or more.

The polarizing plate according to the invention has a transparent protective film (protective film for polarizing plate) through an adhesive layer provided on only one surface of a polarizer. On the other surface of the polarizer, it is preferred to be provided a cohesive agent layer. A protective layer may be provided between the polarizer and the cohesive agent layer. Further, a protect film may be stuck on one surface of the polarizing plate and a separate film may be stuck on the other surface of the polarizing plate.

The protect film and separate film are used for the purpose of protecting the polarizing plate, for example, at the shipment of the polarizing plate or at the product inspection. In this case, the protect film is stuck for the purpose of protecting the surface of polarizing plate and used on the surface opposite the surface through which the polarizing plate is stuck to a liquid crystal plate. The separate film is used for the purpose of covering the cohesive agent layer which is stuck to a liquid crystal plate and used on the surface through which the polarizing plate is stuck to the liquid crystal plate.

The polarizer and protective film for polarizing plate which can be used in the polarizing plate according to the invention are described in detail below.

### (Thickness of Polarizing Plate)

The thickness of polarizing plate according to the invention is preferably from 15 to 150 μm, more preferably from 15 to 120 μm, and still more preferably from 15 to 90 μm. By setting the thickness of polarizing plate to the range described above, the warp or distortion of a liquid crystal panel due to environmental humidity can be reduced.

### <Transparent Protective Film>

The transparent protective film (protective film for polarizing plate) which can be used in the polarizing plate according to the invention is described below.

### (Thickness of Protective Film for Polarizing Plate)

The thickness of protective film for polarizing plate is preferably from 5 to 60 μm, more preferably from 5 to 35 μM, and particularly preferably from 10 to 30 μm.

The resin and additive which can be used in the protective film for polarizing plate are described below.

### (Resin)

The protective film for polarizing plate according to the invention is preferably constituted from a film-shaped resin.

As the resin which can be used in the protective film for polarizing plate, any known resin may be employed and it is not particularly restricted as long as it is not contrary to the spirit of the invention. The resin include a cellulose acylate resin, an acrylic resin and a cycloolefin resin and the cellulose acylate resin is preferred. Specifically, the protective film for polarizing plate preferably contains cellulose acylate.

The content of the resin in the protective film for polarizing plate is preferably from 70 to 99% by weight, and more preferably from 75 to 95% by weight.

(Cellulose acylate)

The cellulose acylate which can be used in the invention is described in detail below.

The degree of substitution in cellulose acylate means a ratio of acylation of three hydroxy groups existing in the constituting unit of cellulose (β-1,4-glycoside-bonding glucose). The degree of substitution (degree of acylation) can be calculated by determining the fatty acid amount bonded per weight of the constituting unit of cellulose. In the invention, the degree of substitution of cellulose body can be calculated by dissolving the cellulose body in a solvent, for example, deuterium-substituted dimethyl sulfoxide, measuring ¹³C-NMR spectrum thereof, and determining a peak intensity ratio of the carbonyl carbon in the acyl group. The remaining hydroxy group in the cellulose acylate is substituted with any acyl group other than the acyl group which the cellulose acylate itself has, and then determined by ¹³C-NMR measurement. The details of the measurement method are described in Tezuka et al., Carbohydrate Res., 273, 83-91 (1995).

The cellulose acylate for use in the invention preferably has a total degree of acyl substitution from 2.0 to 2.97, more preferably from 2.2 to 2.95, and particularly preferably from 2.3 to 2.95. In particular, the compound (A) for use in the invention exhibits a high improvement effect on the polarizing plate durability when it is used together with the cellulose acylate having the range of total degree of acyl substitution.

The acyl group of the cellulose acylate which can be used in the invention is not particularly restricted and is preferably an acyl group having from 2 to 20 carbon atoms, more preferably an acyl group having from 2 to 10 carbon atoms, and still more preferably an acyl group having from 2 to 8 carbon atoms. Specifically, an acetyl group, a propionyl group or a butyryl group is particularly preferred and the acetyl group is most preferred.

A mixed fatty acid ester having two or more different acyl groups is also preferably used for the cellulose acylate in the invention. In this case, the acyl groups are preferably an acetyl group and an acyl group having from 3 or 4 carbon atoms. Also, in case of using the mixed fatty acid ester, the degree of substitution with the acetyl group is preferably less than 2.5, and more preferably less than 1.9. On the other hand, the degree of substitution with the acyl group having from 3 or 4 carbon atoms is preferably from 0.1 to 1.5, more preferably from 0.2 to 1.2, and particularly preferably from 0.5 to 1.1.

In the invention, two kinds of cellulose acylates which differ in at least one of the substituent and the degree of substitution therein may be used together as a mixture, or a film comprising plural layers composed of different cellulose acylates formed according to a co-casting method or the like described below may be used.

A mixed acid ester having a fatty acid acyl group and a substituted or unsubstituted aromatic acyl group described in Paragraph Nos. [0023] to [0038] of JP-A-2008-20896 may also preferably used in the invention.

The cellulose acylate for use in the invention preferably has a number average molecular weight (Mn) from 70,000 to 230,000, more preferably a number average molecular weight from 75,000 to 230,000, and most preferably a number average molecular weight from 78,000 to 200,000. Also, the cellulose acylate for use in the invention preferably has a weight average molecular weight (Mw) from 100,000 to 500,000, more preferably a number average molecular weight from 150,000 to 450,000, and most preferably a number average molecular weight from 170,000 to 400,000.

A ratio (Mw/Mn) of the number average molecular weight (Mn) and the weight average molecular weight (Mw) is preferably from 1.8 to 4.5, more preferably from 2.0 to 4.0, and most preferably from 2.0 to 3.5. The ratio (Mw/Mn) of 4.5 or less is preferred because a ratio of a low molecular component is not too large and elastic modulus of the film easily increase. On the other hand, the ratio (Mw/Mn) of 1.8 or more is preferred because the additive is easily compatible with the cellulose acylate and the increase of haze is hardly occurred.

The average molecular weight and molecular weight distribution of the cellulose acylate according to the invention can be measured using high-performance liquid chromatography according to a conventional method. The number average molecular weight and weight average molecular weight are determined and the ratio thereof (Mw/Mn) can be calculated.

The measurement conditions of the average molecular weight and molecular weight distribution of the cellulose acylate are shown below.

Solvent: Methylene chloride

Column: SHODEX K806, K805 and K803G (produced by Showa Denko K.K.). Three columns were used in connection.

Column temperature: 23° C.

Sample concentration: 0.1% by weight

Detector: RI (RI-71S) SHODEX

Pump: DU-H7000 SYSTEM-21H(SHODEX)

Flow rate: 1.0 ml/min

Injection volume: 300 μl

Calibration curve: A calibration curve prepared by using 13 kinds of standard polystyrene samples having Mw from 1,000,000 to 500, STK Standard Polystyrene (produced by Tosoh Corp.), was used. The 13 kinds of standard polystyrene samples were preferably used at almost regular intervals.

The cellulose acylate for use in the invention can be synthesized using an acid anhydride or an acid chloride as an acylating agent. In the case where the acylating agent is an acid anhydride, an organic acid (for example, acetic acid) or methylene chloride is used as a reaction solvent. Also, a protonic catalyst, for example, sulfuric acid may be used as a catalyst. In the case where the acylating agent is an acid chloride, a basic compound can be used as the catalyst. In a synthetic method most commonly employed in industry, a cellulose ester is synthesized by esterifying a cellulose with a mixed organic acid component containing an organic acid (acetic acid, propionic acid or butyric acid) corresponding to an acetyl group and other acyl group or its acid anhydride (acetic anhydride, propionic anhydride or butyric anhydride).

In the method described above, cellulose, for example, cotton linter or wood pulp is in many cases subjected to an activation treatment with an organic acid, for example, acetic acid and then to esterification using a mixed solution of organic acid components described above in the presence of a sulfuric acid catalyst. The organic acid anhydride component is ordinarily used in an excess amount with respect to the amount of the hydroxy group present in the cellulose. In the esterification treatment, a hydrolysis reaction (depolymerization reaction) of the cellulose main chain (β-1,4-glycoside bond) proceeds in addition to an esterification reaction. When the hydrolysis reaction of the main chain proceeds, the polymerization degree of the cellulose ester decreases and the physical properties of cellulose ester film produced are deteriorated. Therefore, the reaction conditions, for example, reaction temperature are preferably determined by taking into consideration the polymerization degree or molecular weight of the cellulose ester obtained.

### (Polarizer Durability-Improving Agent)

The protective film for polarizing plate which can be used in the polarizing plate according to the invention contains the resin and a compound (A) (polarizer durability-improving agent) having at least one hydrogen bond-forming hydrogen-donating group and a ratio of molecular weight/aromatic ring number of 190 or less. Also, the protective film for polarizing plate contains the compound (A) preferably in an amount from 1 to 20 parts by weight based on 100 parts by weight of the resin. By using the additive, the protective film for polarizing plate can be improved in the polarizer durability in a high temperature and high humidity environment. It is believed that due to the formation of hydrogen bond between the hydrogen bond-forming hydrogen-donating group of the additive and polyvinyl alcohol in the polarizer, the additive is apt to be unevenly distributed at the interface between the polarizer and the protective film for polarizing plate in a high temperature and high humidity environment, and further the aromatic ring in the additive prevents the boric acid in the polarizer from diffusing out of the polarizing plate.

Examples of the hydrogen bond-forming hydrogen-donating group are described in book, for example, George A. Jeffrey, An Introduction to Hydrogen Bonding, Oxford University Press.

From the standpoint of interaction with the carbonyl group in cellulose acylate, the hydrogen bond-forming hydrogen-donating group in the polarizer durability-improving agent according to the invention is preferably an amino group, an acylamino group, an alkoxycarbonylamino group, an aryloxycarbonylamino group, a sulfonylamino group, a hydroxy group, a mercapto group, a carboxyl group, a methylene group having an electron withdrawing substituent or a methine group having an electron withdrawing substituent, more preferably a sulfonylamino group, an acylamino group, an amino group, a hydroxy group or a methine group having an electron withdrawing substituent, and still more preferably an amino group, a hydroxy group or a methine group having an electron withdrawing substituent.

The electron withdrawing substituent according to the invention is preferably a substituent having a Hammett σₚ value of 0 or more. The Hammett substituent constant σₚ value used herein is described. Hammett's rule is an empirical rule advocated by L. P. Hammett in 1935 so as to quantitatively discuss the effect of substituent on the reaction or equilibrium of benzene derivative, and the appropriateness thereof is widely admitted at present. The substituent constant determined in the Hammett's rule includes σₚ value and σₘ value. These values can be found in many ordinary publications, and are detailed, for example, in J. A. Dean, Lange's Handbook of Chemistry, 12th Edition, McGraw-Hill (1979), Kagaku no Ryoiki (Chemistry Region), extra number, No. 122, pp. 96 to 103, Nankodo Co., Ltd. (1979) and Chem. Rev., vol. 91, pp. 165 to 195 (1991). The substituent having a Hammett substituent constant σₚ value of 0 or more in the invention means that the substituent is an electron withdrawing group. The σₚ value is preferably 0.2 or more.

Examples of the electron withdrawing group having a Hammett substituent constant σₚ value of 0 or more include a halogen atom (for example, σₚ value of chlorine atom: 0.23), —CN (σₚ value: 0.66), —NO₂ (σₚ value: 0.78), —C(═O)R (for example, σₚ value of acetyl group: 0.50), —C(═O)OR (for example, σₚ value of methoxycarbonyl group: 0.45), —C(═O)NR^{a}R^{b} (for example, σₚ value of —CONH₂: 0.36), —SO₂R (for example, σₚ value of —SO₂Me: 0.72) and —SO₂NR^{a}R^{b}. In the formulae above, R, R^{a} and R^{b} each independently represents a hydrogen atom or a substituted or unsubstituted alkyl group having from 1 to 7 carbon atoms (preferably, an unsubstituted alkyl group having from 1 to 7 carbon atoms).

The ratio of molecular weight/aromatic ring number of the polarizer durability-improving agent according to the invention is 190 or less, preferably 160 or less, and more preferably 130 or less.

By setting the ratio of molecular weight/aromatic ring number to 190 or less, the additive fills free volume of cellulose acylate to effectively inhibit diffusion of iodide ion/iodine atom and boric acid in the polarizer into the cellulose acylate, thereby remarkably improving the polarizer durability in a high temperature and high humidity environment.

From the standpoint of increasing compatibility with cellulose acylate, the ratio of molecular weight/aromatic ring number of the polarizer durability-improving agent is preferably 90 or more, and more preferably 100 or more.

The aromatic ring in the polarizer durability-improving agent according to the invention is preferably a hydrocarbon aromatic ring (aromatic ring which does not contain an atom other than a carbon atom as a member for forming the ring) from the standpoint of improving the polarizer durability.

### (Molecular Weight)

The molecular weight of the polarizer durability-improving agent is preferably from 200 to 1,000, more preferably from 250 to 800, and particularly preferably from 280 to 600. The molecular weight of the lower limit described above or higher is preferred because disappearance of the polarizer durability-improving agent due to sublimation is prevented at the film formation of protective film for polarizing plate, and the molecular weight of the upper limit described above or lower is preferred because the compatibility between cellulose acylate and polarizer durability-improving agent is good to obtain a protective film for polarizing plate of low haze.

### <Compound Represented by Formula (1)>

The polarizer durability-improving agent according to the invention is preferably a compound represented by formula (1) shown below.

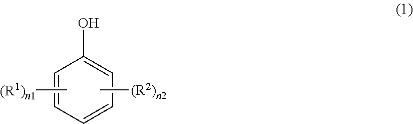

In formula (1), R¹ represents a substituent, R² represents a substituent represented by formula (1-2) shown below, n1 represents an integer from 0 to 4, when n1 represents 2 or more, plural R¹s may be the same or different from each other, and n2 represents an integer from 1 to 5, when n2 represents 2 or more, plural R²s may be the same or different from each other.

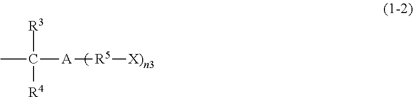

In formula (1-2), A represents a substituted or unsubstituted aromatic ring, R³ and R⁴ each independently represents a hydrogen atom, an alkyl group having from 1 to 5 carbon atoms or a substituent represented by formula (1-3) shown below, R⁵ represents a single bond or an alkylene group having from 1 to 5 carbon atoms, X represents a substituted or unsubstituted aromatic ring, and n3 represents an integer from 0 to 10, when n3 represents 2 or more, plural R⁵s and Xs may be the same or different from each other.

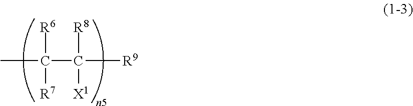

In formula (1-3), X¹ represents a substituted or unsubstituted aromatic ring, R⁶, R⁷, R⁸ and R⁹ each independently represents a hydrogen atom or an alkyl group having from 1 to 5 carbon atoms, and n5 represents an integer from 1 to 11, when n5 represents 2 or more, plural R⁶s, R⁷s, R⁸s and X¹s may be the same or different from each other.

R¹ represents a substituent. The substituent is not particularly restricted and examples thereof include an alkyl group (preferably an alkyl group having from 1 to 20 carbon atoms, more preferably from 1 to 10 carbon atoms, for example, methyl, ethyl, isopropyl, tert-butyl, pentyl, heptyl, 1-ethylpentyl, benzyl, 2-ethoxyethyl or 1-carboxymethyl), an alkenyl group (preferably an alkenyl group having from 2 to 20 carbon atoms, for example, vinyl, allyl or oleyl), an alkynyl group (preferably an alkynyl group having from 2 to 20 carbon atoms, for example, ethynyl, butadiynyl or phenylethynyl), a cycloalkyl group (preferably a cycloalkyl group having from 3 to 20 carbon atoms, for example, cyclopropyl, cyclopentyl, cyclohexyl or 4-methylcyclohexyl), an aryl group (preferably an aryl group having from 6 to 26 carbon atoms, for example, phenyl, 1-naphthyl, 4-methoxyphenyl, 2-chlorophenyl or 3-methylphenyl), a heterocyclic group (preferably a heterocyclic group having from 2 to 20 carbon atoms, for example, 2-pyridyl, 4-pyridyl, 2-imidazolyl, 2-benzimidazolyl, 2-thiazolyl or 2-oxazolyl), an alkoxy group (preferably an alkoxy group having from 1 to 20 carbon atoms, for example, methoxy, ethoxy, isopropyloxy or benzyloxy), an aryloxy group (preferably an aryloxy group having from 6 to 26 carbon atoms, for example, phenoxy, 1-naphthyloxy, 3-methylphenoxy or 4-methoxyphenoxy), an alkoxycarbonyl group (preferably an alkoxycarbonyl group having from 2 to 20 carbon atoms, for example, ethoxycarbonyl or 2-ethylhexyloxycarbonyl), an amino group (preferably an amino group having from 0 to 20 carbon atoms, for example, amino, N,N-dimethylamino, N,N-diethylamino, N-ethylamino or anilino), a sulfonamide group (preferably a sulfonamide group having from 0 to 20 carbon atoms, for example, N,N-dimethylsulfonamide or N-phenylsulfonamide), an acyloxy group (preferably an acyloxy group having from 1 to 20 carbon atoms, for example, acethyloxy or benzoyloxy), a carbamoyl group (preferably a carbamoyl group having from 1 to 20 carbon atoms, for example, N,N-dimethylcarbamoyl or N-phenylcarbamoyl), an acylamino group (preferably an acylamino group having from 1 to 20 carbon atoms, for example, acetylamino or benzoylamino), a cyano group, a halogen atom (for example, a fluorine atom, a chlorine atom, a bromine atom or an iodine atom) and a hydroxy group.

R¹ is preferably an alkyl group having from 1 to 20 carbon atoms or a hydroxy group, and is more preferably a hydroxy group or a methyl group. R¹ may have one or more substituents selected from the substituents described above. Also, R¹ may further have one or more substituents and the substituents are same as the substituents for R¹.

n1 represents an integer from 0 to 4, and is preferably an integer from 2 to 4.

n2 represents an integer from 1 to 5, and is preferably an integer from 1 to 3 and more preferably 1 or 2.

R² represents a substituent represented by formula (1-2) shown below.

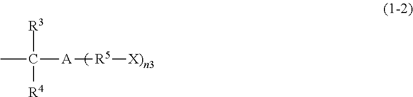

In formula (1-2), A represents a substituted or unsubstituted aromatic ring, R³ and R⁴ each independently represents a hydrogen atom, an alkyl group having from 1 to 5 carbon atoms or a substituent represented by formula (1-3) shown below, R⁵ represents a single bond or an alkylene group having from 1 to 5 carbon atoms, X represents a substituted or unsubstituted aromatic ring, and n3 represents an integer from 0 to 10, when n3 represents 2 or more, plural R⁵s and Xs may be the same or different from each other.

A represents a substituted or unsubstituted aromatic ring. The aromatic ring may be a heterocyclic ring containing a hetero atom, for example, a nitrogen atom, an oxygen atom or a sulfur atom. Examples of A include a benzene ring, an indene ring, a naphthalene ring, a fluorene ring, a phenanthrene ring, an anthracene ring, a biphenyl ring, a pyrene ring, a pyran ring, a dioxane ring, a dithiane ring, a thiin ring, a pyridine ring, a piperidine ring, an oxazine ring, a morpholine ring, a thiazine ring, a pyridazine ring, a pyrimidine ring, a pyrazine ring, a piperazine ring and a triazine ring. Furthermore, other 6-membered ring or 5-membered ring may be condensed. A is preferably a benzene ring. The substituent which A may have includes a halogen atom (for example, a fluorine atom, a chlorine atom, a bromine atom or an iodine atom), an alkyl group and a hydroxy group, and is preferably an alkyl group or a hydroxy group, more preferably an alkyl group having from 1 to 10 carbon atoms or a hydroxy group, and still more preferably an alkyl group having from 1 to 5 carbon atoms or a hydroxy group.

R³ and R⁴ each independently represents a hydrogen atom, an alkyl group having from 1 to 5 carbon atoms or a substituent represented by formula (1-3) shown below. R³ and R⁴ each preferably represents a hydrogen atom, an alkyl group having from 1 to 3 carbon atoms or a substituent represented by formula (1-3) shown below, and more preferably a hydrogen atom, a methyl group or a substituent represented by formula (1-3) shown below.

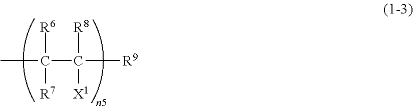

In formula (1-3), X¹ represents a substituted or unsubstituted aromatic ring, R⁶, R⁷, R⁸ and R⁹ each independently represents a hydrogen atom or an alkyl group having from 1 to 5 carbon atoms, and n5 represents an integer from 1 to 11, when n5 represents 2 or more, plural R⁶s, R¹s, R⁸s and X¹s may be the same or different from each other.

X¹ in formula (1-3) has the same meaning as X defined in formula (1-2) and the preferred ranges thereof are also the same.

R⁶, R⁷, R⁸ and R⁹ each independently represents a hydrogen atom or an alkyl group having from 1 to 5 carbon atoms. R⁶, R⁷, R⁸ and R⁹ each preferably represents a hydrogen atom or an alkyl group having from 1 to 3 carbon atoms, and more preferably a hydrogen atom or a methyl group.

n5 represents an integer from 1 to 11, and is preferably an integer from 1 to 9, more preferably an integer from 1 to 7.

The substituent represented by formula (1-3) is preferably a substituent represented by formula (I-3″) shown below.

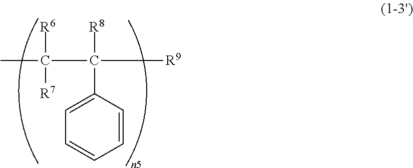

In formula (1-3′), R⁶, R⁷, R⁹ and n5 have the same meanings as those defined in formula (1-3), respectively, and the preferred ranges thereof are also the same.

The substituent represented by formula (1-3) is preferably a substituent represented by formula (1-3″) shown below.

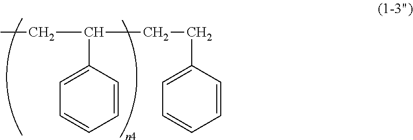

In formula (1-3″), n4 represents an integer from 0 to 10.

n4 represents an integer from 0 to 10, and is preferably an integer from 0 to 8, more preferably an integer from 0 to 6.

In formula (1-2), R⁵ represents a single bond or an alkylene group having from 1 to 5 carbon atoms. The alkylene group having from 1 to 5 carbon atoms may have a substituent. R⁵ is preferably an alkylene group having from 1 to 4 carbon atoms, and more preferably an alkylene group having from 1 to 3 carbon atoms. The substituent which R⁵ may have includes an alkyl group having from 1 to 5 carbon atoms (for example, methyl, ethyl, isopropyl or tert-butyl), a halogen atom (for example, a fluorine atom, a chlorine atom, a bromine atom or an iodine atom) and a hydroxy group.

In formula (1-2), X represents a substituted or unsubstituted aromatic ring. The aromatic ring may be a heterocyclic ring containing a hetero atom, for example, a nitrogen atom, an oxygen atom or a sulfur atom. Examples of X include a benzene ring, an indene ring, a naphthalene ring, a fluorene ring, a phenanthrene ring, an anthracene ring, a biphenyl ring, a pyrene ring, a pyran ring, a dioxane ring, a dithiane ring, a thiin ring, a pyridine ring, a piperidine ring, an oxazine ring, a morpholine ring, a thiazine ring, a pyridazine ring, a pyrimidine ring, a pyrazine ring, a piperazine ring and a triazine ring. Furthermore, other 6-membered ring or 5-membered ring may be condensed. X is preferably a benzene ring. The substituent which X may have includes the substituents described for A.

n3 represents an integer from 0 to 10, and is preferably an integer from 0 to 2, more preferably an integer of 0 or 1. When n3 represents an integer of 2 or more, plural groups represented by —(R⁵—X) may be the same as or different from each other and are connected to A. When n3 is 0, since the group represented by —(R⁵—X) is not present, the group represented by —(R¹⁵—X) is not connected to A.

The substituent represented by formula (1-2) is preferably a substituent represented by formula (1-2′) shown below.

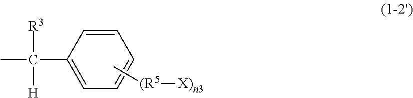

In formula (1-2′), R³ represents a hydrogen atom, an alkyl group having from 1 to 5 carbon atoms or a substituent represented by formula (1-3) shown above, R⁵ represents a single bond or an alkylene group having from 1 to 5 carbon atoms, X represents a substituted or unsubstituted aromatic ring, and n3 represents an integer from 0 to 5, when n3 represents 2 or more, plural R⁵s and Xs may be the same or different from each other.

The preferred ranges of the respective symbols are same as those described in formula (1-2).

The substituent represented by formula (1-2) is preferably a substituent represented by formula (1-2″) shown below.

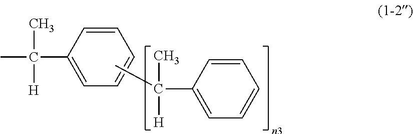

In formula (1-2″), n3 represents an integer from 0 to 5.

The preferred range of n3 in formula (1-2″) are the same as the preferred range of n3 in formula (1-2).

The compound represented by formula (1) is preferably an embodiment wherein R¹ is a hydrogen atom or an alkyl group having from 1 to 5 carbon atoms, R² is a substituent represented by formula (1-2″), n1 represents an integer from 2 to 4, n2 represents an integer from 1 to 3, and n3 represents an integer from 0 to 2.

Specific examples of the compound represented by formula (1) are set forth below, but the invention should not be construed as being limited thereto.

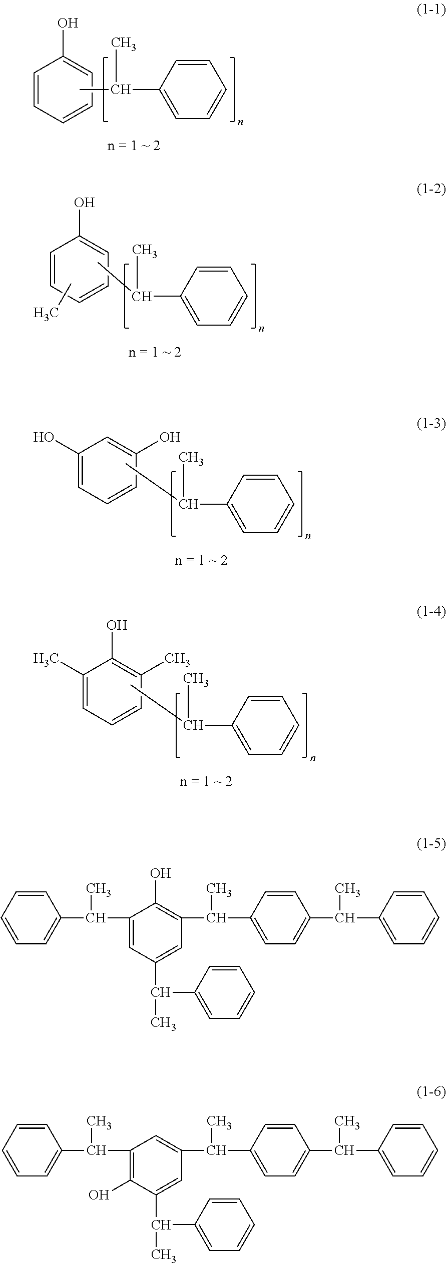

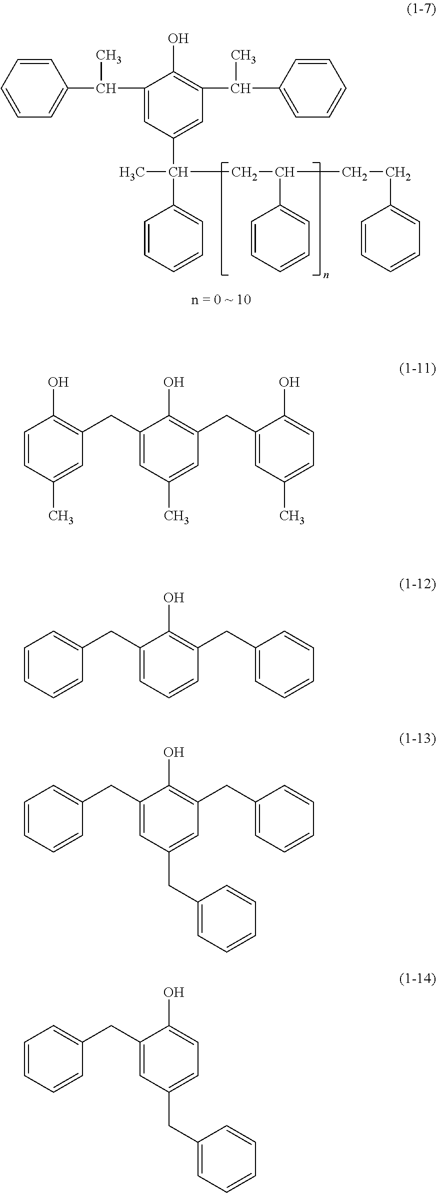

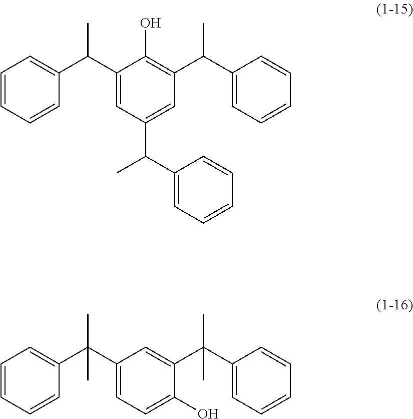 [SMILES: CC(c1ccccc1)c1cc(C(C)c2ccccc2)c(O)c(C(C)c2ccccc2)c1 ; CC(C)(c1ccccc1)c1ccc(O)c(C(C)(C)c2ccccc2)c1]

In order to make it possible that the compounds represented by formula (1) having different number of hydroxy groups form hydrogen bonds at multiple points, a mixture may also be employed which contains at least two kinds of the compounds represented by formula (1) different from each other. As one example, a mixture containing a styrenated phenol obtained by alkylation of 1 to 3 moles of styrenes on phenol, a styrenated phenol obtained by further alkylation of styrene on a phenol moiety of an alkylated styrene and a styrenated phenol obtained by alkylation of an oligomer having about 2 to 4 units of styrenes on phenol is exemplified.

The compound represented by the formula (1) can be ordinarily synthesized by adding one or more equivalents of styrene to one equivalent of phenol in the presence of an acid catalyst. Commercially available products may also be employed. Further, a mixture obtained by the synthesis method described above may be used as it is.

Examples of the commercially available product of the compound represented by the formula (1) include styrenated phenol TSP produced by Sanko Co., Ltd., PH-25 produced by Nitto Chemical Co., Ltd. and NONFLEX WS produced by Seiko Chemical Co., Ltd.

### <Compound Represented by Formula (2)>

The polarizer durability-improving agent according to the invention is also preferably a compound represented by formula (2) shown below.

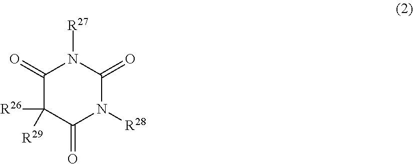

In formula (2), R²⁶ represents an alkyl group, an alkenyl group or an aryl group, R²⁷ and R²⁸ each independently represents an alkyl group, an alkenyl group, an aryl group or a heteroaryl group, and R²⁹ represents a hydrogen atom. R²⁶, R²⁷ and R²⁸ each may have a substituent.

R²⁶ is preferably an alkyl group having from 1 to 20 carbon atoms (also including a cycloalkyl group), an alkenyl group having from 2 to 20 carbon atoms or an aryl group having from 6 to 20 carbon atoms, more preferably an alkyl group having from 1 to 12 carbon atoms (also including a cycloalkyl group), an alkenyl group having from 2 to 20 carbon atoms or an aryl group having from 6 to 20 carbon atoms, still more preferably an alkyl group having from 1 to 12 carbon atoms (also including a cycloalkyl group), an alkenyl group having from 2 to 10 carbon atoms or an aryl group having from 6 to 18 carbon atoms, particularly preferably an alkyl group having from 1 to 8 carbon atoms (also including a cycloalkyl group), an alkenyl group having from 2 to 5 carbon atoms or an aryl group having from 6 to 12 carbon atoms, and most preferably an alkyl group having from 1 to 6 carbon atoms (also including a cycloalkyl group) or an aryl group having from 6 to 12 carbon atoms.

Of the groups, a methyl group, an ethyl group, a propyl group, a cyclohexyl group, a phenyl group or a naphthyl group is more preferred, and a methyl group, a cyclohexyl group or a phenyl group is most preferred.

R²⁷ and R²⁸ each preferably represents an alkyl group having from 1 to 20 carbon atoms (also including a cycloalkyl group), an alkenyl group having from 2 to 20 carbon atoms, an aryl group having from 6 to 20 carbon atoms or a heteroaryl group having from 6 to 20 carbon atoms, more preferably an alkyl group having from 1 to 12 carbon atoms (also including a cycloalkyl group), an alkenyl group having from 2 to 20 carbon atoms or an aryl group having from 6 to 20 carbon atoms, still more preferably an alkyl group having from 1 to 12 carbon atoms (also including a cycloalkyl group), an alkenyl group having from 2 to 10 carbon atoms or an aryl group having from 6 to 18 carbon atoms, particularly preferably an alkyl group having from 1 to 8 carbon atoms (also including a cycloalkyl group), an alkenyl group having from 2 to 5 carbon atoms or an aryl group having from 6 to 12 carbon atoms, and most preferably an alkyl group having from 1 to 6 carbon atoms (also including a cycloalkyl group) or an aryl group having from 6 to 12 carbon atoms.

Of the groups, a methyl group, an ethyl group, a propyl group, a cyclohexyl group, a phenyl group or a naphthyl group is more preferred, and a methyl group, an ethyl group, a cyclohexyl group or a phenyl group is particularly preferred.

The substituent which R²⁶ may have is not particularly restricted as long as it is not contrary to the spirit of the invention, and is preferably a halogen atom, an alkyl group or an aryl group, more preferably a halogen atom, an alkyl group having from 1 to 6 carbon atoms or an aryl group having from 6 to 12 carbon atoms, and particularly preferably a chlorine atom, a methyl group or a phenyl group.

The substituent which R²⁷ or R²⁸ may have is not particularly restricted as long as it is not contrary to the spirit of the invention, and is preferably an aryl group having from 6 to 12 carbon atoms, and more preferably a phenyl group.

As the compound represented by formula (2), a compound represented by formula (2-a) shown below is used. The compound represented by formula (2-a) is preferred from the standpoint of preventing the sublimation at the film formation.

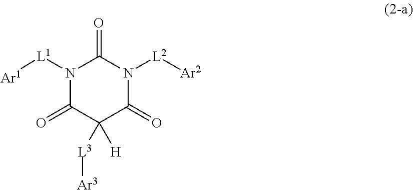

In formula (2-a), L¹ to L³ each independently represents a single bond or an alkylene group, and Ar¹ to Ar³ each independently represents an aryl group having from 6 to 20 carbon atoms.

In formula (2-a), L¹ to L³ each independently represents a single bond or a divalent connecting group having one or more carbon atoms. L¹ to L³ each preferably represents a single bond or an alkylene group having from 1 to 6 carbon atoms, more preferably a single bond, a methylene group or an ethylene group, and particularly preferably a single bond or a methylene group. The divalent connecting group may have a substituent and the substituent is same as the substituent which Ar¹, Ar² or Ar³ may have as described below.

In formula (2-a), each of Ar¹ to Ar³ represents an aryl group having from 6 to 20 carbon atoms, and is preferably a phenyl group or a naphthyl group, and more preferably a phenyl group. Each of Ar¹ to Ar³ may have a substituent and the substituent is same as the substituent which Ar¹, Ar² or Ar³ may have as described below. Each of Ar¹ to Ar³ preferably has no substituent or when it has a substituent, the substituent having no ring structure is preferred.

Each of Ar¹ to Ar³ may have a substituent. The substituent is not particularly restricted and examples thereof include an alkyl group (preferably an alkyl group having from 1 to 10 carbon atoms, for example, methyl, ethyl, isopropyl, tert-butyl, pentyl, heptyl, 1-ethylpentyl, benzyl, 2-ethoxyethyl or 1-carboxymethyl), an alkenyl group (preferably an alkenyl group having from 2 to 20 carbon atoms, for example, vinyl, allyl or oleyl), an alkynyl group (preferably an alkynyl group having from 2 to 20 carbon atoms, for example, ethynyl, butadiynyl or phenylethynyl), a cycloalkyl group (preferably a cycloalkyl group having from 3 to 20 carbon atoms, for example, cyclopropyl, cyclopentyl, cyclohexyl or 4-methylcyclohexyl), an aryl group (preferably an aryl group having from 6 to 26 carbon atoms, for example, phenyl, 1-naphthyl, 4-methoxyphenyl, 2-chlorophenyl or 3-methylphenyl), a heterocyclic group (preferably a heterocyclic group having from 0 to 20 carbon atoms, a hetero atom for forming the ring being preferably an oxygen atom, a nitrogen atom or a sulfur atom, a 5-membered or 6-membered ring may be condensed with a benzene ring or a hetero ring, the ring may be a saturated ring, an unsaturated ring or an aromatic ring, for example, 2-pyridyl, 4-pyridyl, 2-imidazolyl, 2-benzimidazolyl, 2-thiazolyl or 2-oxazolyl), an alkoxy group (preferably an alkoxy group having from 1 to 20 carbon atoms, for example, methoxy, ethoxy, isopropyloxy or benzyloxy), an aryloxy group (preferably an aryloxy group having from 6 to 26 carbon atoms, for example, phenoxy, 1-naphthyloxy, 3-methylphenoxy or 4-methoxyphenoxy), an alkylthio group (preferably an alkylthio group having from 1 to 20 carbon atoms, for example, methylthio, ethylthio, isopropylthio or benzylthio), an arylthio group (preferably an arylthio group having from 6 to 26 carbon atoms, for example, phenylthio, 1-naphthyltio, 3-methylphenylthio or 4-methoxyphenylthio), an acyl group (including an alkylcarbonyl group, an alkenylcarbonyl group, an arylcamonyl group and a heterocyclic carbonyl group, preferably an acyl group having 20 or less carbon atoms, for example, acetyl, pivaloyl, acryloyl, methacryloyl, benzoyl or nicotinoyl), an aryloylalkyl group, an alkoxycarbonyl group (preferably an alkoxycarbonyl group having from 2 to 20 carbon atoms, for example, ethoxycarbonyl or 2-ethylhexyloxycarbonyl), an aryloxycarbonyl group (preferably an aryloxycarbonyl group having from 7 to 20 carbon atoms, for example, phenyloxycarbonyl or naphthyloxycarbonyl), an amino group (including an amino group, an alkylamino group, an arylamino group and heterocyclic amino group, preferably an amino group having from 0 to 20 carbon atoms, for example, amino, N,N-dimethylamino, N,N-diethylamino, N-ethylamino, anilino, 1-pyrrolidinyl, piperidino or morpholinyl), a sulfonamide group (preferably a sulfonamide group having from 0 to 20 carbon atoms, for example, N,N-dimethylsulfonamide or N-phenylsulfonamide), a sulfamoyl group (preferably a sulfamoyl group having from 0 to 20 carbon atoms, for example, N,N-dimethylsulfamoyl or N-phenylsulfamoyl), an acyloxy group (preferably an acyloxy group having from 1 to 20 carbon atoms, for example, acethyloxy or benzoyloxy), a carbamoyl group (preferably a carbamoyl group having from 1 to 20 carbon atoms, for example, N,N-dimethylcarbamoyl or N-phenylcarbamoyl), an acylamino group (preferably an acylamino group having from 1 to 20 carbon atoms, for example, acetylamino, acryloylamino, benzoylamino or nicotinamide), a cyano group, a hydroxy group, a mercapto group and a halogen atom (for example, a fluorine atom, a chlorine atom, a bromine atom or an iodine atom).

The substituent which Ar¹, Ar² or Ar³ may further have the substituent described above.

Of the substituents which Ar¹, Ar² or Ar³ may have, an alkyl group, an aryl group, an alkoxy group or an acyl group is preferred.

The molecular weight of the compound represented by formula (2) or (2-a) is preferably from 250 to 1,200, and more preferably from 300 to 800.

When the molecular weight is 250 or more, the sublimation thereof from the protective film is prevented, whereas when it is 1,200 or less, the compatibility thereof with cellulose acylate is excellent to improve transparency of the protective film.

Specific examples of the compound represented by formula (2) or (2-a) are set forth below, but the invention should not be construed as being limited thereto. In the compounds shown below, Me denotes a methyl group.

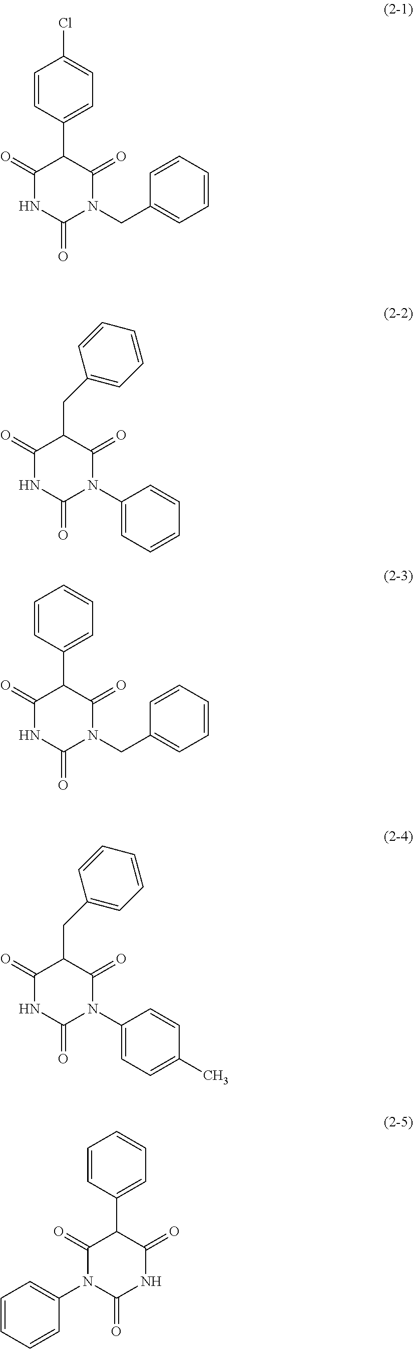 [SMILES: O=C1NC(=O)N(Cc2ccccc2)C(=O)C1c1ccc(Cl)cc1 ; O=C1NC(=O)N(c2ccccc2)C(=O)C1Cc1ccccc1 ; O=C1NC(=O)N(Cc2ccccc2)C(=O)C1c1ccccc1 ; Cc1ccc(N2C(=O)NC(=O)C(Cc3ccccc3)C2=O)cc1 ; O=C1NC(=O)N(c2ccccc2)C(=O)C1c1ccccc1]

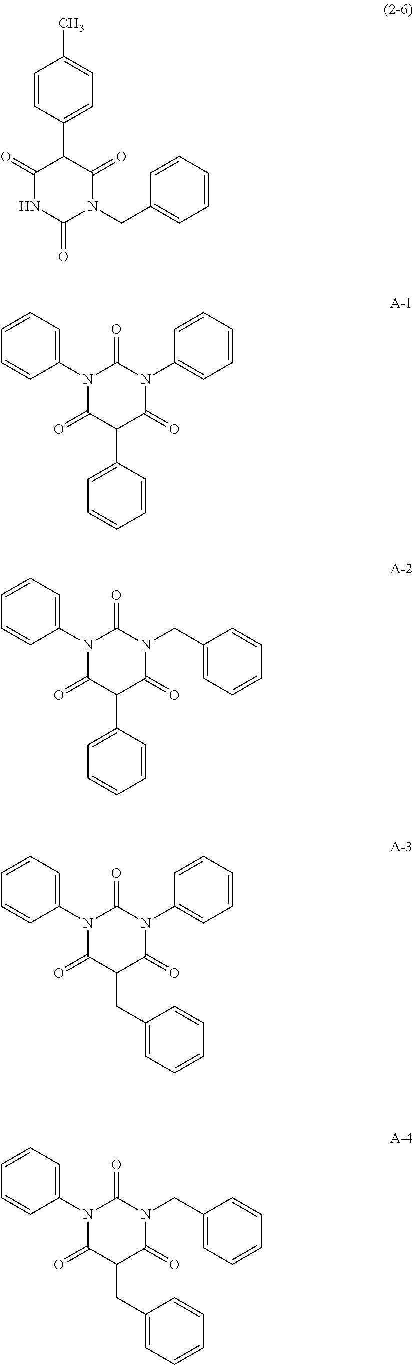 [SMILES: Cc1ccc(C2C(=O)NC(=O)N(Cc3ccccc3)C2=O)cc1 ; O=C1C(c2ccccc2)C(=O)N(c2ccccc2)C(=O)N1c1ccccc1 ; O=C1C(c2ccccc2)C(=O)N(c2ccccc2)C(=O)N1Cc1ccccc1 ; O=C1C(Cc2ccccc2)C(=O)N(c2ccccc2)C(=O)N1c1ccccc1 ; O=C1C(Cc2ccccc2)C(=O)N(c2ccccc2)C(=O)N1Cc1ccccc1]

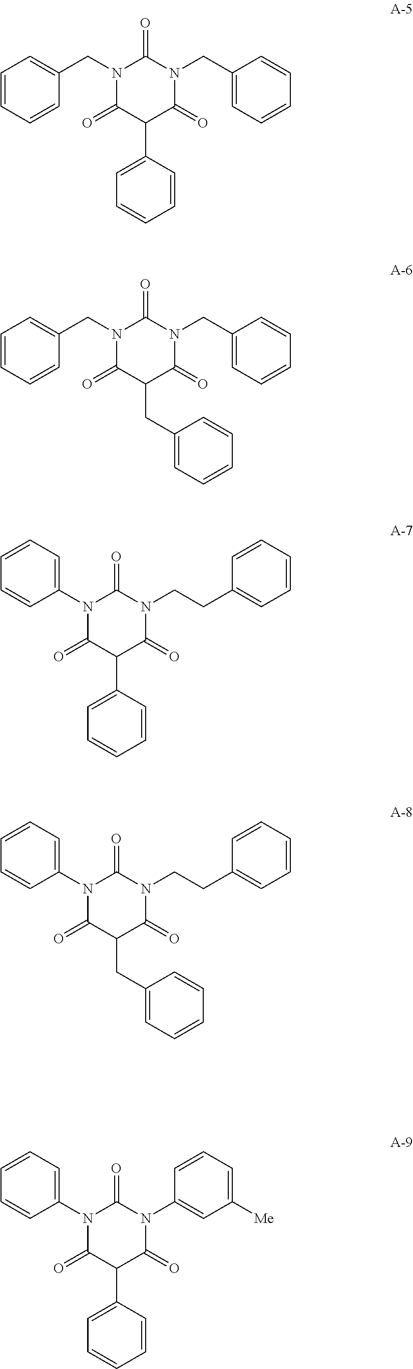 [SMILES: O=C1C(c2ccccc2)C(=O)N(Cc2ccccc2)C(=O)N1Cc1ccccc1 ; O=C1C(Cc2ccccc2)C(=O)N(Cc2ccccc2)C(=O)N1Cc1ccccc1 ; O=C1C(c2ccccc2)C(=O)N(c2ccccc2)C(=O)N1CCc1ccccc1 ; O=C1C(Cc2ccccc2)C(=O)N(c2ccccc2)C(=O)N1CCc1ccccc1 ; Cc1cccc(N2C(=O)C(c3ccccc3)C(=O)N(c3ccccc3)C2=O)c1]

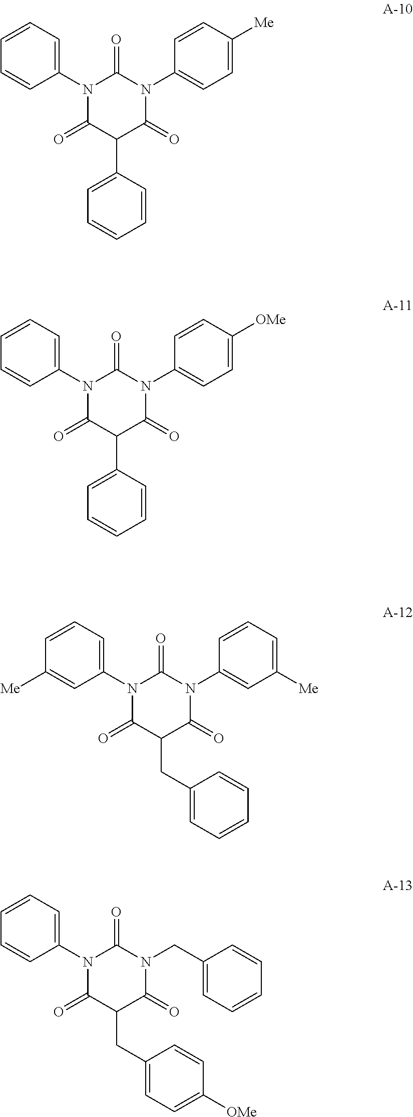 [SMILES: Cc1ccc(N2C(=O)C(c3ccccc3)C(=O)N(c3ccccc3)C2=O)cc1 ; COc1ccc(N2C(=O)C(c3ccccc3)C(=O)N(c3ccccc3)C2=O)cc1 ; Cc1cccc(N2C(=O)C(Cc3ccccc3)C(=O)N(c3cccc(C)c3)C2=O)c1 ; COc1ccc(CC2C(=O)N(Cc3ccccc3)C(=O)N(c3ccccc3)C2=O)cc1]

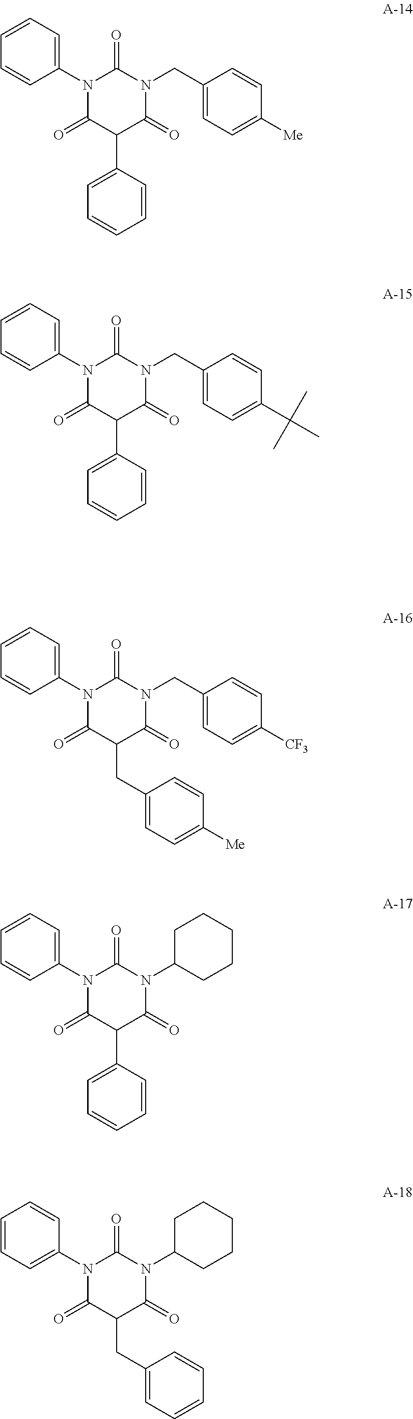 [SMILES: Cc1ccc(CN2C(=O)C(c3ccccc3)C(=O)N(c3ccccc3)C2=O)cc1 ; CC(C)(C)c1ccc(CN2C(=O)C(c3ccccc3)C(=O)N(c3ccccc3)C2=O)cc1 ; Cc1ccc(CC2C(=O)N(Cc3ccc(C(F)(F)F)cc3)C(=O)N(c3ccccc3)C2=O)cc1 ; O=C1C(c2ccccc2)C(=O)N(C2CCCCC2)C(=O)N1c1ccccc1 ; O=C1C(Cc2ccccc2)C(=O)N(C2CCCCC2)C(=O)N1c1ccccc1]

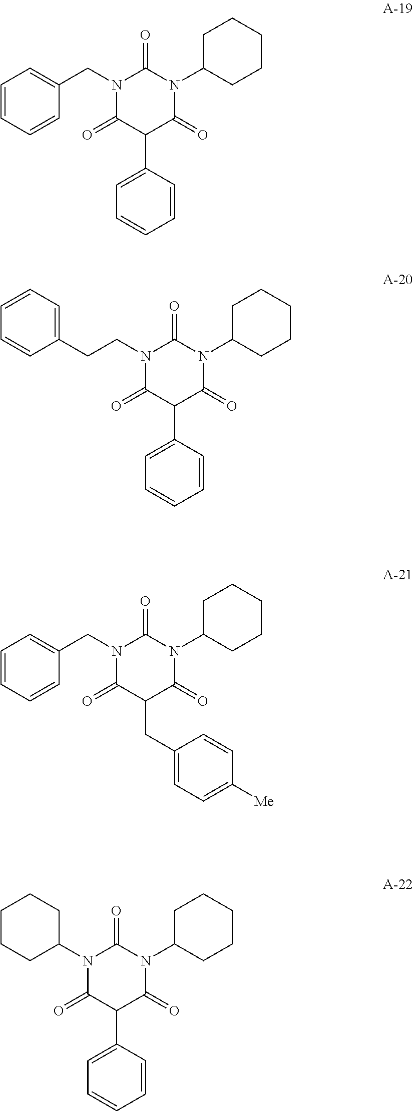 [SMILES: O=C1C(c2ccccc2)C(=O)N(C2CCCCC2)C(=O)N1Cc1ccccc1 ; O=C1C(c2ccccc2)C(=O)N(C2CCCCC2)C(=O)N1CCc1ccccc1 ; Cc1ccc(CC2C(=O)N(Cc3ccccc3)C(=O)N(C3CCCCC3)C2=O)cc1 ; O=C1C(c2ccccc2)C(=O)N(C2CCCCC2)C(=O)N1C1CCCCC1]

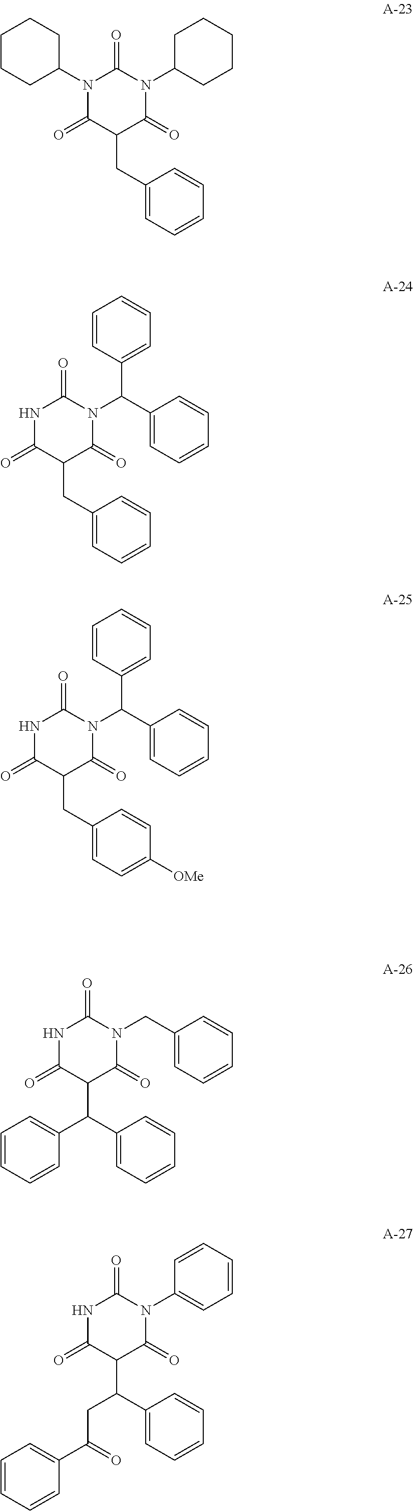

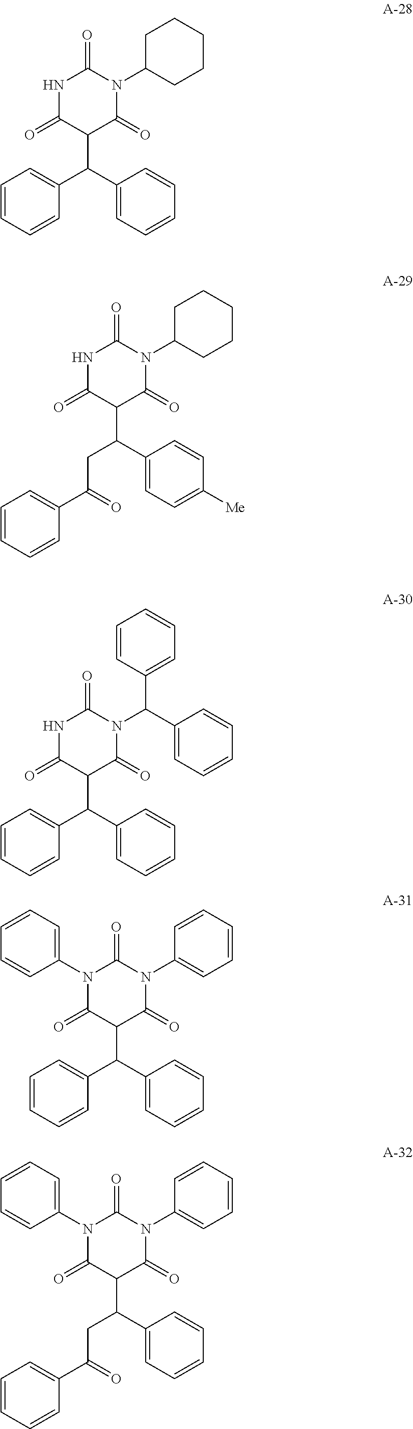

It is known that the compound represented by formula (2) can be synthesized using a synthesis method for barbituric acid according to condensation between a urea derivative and a molonic acid derivative. A barbituric acid having two substituents on the Ns can be obtained by heating N,N′-disubstituted urea and malonic acid chloride or malonic acid in combination with an activating agent, for example, acetic anhydride. Methods described, for example, in Journal of the American Chemical Society, Vol. 61, page 1015 (1939), Journal of Medical Chemistry, Vol. 54, page 2409 (2011), Tetrahedron letters, Vol. 40, page 8029 (1999) and WO 2007/150011 may be preferably used.

The malonic acid for use in the condensation may be unsubstituted or substituted. By constructing barbituric acid using malonic acid having a substituent corresponding R⁵, the compound represented by formula (2) according to the invention can be synthesized. Also, the compound represented by formula (2) according to the invention may also be synthesized by obtaining barbituric acid in which the 5-position is unsubstituted according to condensation between unsubstituted malonic acid and a urea derivative and modifying the resulting barbituric acid.

The synthesis methods of the compound represented by formula (2) for use in the invention are not restricted as described above.

### (Content of Polarizer Durability-Improving Agent)

The content of the polarizer durability-improving agent is preferably from 1 to 20 parts by weight based on 100 parts by weight of the main component resin constituting the protective film for polarizing plate (the term “main component resin” means a resin which has the largest content weight ratio of the resins contained in the protective film for polarizing plate). When the content thereof is 1 part by weight or more, the effect of improving polarizer durability is apt to be obtained, whereas when it is 20% by weight or less, the bleed out or seepage hardly occur when the protective film for polarizing plate is formed. The content of the polarizer durability-improving agent is more preferably from 1 to 15 parts by weight, particularly preferably from 1 to 10 parts by weight, based on 100 parts by weight of the resin.

### (Hydrophobizing Agent)

The protective film for polarizing plate according to the invention preferably contains a carbohydrate derivative as a hydrophobizing agent.

### (Carbohydrate Derivative Plasticizer)

The hydrophobizing agent is preferably a carbohydrate derivative containing a saccharide or from 2 to 10 saccharide units (hereinafter, referred to as a carbohydrate derivative plasticizer).

The saccharide or polysaccharide which preferably constitutes the carbohydrate derivative plasticizer is characterized in that a group capable of being substituted (for example, a hydroxy group, a carboxyl group, an amino group or a mercapto group) in the molecule is substituted. Examples of the structure formed by the substituent include an alkyl group, an aryl group or an acyl group. Also, an ether stricture formed by substituting a hydroxy group with an alkyl group, an ester stricture formed by substituting a hydroxy group with an acyl group, and an amido stricture or imido structure formed by substituting an amino group with an acyl group are exemplified.

Examples of the carbohydrate containing a saccharide or from 2 to 10 saccharide units include erythrose, threose, ribose, arabinose, xylose, lyxose, arose, altrose, glucose, fructose, mannose, gulose, idose, galactose, talose, trehalose, isotrehalose, neotrehalose, trehalosamine, kojibiose, nigerose, maltose, maltitol, isomaltose, sophorose, laminaribiose, cellobiose, gentiobiose, lactose, lactosamine, lactitol, lactulose, melibiose, primeverose, rutinose, scillabiose, sucrose, sucralose, turanose, vicianose, cellotriose, chacotriose, gentianose, isomaltotriose, isopanose, maltotriose, manninotriose, melezitose, panose, planteose, raffinose, solatriose, umbelliferose, lycotetraose, maltotetraose, stachyose, maltopentaose, verbascose, maltohexaose, α-cyclodextrin, β-cyclodextrin, γ-cyclodextrin, δ-cyclodextrin, xylitol and sorbitol.

Preferred examples thereof are ribose, arabinose, xylose, lyxose, glucose, fructose, mannose, galactose, trehalose, maltose, cellobiose, lactose, sucrose, sucralose, α-cyclodextrin, β-cyclodextrin, γ-cyclodextrin, δ-cyclodextrin, xylitol and sorbitol. More preferred examples thereof are arabinose, xylose, glucose, fructose, mannose, galactose, maltose, cellobiose, sucrose, β-cyclodextrin and γ-cyclodextrin. Particularly preferred examples thereof are xylose, glucose, fructose, mannose, galactose, maltose, cellobiose, sucrose, xylitol and sorbitol.

Examples of the substituent for the carbohydrate derivative plasticizer include an alkyl group (preferably an alkyl group having from 1 to 22 carbon atoms, more preferably from 1 to 12 carbon atoms, and particularly preferably from 1 to 8 carbon atoms, for example, a methyl group, an ethyl group, a propyl group, a hydroxyethyl group, a hydroxypropyl group, a 2-cyanoethyl group or a benzyl group), an aryl group (preferably an aryl group having from 6 to 24 carbon atoms, more preferably from 6 to 18 carbon atoms, and particularly preferably from 6 to 12 carbon atoms, for example, a phenyl group or a naphthyl group), an acyl group (preferably an acyl group having from 1 to 22 carbon atoms, more preferably from 2 to 12 carbon atoms, and particularly preferably from 2 to 8 carbon atoms, for example, an acetyl group, a propionyl group, a butyryl group, a pentanoyl group, a hexanoyl group, an octanoyl group, a benzoyl group, a toluoyl group, a phthalyl group or a naphthal group). Also, preferred examples of the structure formed by substitution of an amino group include an amido structure (preferably an amide having from 1 to 22 carbon atoms, more preferably from 2 to 12 carbon atoms, and particularly preferably from 2 to 8 carbon atoms, for example, formamide or acetamide) and an imido structure (preferably an imide having from 4 to 22 carbon atoms, more preferably from 4 to 12 carbon atoms, and particularly preferably from 4 to 8 carbon atoms, for example, succinimide or phthalimide).

Of the substituents, an alkyl group, an aryl group or an acyl group is more preferred, and an acyl group is particularly preferred.

Preferred examples of the carbohydrate derivative plasticizer are set forth below. However, the carbohydrate derivative plasticizer which can be used in the invention should not be construed as being limited thereto.

Preferred examples thereof include xylose tetraacetate, glucose pentaacetate, fructose pentaacetate, mannose pentaacetate, galactose pentaacetate, maltose octaacetate, cellobiose octaacetate, sucrose octaacetate, xylitol pentaacetate, sorbitol hexaacetate, xylose tetrapropionate, glucose pentapropionate, fructose pentapropionate, mannose pentapropionate, galactose pentapropionate, maltose octapropionate, cellobiose octapropionate, sucrose octapropionate, xylitol pentapropionate, sorbitol hexapropionate, xylose tetrabutyrate, glucose pentabutyrate, fructose pentabutyrate, mannose pentabutyrate, galactose pentabutyrate, maltose octabutyrate, cellobiose octabutyrate, sucrose octabutyrate, xylitol pentabutyrate, sorbitol hexabutyrate, xylose tetrabenzoate, glucose pentabenzoate, fructose pentabenzoate, mannose pentabenzoate, galactose pentabenzoate, maltose octabenzoate, cellobiose octabenzoate, sucrose benzoate, xylitol pentabenzoate and sorbitol hexabenzoate. More preferred examples thereof include xylose tetraacetate, glucose pentaacetate, fructose pentaacetate, mannose pentaacetate, galactose pentaacetate, maltose octaacetate, cellobiose octaacetate, sucrose octaacetate, xylitol pentaacetate, sorbitol hexaacetate, xylose tetrapropionate, glucose pentapropionate, fructose pentapropionate, mannose pentapropionate, galactose pentapropionate, maltose octapropionate, cellobiose octapropionate, sucrose octapropionate, xylitol pentapropionate, sorbitol hexapropionate, xylose tetrabenzoate, glucose pentabenzoate, fructose pentabenzoate, mannose pentabenzoate, galactose pentabenzoate, maltose octabenzoate, cellobiose octabenzoate, sucrose benzoate, xylitol pentabenzoate and sorbitol hexabenzoate. Particularly preferred examples thereof include maltose octaacetate, cellobiose octaacetate, sucrose octaacetate, xylose tetrapropionate, glucose pentapropionate, fructose pentapropionate, mannose pentapropionate, galactose pentapropionate, maltose octapropionate, cellobiose octapropionate, sucrose octapropionate, xylose tetrabenzoate, glucose pentabenzoate, fructose pentabenzoate, mannose pentabenzoate, galactose pentabenzoate, maltose octabenzoate, cellobiose octabenzoate, sucrose benzoate, xylitol pentabenzoate and sorbitol hexabenzoate.

The carbohydrate derivative plasticizer preferably contains a pyranose structure or a furanose structure. The molecular weight of the carbohydrate derivative plasticizer is preferably from 300 to 1,000, and more preferably from 350 to 800. A ratio of substituent introduction per the total hydroxy groups is preferably from 0.2 to 1.0, and more preferably from 0.2 to 0.8.

As the carbohydrate derivative plasticizer which can be used in the invention, compounds set forth below are particularly preferred. However, the carbohydrate derivative plasticizer which can be used in the invention should not be construed as being limited thereto. In the structural formulae below, R each independently represents an appropriate substituent, and plural Rs may be the same or different from each other. In the structures below, Substituent 1 and Substituent 2 each represents an appropriate R. The substitution degree denotes a number of substituents for Rs. The expression “None” means that R is a hydrogen atom.

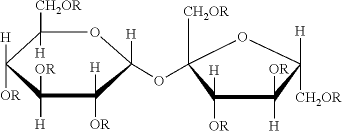

| | Substituent 1 | | Substituent 2 | | |
|---|---|---|---|---|---|
| Com- | | Substitution | | Substitution | Molecular |
| pound | Kind | Degree | Kind | Degree | Weight |
| K-101 | Acetyl | 7 | Benzyl | 1 | 727 |
| K-102 | Acetyl | 6 | Benzyl | 2 | 775 |
| K-103 | Acetyl | 7 | Benzoyl | 1 | 741 |
| K-104 | Acetyl | 6 | Benzoyl | 2 | 802 |
| K-105 | Benzyl | 2 | None | 0 | 523 |
| K-106 | Benzyl | 3 | None | 0 | 613 |
| K-107 | Benzyl | 4 | None | 0 | 702 |
| K-108 | Acetyl | 7 | Phenylacetyl | 1 | 771 |
| K-109 | Acetyl | 6 | Phenylacetyl | 2 | 847 |
| K-110 | Benzoyl | 1 | None | 0 | 446 |
| K-111 | Benzoyl | 2 | None | 0 | 551 |
| K-112 | Benzoyl | 3 | None | 0 | 655 |
| K-113 | Benzoyl | 4 | None | 0 | 759 |
| K-114 | Benzoyl | 5 | None | 0 | 863 |
| K-115 | Benzoyl | 6 | None | 0 | 967 |
| K-116 | Benzoyl | 7 | None | 0 | 1,071 |
| K-117 | Benzoyl | 8 | None | 0 | 1,175 |

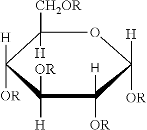

| | Substituent 1 | | Substituent 2 | | |
|---|---|---|---|---|---|
| | | Substitution | | Substitution | Molecular |
| Compound | Kind | Degree | Kind | Degree | Molecular Weight |
| K-201 | Acetyl | 4 | Benzoyl | 1 | 468 |
| K-202 | Acetyl | 3 | Benzoyl | 2 | 514 |
| K-203 | Acetyl | 2 | Benzoyl | 3 | 577 |
| K-204 | Acetyl | 4 | Benzyl | 1 | 454 |
| K-205 | Acetyl | 3 | Benzyl | 2 | 489 |
| K-206 | Acetyl | 2 | Benzyl | 3 | 535 |
| K-207 | Acetyl | 4 | Phenylacetyl | 1 | 466 |
| K-208 | Acetyl | 3 | Phenylacetyl | 2 | 543 |
| K-209 | Acetyl | 2 | Phenylacetyl | 3 | 619 |
| K-210 | Phenylacetyl | 1 | None | 0 | 298 |
| K-211 | Phenylacetyl | 2 | None | 0 | 416 |
| K-212 | Phenylacetyl | 3 | None | 0 | 535 |
| K-213 | Phenylacetyl | 4 | None | 0 | 654 |
| K-214 | Acetyl | 1 | Benzoyl | 4 | 639 |
| K-215 | Acetyl | 0 | Benzoyl | 5 | 701 |

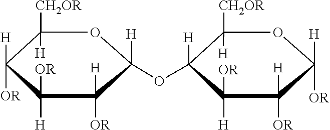

| | Substituent 1 | | Substituent 2 | | |
|---|---|---|---|---|---|
| | | Substitution | | Substitution | |
| Compound | Kind | Degree | Kind | Degree | Molecular Weight |
| K-301 | Acetyl | 6 | Benzoyl | 2 | 803 |
| K-302 | Acetyl | 6 | Benzyl | 2 | 775 |
| K-303 | Acetyl | 6 | Phenylacetyl | 2 | 831 |
| K-304 | Benzoyl | 2 | None | 0 | 551 |
| K-305 | Benzyl | 2 | None | 0 | 522 |
| K-306 | Phenylacetyl | 2 | None | 0 | 579 |

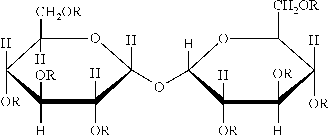

| | Substituent 1 | | Substituent 2 | | |
|---|---|---|---|---|---|
| | | Substitution | | Substitution | |
| Compound | Kind | Degree | Kind | Degree | Molecular Weight |
| K-401 | Acetyl | 6 | Benzoyl | 2 | 803 |
| K-402 | Acetyl | 6 | Benzyl | 2 | 775 |
| K-403 | Acetyl | 6 | Phenylacetyl | 2 | 831 |
| K-404 | Benzoyl | 2 | None | 0 | 551 |
| K-405 | Benzyl | 2 | None | 0 | 522 |
| K-406 | Phenylacetyl | 2 | None | 0 | 579 |

### (Procurement Method)

As to the procurement method of the carbohydrate derivative plasticiaer, it is available as commercial products, for example, from Tokyo Chemical Industry Co., Ltd. or Sigma-Aldrich, or it can be synthesized by applying a well-known ester derivative-forming method (for example, a method described in JP-A-8-245678) to a commercially available carbohydrate.

The content of the carbohydrate derivative plasticizer is preferably from 1 to 30 parts by weight based on 100 parts by weight of the main component resin constituting the protective film for polarizing plate (the term “main component resin” means a resin which has the largest content weight ratio of the resins contained in the protective film for polarizing plate). When the content thereof is 1 part by weight or more, the effect of improving polarizer durability is apt to be obtained, whereas when it is 30% by weight or less, the bleed out or seepage hardly occur when the protective film for polarizing plate is formed. The content of the carbohydrate derivative plasticizer is more preferably from 5 to 20 parts by weight, particularly preferably from 5 to 15 parts by weight, based on 100 parts by weight of the resin.

### (Aromatic Terminal Ester Compound)

The compound represented by formula (4) shown below (hereinafter referred to as an “aromatic terminal ester compound”) can also be preferably used as the hydrophobizing agent of the protective film for polarizing plate.

B-(G-A)ₙ-G-B Formula (4)

In formula (4), B each independently represents a benzenemonocarboxylic acid residue. G each independently represents an alkylene glycol residue having from 2 to 12 carbon atoms, an aryl glycol residue having from 6 to 12 carbon atoms or an oxyalkylene glycol residue having from 4 to 12 carbon atoms. A represents an alkylenedicarboxylic acid residue having from 4 to 12 carbon atoms or an aryldicarboxylic acid residue having from 6 to 12 carbon atoms. n represents an integer of 0 or more.

The aromatic terminal ester compound represented by formula (4) is composed of the benzenemonocarboxylic acid residue represented by B, the alkylene glycol residue, oxyalkylene glycol residue or aryl glycol residue represented by G, and the alkylenedicarboxylic acid residue or aryldicarboxylic acid residue represented by A in formula (4), and is obtained by the same reaction as in an ordinary polyester (polycondensation ester).

The term “residue” as used herein indicates a partial structure of the aromatic terminal ester compound represented by formula (4) and represents a partial structure having the characteristic of the monomer constituting the compound (polymer). For example, the monocarboxylic acid residue formed from a monocarboxylic acid of R—COOH is R—CO—.

Examples of benzenemonocarboxylic acid for the benzenemonocarboxylic acid residue include benzoic acid, p-tert-butylbenzoic acid, o-toluic acid, m-toluic acid, p-toluic acid, dimethylbenzoic acid, ethylbenzoic acid, n-propylbenzoic acid, aminobenzoic acid and acetoxybenzoic acid. The benzenemonocarboxylic acids may be used individually or as a mixture of two or more thereof.

Of the benzenemonocarboxylic acids, benzoic acid, o-toluic acid, m-toluic acid or p-toluic acid is preferred, and benzoic acid, o-toluic acid or m-toluic acid is more preferred.

An alkylene glycol for the alkylene glycol residue is an alkylene glycol having from 2 to 12 carbon atoms, preferably having from 2 to 6 carbon atoms, and more preferably having 2 or 3 carbon atoms.

Examples of the alkylene glycol include ethylene glycol, 1,2-propylene glycol, 1,3-propylene glycol, 1,2-butanediol, 1,3-butanediol, 2-methyl-1,3-propanediol, 1,4-butanediol, 1,5-pentanediol, 2,2-dimethyl-1,3-propanediol (neopentyl glycol), 2,2-diethyl-1,3-propanediol (3,3-dimethylolpentane), 2-n-butyl-2-ethyl-1,3-propanediol (3,3-dimethylolheptane), 3-methyl-1,5-pentanediol, 1,6-hexanediol, 2,2,4-trimethyl-1,3-pentanediol, 2-ethyl-1,3-hexanediol, 2-methyl-1,8-octanediol, 1,9-nonanediol, 1,10-decanediol and 1,12-octadecanediol. The alkylene glycols may be used individually or as a mixture of two or more thereof.

Of the alkylene glycols, 1,4-butanediol, ethylene glycol, 1,2-propylene glycol or 1,3-propylene glycol is preferred, and ethylene glycol, 1,2-propylene glycol or 1,3-propylene glycol is more preferred.

An oxyalkylene glycol for the oxyalkylene glycol residue is an oxyalkylene glycol having from 4 to 12 carbon atoms, preferably having from 4 to 8 carbon atoms, and more preferably having from 4 to 6 carbon atoms.

Examples of the oxyalkylene glycol include diethylene glycol, triethylene glycol, tetraethylene glycol, dipropylene glycol and tripropylene glycol. The oxyalkylene glycols may be used individually or as a mixture of two or more thereof.

Of the oxyalkylene glycols, diethylene glycol or dipropylene glycol is preferred, and diethylene glycol is more preferred.

An aryl glycol for the aryl glycol residue is an aryl glycol having from 6 to 12 carbon atoms, and preferably having from 6 to 8 carbon atoms.

Examples of the aryl glycol include hydroquinone, resorcin and bisphenol, for example, bisphenol A or bisphenol F. The aryl glycols may be used individually or as a mixture of two or more thereof.

Of the aryl glycols, hydroquinone or resorcin is preferred, and hydroquinone is more preferred.

An alkylenedicarboxylic acid for the alkylenedicarboxylic acid residue is an alkylenedicarboxylic acid having from 4 to 12 carbon atoms, preferably having from 4 to 10 carbon atoms, and more preferably having from 4 to 8 carbon atoms.

Examples of the alkylenedicarboxylic acid include succinic acid, maleic acid, fumaric acid, glutaric acid, adipic acid, azelaic acid, sebacic acid and dodecanedicarboxylic acid. The alkylenedicarboxylic acids may be used individually or as a mixture of two or more thereof.

Of the alkylenedicarboxylic acids, succinic acid or maleic acid is preferred, and succinic acid is more preferred.

An aryldicarboxylic acid for the aryldicarboxylic acid residue is an arylenedicarboxylic acid having from 6 to 12 carbon atoms, and preferably having from 8 to 12 carbon atoms.

Examples of the aryldicarboxylic acid include phthalic acid, terephthalic acid, 1,5-naphthalenedicarboxylic acid and 1,4-naphthalenedicarboxylic acid. The aryldicarboxylic acids may be used individually or as a mixture of two or more thereof.

Of the aryldicarboxylic acids, 1,5-naphthalenedicarboxylic acid, phthalic acid or terephthalic acid is preferred, and phthalic acid or terephthalic acid is more preferred.

In formula (4), n is preferably from 0 to 4, more preferably from 1 to 3, and still more preferably 1 or 2.

The aromatic terminal ester compound according to the invention preferably has a number average molecular weight from 300 to 2,000, and more preferably from 500 to 1,500. Further, the acid value thereof is preferably 0.5 mg KOH/g or less and the hydroxy value thereof is ordinarily 25 mg KOH/g or less. More preferably, the acid value is 0.3 mg KOH/g or less and the hydroxy value is 15 mg KOH/g.

### (Acid Value and Hydroxy Value of Aromatic Terminal Ester Compound)

The term “acid value” as used herein means a milligram number of potassium hydroxide necessary for neutralizing an acid (a carboxyl group present at a molecular terminal) contained in one gram of a sample.

The term “hydroxy value” as used herein means a milligram number of potassium hydroxide necessary for neutralizing acetic acid connected with an OH group contained in one gram of a sample.

The acid value and hydroxy value are measured in accordance with JIS K 0070.

Synthetic examples of the aromatic terminal ester plasticizer according to the invention are described below.

### <Sample No. 1 (Aromatic Terminal Ester Sample)>

In a reaction vessel were charged collectively 820 parts (5 mol) of phthalic acid, 608 parts (8 mol) of 1,2-propylene glycol, 610 parts (5 mol) of benzoic acid and 0.30 parts of tetraisopropyl titanate as a catalyst, and the mixture was continued to heat at 130 to 250° C. with stirring under a nitrogen stream while excess monohydric alcohol was refluxed with a reflux condenser until the acid value becomes 2 or less, thereby continuously removing the water generated. Then, the distillate was removed at 200 to 230° C. under a reduced pressure of 6.65×10³ Pa and finally 4×10² Pa or less, followed by filtration to obtain the aromatic terminal ester having the properties shown below.

Viscosity (25° C., mPa·s): 19815

Acid value: 0.4

### <Sample No. 2 (Aromatic Terminal Ester Sample)>

In the same manner as in Sample No. 1 except for using 500 parts (3.5 mol) of adipic acid, 305 parts (2.5 mol) of benzoic acid, 583 parts (5.5 mol) of diethylene glycol and 0.45 parts of tetraisopropyl titanate as a catalyst, the aromatic terminal ester having the properties shown below was obtained.

Viscosity (25° C., mPa·s): 90

Acid value: 0.05

### <Sample No. 3 (Aromatic Terminal Ester Sample)>

In the same manner as in Sample No. 1 except for using 410 parts (2.5 mol) of phthalic acid, 610 parts (5 mol) of benzoic acid, 737 parts (5.5 mol) of dipropylene glycol and 0.40 parts of tetraisopropyl titanate as a catalyst, the aromatic terminal ester having the properties shown below was obtained.

Viscosity (25° C., mPa·s): 43400

Acid value: 0.2

Specific examples of the aromatic terminal ester plasticizer according to the invention are set forth below, but the invention should not be construed as being limited thereto.

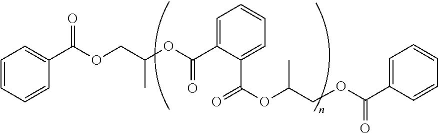

| Additive | n | Molecular Weight |
|---|---|---|
| AA-0 | 0 | 284 |
| AA-1 | 1 | 491 |
| AA-2 | 2 | 697 |
| AA-3 | 3 | 903 |

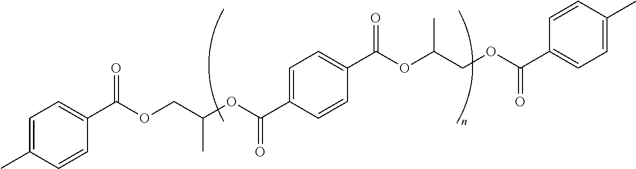

| Additive | n | Molecular Weight |
|---|---|---|
| B-0 | 0 | 312 |
| B-1 | 1 | 519 |
| B-2 | 2 | 725 |
| B-3 | 3 | 931 |

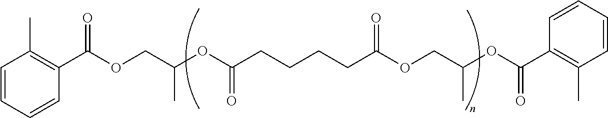

| Additive | n | Molecular Weight |
|---|---|---|
| C-0 | 0 | 312 |
| C-1 | 1 | 471 |
| C-2 | 2 | 657 |
| C-3 | 3 | 843 |

The content of the compound represented by formula (4) for use in the invention is preferably from 2 to 20 parts by weight, more preferably from 5 to 15 parts by weight, based on 100 parts by weight of the main component resin constituting the protective film for polarizing plate.

In the cellulose acylate film according to the invention, from the standpoint of decreasing the haze of the film, two or more kinds of the compounds represented by formula (4) may be used. The total content of the compounds in the case of using two or more kinds thereof is preferably in the range described above. In the case of using two or more kinds of the compounds, it is particularly preferred from the standpoint of decreasing the haze of the film to use by mixing compounds having different values of n in the structure described above.

### [Production Method of Polarizing Plate]

With respect to the production method of the polarizing plate according to the invention, production method of a protective film for polarizing plate, production method of a polarizer, stack method of the protective film for polarizing plate and the polarizer, functionalization of the polarizing plate will be described in order below.

### <Production Method of Protective Film for Polarizing Plate>

The protective film for polarizing plate can be produced by a solvent casting method. Although an embodiment using cellulose acylate as the main component resin is explained for an example below as to the production method of the protective film for polarizing plate, the protective film for polarizing plate containing the compound (A) can be produced in the same manner by using the other resins.

In the solvent casting method, the film is produced using a solution (dope) prepared by dissolving cellulose acylate in an organic solvent.

The organic solvent preferably contains a solvent selected from an ether having from 3 to 12 carbon atoms, a ketone having from 3 to 12 carbon atoms, an ester having from 3 to 12 carbon atoms and a halogenated hydrocarbon having from 1 to 6 carbon atoms.

The ether, ketone and ester may have a cyclic structure. A compound having two or more functional groups of ether, ketone and ester (i.e., —O—, —CO— and —COO—) can also be used as the organic solvent. The organic solvent may have other functional group, for example, an alcoholic hydroxy group. In the case of the organic solvent having two or more functional groups, the number of the carbon atoms contained therein preferably falls within the preferred range of the number of carbon atoms described above for the solvent having any of the functional groups.

Examples of the ether having from 3 to 12 carbon atoms include diisopropyl ether, dimethoxymethane, dimethoxyethane, 1,4-dioxane, 1,3-dioxolane, tetrahydrofuran, anisole and phenetole.

Examples of the ketone having from 3 to 12 carbon atoms include acetone, methyl ethyl ketone, diethyl ketone, diisobutyl ketone, cyclohexanone and methylcyclohexanone.

Examples of the ester having from 3 to 12 carbon atoms include ethyl formate, propyl formate, pentyl formate, methyl acetate, ethyl acetate and pentyl acetate.

Examples of the organic solvents having two or more functional groups include 2-ethoxyethyl acetate, 2-methoxyethanol and 2-butoxyethanol.

The number of carbon atoms in the halogenated hydrocarbon having from 1 to 6 carbon atoms is preferably 1 or 2, and most preferably 1. The halogen atom of the halogenated hydrocarbon is preferably a chlorine atom. The ratio of the substitution of hydrogen with halogen is preferably from 25 to 75% by mole, more preferably from 30 to 70% by mole, still more preferably from 35 to 65% by mole, and most preferably from 40 to 60% by mole. Methylene chloride is the representative halogenated hydrocarbon.

Two or more kinds of the organic solvents may be used in combination.

A cellulose acylate solution (dope) can be prepared by a conventional method which comprises treatment at a temperature of 0° C. or higher (ordinary temperature or high temperature). The preparation of cellulose acylate solution can be conducted by using a process and apparatus for preparation of a dope in an ordinary solvent casting method. The ordinary method preferably uses a halogenated hydrocarbon (particularly, methylene chloride) as the organic solvent.

The amount of cellulose acylate in the cellulose acylate solution is preferably so adjusted that a solution prepared contains cellulose acylate in an amount from 10 to 40% by weight. The amount of cellulose acylate is more preferably from 10 to 30% by weight. An optional additive described hereinafter may have been added to the organic solvent (main solvent).

The cellulose acylate solution can be prepared by stirring cellulose acylate and the organic solvent at an ordinary temperature (from 0 to 40° C.). A solution of a high concentration may be stirred under pressurized and heated conditions. Specifically, cellulose acylate and the organic solvent are placed in a pressure vessel, sealed and stirred therein under pressure while heating at temperature within a range from temperature not lower than the boiling point of the solvent at atmospheric pressure to temperature at which the solvent does not boil. The heating temperature is ordinarily 40° C. or higher, preferably from 60 to 200° C., and more preferably from 80 to 110° C.

The ingredients may be placed in a vessel after rough mixing. The ingredients may be placed in a vessel successively. The vessel must be so designed that the contents may be stirred therein. An inert gas, for example, nitrogen gas may be introduced into the vessel to pressurize. Also, increase in vapor pressure of the solvent due to heating may be utilized. Alternatively, after sealing the vessel the respective ingredients may be added thereto under pressure.

In case of the heating, the vessel is preferably heated from the outside. For example, a jacket type heater may be used. A plate heater may be provided outside the vessel and liquid may be circulated through a pipe to heat the whole of the vessel.

The stirring is preferably conducted by a stirring blade disposed inside the vessel. The length of the stirring blade preferably reaches near the wall of the vessel. The tip of the stirring blade is preferably provided with a scraper so as to renew the liquid film on the inner wall of the vessel.

The vessel may be provided with an instrument, for example, a pressure gauze or a thermometer. In the vessel, the ingredients are dissolved in the solvent. The dope thus-prepared is taken out of the vessel after cooled, or after taken out it is cooled using, for example, a heat exchanger.

The cellulose acylate solution may also be prepared according to a cooling dissolution method. As to details of the cooling dissolution method, techniques described in Paragraph Nos. to [0122] of JP-A-2007-86748 may be employed.

The cellulose acetate film is produced by a solvent casting method using the cellulose acetate solution (dope) obtained. It is preferred to add a retardation developer to the dope. The dope is cast on a drum or a band and the solvent is evaporated to form a film. The dope before casting is preferably controlled at the concentration so as to have a solid content from 18 to 35%. The surface of the drum or band is preferably finished in a mirror state. The dope is preferably cast onto the drum or band having a surface temperature of 10° C. or lower.

The drying processes of the solvent cast method are described in U.S. Pat. Nos. 2,336,310, 2,367,603, 2,492,078, 2,492,977, 2,492,978, 2,607,704, 2,739,069 and 2,739,070, British Patents 640,731 and 736,892, JP-B-45-4554 (the term “JP-B” as used herein means an “examined Japanese patent publication”), JP-B-49-5614, JP-A-60-176834, JP-A-60-203430 and JP-A-62-115035. The drying on the band or drum may be conducted with blowing air or an inactive gas, for example, nitrogen.

The film formed is peeled from the drum or band and then further dried with a high-temperature air flow having successively changing temperature from 100 to 160° C., thereby removing the residual solvent through evaporation. The process is described in JP-B-5-17844. According to the process, the time from the casting to the peeling can be shortened. In order to conduct the process, the dope is preferably gelled at the surface temperature of the drum or band at the time of cast.

Using the cellulose acylate solution (dope) prepared, two or more layers may be cast to form a film. In this case, preferably, the cellulose acylate film is formed according to the solvent cast method. The dope is cast on a drum or a band and the solvent is evaporated to form a film. The dope before casting is preferably controlled at the concentration so as to have a solid content from 10 to 40%. The surface of the drum or band is preferably finished in a mirror state.

In the case of casting two or more layers of cellulose acylate solutions, the cellulose acylate solutions may be respectively cast through plural casting apertures capable of casting plural cellulose acylate solutions disposed at intervals in the traveling direction of the support to stack on the support, thereby forming a film. For example, methods described in JP-A-61-158414, JP-A-1-122419 and JP-A-11-198285 can be employed. The cellulose acylate solution may be cast through two casting apertures to form a film. For example, methods described in JP-B-60-27562, JP-A-61-94724, JP-A-61-94725, JP-A-61-104813, JP-A-61-158413 and JP-A-6-134933 can be employed. Also a casting method for cellulose acylate film wherein a flow of a high viscosity cellulose acylate solution is enveloped with a low viscosity cellulose acylate solution and the resulting high viscosity and low viscosity cellulose acylate solutions are simultaneously extruded as described in JP-A-56-162617 may be employed.

Alternatively, a film may be formed by using two casting apertures wherein a film is formed on a support through a first casting aperture and then peeled, and a second casting is conducted on the side of film brought into contact with the support through a second casting aperture. For example, method described in JP-B-44-20235 is employed.

The cellulose acylate solution to be cast may be the same solution or two or more of different cellulose acylate solutions may be used. In order to make plural cellulose acylate layers have respective functions, cellulose acylate solutions corresponding to the desired functions may be cast through the respective casting apertures. Further, the cellulose acylate solution according to the invention may be cast simultaneously with a solution for other functional layer (for example, an adhesive layer, a dye layer, an antistatic layer, an antihalation layer, an ultraviolet absorbing layer or a polarizing layer).

### (Addition of Polarizer Durability-Improving Agent)

The timing when the polarizer durability-improving agent is added to the cellulose acylate solution which is a resin material of the protective film for polarizing plate is not particularly restricted as far as it has been added at the film formation. For example, it may be added to the cellulose acylate solution at the time of synthesis of cellulose acylate or it may be mixed with cellulose acylate at the time of preparation of a dope.

### (Addition of Hydrophobizing Agent)

The timing when the hydrophobizing agent is added to the cellulose acylate solution which is a resin material of the protective film for polarizing plate is not particularly restricted as far as it has been added at the film formation. For example, it may be added to the cellulose acylate solution at the time of synthesis of cellulose acylate or it may be mixed with cellulose acylate at the time of preparation of a dope.

### (Addition of Ultraviolet Absorbing Agent)

In the invention, an ultraviolet absorbing agent may be added to the cellulose acylate solution from the viewpoint of preventing deterioration of polarizing plate, liquid crystal or the like. As to the ultraviolet absorbing agent, an ultraviolet absorbing agent is preferably used which is excellent in ability to absorb an ultraviolet ray having a wavelength of 370 nm or less and has low absorption in visible light at a wavelength of 400 nm or more from the viewpoint of excellent liquid crystal display performance. Specific examples of the ultraviolet absorbing agent which is preferably used in the invention include a hindered phenol compound, a hydroxybenzophenone compound, a benzotriazole compound, a salicylic acid ester compound, a benzophenone compound, a cyano acrylate compound and a nickel complex salt compound. Examples of the hindered phenol compound include 2,6-di-tert-butyl-p-cresol, pentaerythrityl-teterakis[3-(3,5-di-tert-butyl-4-hydroxyphenyl)propionate], N,N′-hexamethylenebis(3,5-di-tert-butyl-4-hydroxyhydrocinnamide), 1,3,5-trimethyl-2,4,6-tris(3,5-di-tert-butyl-4-hydroxybenzyl)benzene and tris(3,5-di-tert-butyl-4-hydroxybenzyl)isocyanurate. Examples of the benzotriazole compound include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis-(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxyhydrocinnamide), 1,3,5-trimethyl-2,4,6-tris(3,5-di-tert-butyl-4-hydroxybenzyl)benzene, 2(2′-hydroxy-3′,5′-di-tert-butylphenyl)-5-chlorobenzotriazole, (2(2′-hydroxy-3′,5′-di-tert-amylphenyl)-5-chlorobenzotriazole, 2,6-di-tert-butyl-p-cresol and pentaerythrityl-tetrakis[3-(3,5-di-tert-butyl-4-hydroxyphenyl)propionate]. The amount of the ultraviolet absorbing agent added is preferably from 0.1 to 10.0 parts by weight based on 100 parts by weight of the protective film for polarizing plate.

### (Addition of Other Additive)

A deterioration preventing agent (for example, an antioxidant, a peroxide decomposing agent, a radical inhibitor, a metal-inactivating agent, an acid scavenger or an amine) may be added to the protective film for polarizing plate. As to the deterioration preventing agent, there are descriptions in JP-A-3-199201, JP-A-5-197073, JP-A-5-194789, JP-A-5-271471 and JP-A-6-107854. The amount of the deterioration preventing agent added is preferably from 0.01 to 1% by weight, more preferably from 0.01 to 0.2% by weight of the solution (dope) prepared. The amount of the deterioration preventing agent added of 0.01% by weight or more is preferred because the effect of the deterioration preventing agent is sufficiently exerted and the amount of deterioration preventing agent added of 1% by weight or less is preferred because bleed out (seepage) or the like of the deterioration preventing agent on the surface of the protective film hardly occurs. Particularly preferred examples of the deterioration preventing agent include butylated hydroxytoluene (BHT) and tribenzylamine (TBA).

It is also preferred to add a fine particle as a matting agent to the protective film for polarizing plate. Examples of the fine particle for use in the invention include silicon dioxide, titanium dioxide, aluminum oxide, zirconium oxide, calcium carbonate, talc, clay, calcined kaolin, calcined calcium silicate, calcium silicate hydrate, aluminum silicate, magnesium silicate and calcium phosphate. Of the fine particles, those containing silicon are preferred from the standpoint of low turbidity and fine particle of silicon dioxide is particularly preferred. The fine particle of silicon dioxide preferably has an average primary particle size of 20 nm or less and an apparent specific gravity of 70 g/liter or more. The apparent specific gravity is more preferably from 90 to 200 g/liter, and still more preferably from 100 to 200 g/liter. The fine particle having a larger apparent specific gravity is more preferred because it makes possible to prepare a dispersion of high concentration to reduce haze and aggregates.

The fine particles ordinarily form a secondary particle having an average particle size from 0.1 to 3.0 μm, and they exist as an aggregate of the primary particles in the film, thereby forming projections having a size from 0.1 to 3.0 μm on the surface of the film. The average secondary particle size is preferably from 0.2 to 1.5 μm, more preferably from 0.4 to 1.2 μm, and most preferably from 0.6 μm to 1.1 μm. The primary and secondary particle sizes mean the diameters of the circumscribed circles of the particles in the film observed by a scanning electron microscope. Specifically, 200 particles in different places are observed, and the average value of the particles is defined as the average particle size.

As the fine particle of silicon dioxide, commercially available products, for example, AEROSIL R972, R972V, 8974, R812, 200, 200V, 300, R202, CW50,17600 (produced by Nippon Aerosil Co., Ltd.) are used. As the fine particle of zirconium oxide, commercial products, for example, AEROSIL R976 and R811 (produced by Nippon Aerosil Co., Ltd.) are used.

Of the fine particles, AEROSIL 200V and AEROSIL R972V are fine particles of silicon dioxide having the average primary particle size of 20 nm or less and the apparent specific gravity of 70 g/liter or more, and they are particularly preferred because they have a large effect for reducing the friction coefficient of the protective film for polarizing plate while maintaining low turbidity of the protective film for polarizing plate.

In order to obtain the protective film for polarizing plate containing particles having a small average secondary particle size in the invention, several methods are considered at the time of preparing the dispersion of fine particles. For example, there is a method wherein a dispersion of fine particles is previously prepared by mixing a solvent and fine particles with stirring, the dispersion of fine particles is added to a small amount of cellulose acylation solution separately prepared under stilling and then the resulting mixture is mixed with a cellulose acylate solution (dope) as the main component. This method is a preferred preparation method from the standpoints that the dispersibility of fine particle of silicon dioxide is good and the fine particles of silicon dioxide hardly reaggregate. Also, there is a method wherein a small amount of cellulose ester is added to a solvent to dissolve by stirring and the fine particles are added thereto, followed by dispersing by a disperser to prepare a fine particle addition liquid and then, the fine particle addition liquid is thoroughly mixed with a dope solution using an in-line mixer. The invention should not be construed as being limited to these methods. The concentration of silica dioxide fine particle to be mixed and dispersed in a solvent or the like is from 5 to 30% by weight, more preferably from 10 to 25% by weight, and most preferably from 15 to 20% by weight. The higher the dispersion concentration of silica dioxide fine particle, the lower the liquid turbidity relative to the amount of addition and the haze and aggregates are preferably more reduced. The amount of the fine particle of matting agent in the final dope solution of cellulose acylate is preferably from 0.01 to 1.0 g, more preferably from 0.03 to 0.3 g, and most preferably from 0.08 to 0.16 g, per 1 m².

Examples of the solvent used in the method described above include a lower alcohol, for example, methyl alcohol, ethyl alcohol, propyl alcohol, isopropyl alcohol or butyl alcohol. Other solvents than the lower alcohol are not particularly restricted, and solvents used in the film formation from cellulose ester are preferably used.

The processes from casting to post-drying may be performed under air atmosphere or under inactive gas atmosphere, for example, nitrogen gas. The winding machine for use in the production of the protective film for polarizing plate according to the invention may be any winding machine ordinarily employed. The film may be wound according to a winding method, for example, a constant tension method, a constant torque method, a tapered tension method, a programmed tension control method where the internal stress is kept constant.

### (Stretching Treatment)

The protective film of polarizing plate may also be subjected to a stretching treatment. It is possible to impart the desired retardation to the protective film for polarizing plate by the stretching treatment. The stretching direction of cellulose acylate film is preferably any of the width direction and the longitudinal direction.

Examples of the method for stretching of the film in the width direction are described in JP-A-62-115035, JP-A-4-152125, JP-A-4-284211, JP-A-4-298310 and JP-A-11-48271.

The stretching of the film is conducted under heating conditions. The film may be stretched in a process for drying and this is effective for the film containing the remaining solvent. In the case of stretching in the longitudinal direction, for example, the film may be stretched by controlling a transporting roller speed so that the film winding speed is faster than the film peeling speed. In the case of stretching in the width direction, the film may be stretched by transporting the film while holding both sides of the width direction by a tenter and gradually increasing the width of the tenter. Alternatively, after drying, the film may be stretched by using a stretching machine (preferably, uniaxially stretched by using a long stretch machine).

The stretching of the protective film for polarizing plate is conducted preferably at a temperature from (Tg−5° C.) to (Tg+40° C.) wherein Tg is the glass transition temperature of the protective film for polarizing plate, more preferably from Tg to (Tg+35° C.), and particularly preferably from (Tg+10° C.) to (Tg+30° C.). In the case where the film is a dry film, the stretching is preferably conducted at a temperature from 130 to 200° C.

In the case where the film is stretched after casting while the dope solvent still remains therein, the stretching is possible at a lower temperature than that for stretching of dry film, and in this case, the film is preferably stretched at a temperature from 100 to 170° C.

The stretching ratio of the protective film for polarizing plate (percentage of elongation relative to the unstretched film) is preferably from 1 to 200%, and more preferably from 5 to 150%. In particular, the stretching ratio for width direction is preferably from 1 to 200%, more preferably from 5 to 150%, and particularly preferably from 10 to 45%.

The stretching speed is preferably from 1 to 300%/minute, more preferably from 10 to 300%/minute, and most preferably from 30 to 300%/minute.

Also, the protective film for polarizing plate is preferably produced, after stretched to the maximum stretching ratio, through a step of maintaining at a stretching ratio lower than the maximum stretching ratio for a predetermined period of time (hereinafter, the step may also be referred to as “relaxation step”). The stretching ratio in the relaxation step is preferably from 50 to 99% of the maximum stretching ratio, more preferably from 70 to 97%, and most preferably from 90 to 95%. The time for the relaxation step is preferably from 1 to 120 seconds, and more preferably from 5 to 100 seconds.

Further, the protective film for polarizing plate is preferably produced by including the shrinking step of shrinking the film while being held in the width direction.

In the production method which is characterized by including the stretching step of stretching the film in the width direction and the step of shrinking it in the transporting direction (in the longitudinal direction), the film is held by a pantograph-type or linear motor-type tenter and while stretched in the width direction, the film is shrunk in the transporting direction by gradually narrowing the distance between the clips.

The method descried above means that at least one part of the stretching step and one part of the shrinking step are simultaneously performed.

As the stretching device for stretching any one of the longitudinal direction and the width direction of the film and simultaneously shrinking it in the other direction with increasing the thickness of the film at the same time, an FITZ machine produced by Ichikin Co., Ltd. is preferably employed. The device is described in JP-A-2001-38802.

The stretching ratio in the stretching step and the shrinking ratio in the shrinking step may be appropriately selected and determined in accordance with the intended in-plane retardation Re and the thickness-direction retardation Rth of the film. It is preferred that the stretching ratio in the stretching step is 10% or more and the shrinking ratio in the shrinking step is 5% or more.

In particular, the production method preferably includes the step of stretching the film of 10% or more in the width direction and the step of shrinking the film of 5% or more in the transporting direction while being held in the width direction.

The shrinking ratio as referred to in the invention means the ratio of the length of the film after shrunk in the shrinking direction to the length of the film before the shrinking.

The shrinking ratio is preferably from 5 to 40%, and more preferably from 10 to 30%.

### [Film-Forming Method of Cellulose Acylate Film Using Peelable Stacked Film]

The cellulose acylate film can also be produced by peeling a cellulose acylate film from a peelable stacked film. The peelable stacked film preferably comprises a stack composed of layer A containing cellulose acylate and layer B containing a solution film-formable resin different from the cellulose acylate and the adhesion strength between layer A and layer B is 5 N/cm or less.

A preferred embodiment of the peelable stacked film is described below.

### <Layer Constitution of Peelable Stacked Film>

### (Thickness of Layer A)

The stack of the peelable stacked film is preferably a stack composed of layer A containing cellulose acylate and layer B containing a solution film-formable resin different from the cellulose acylate and the adhesion strength between layer A and layer B is 5 N/cm or less. Due to the constitution, in the peelable laminated film each layer has the property suitable as a thin layer under production conditions of a thick layer. The adhesion strength between the layer A and the layer B is preferably from 0.1 to 2.0 N/cm, more preferably from 0.1 to 1.8 N/cm, still more preferably from 0.2 to 1.0 N/cm, and particularly preferably from 0.2 to 0.7 N/cm. When the adhesion strength between the layers is too small, peeling occurs during transportation in the film-forming step to cause a production trouble. On the other hand, too large adhesion strength between the layers is not preferred, because deterioration of surface state, for example, uneven peeling occurs.

The total thickness of the stack including the layer A and layer B is preferably from 20 to 200 μm, more preferably from 20 to 180 μm, particularly preferably from 30 to 150 μm, and most preferably from 40 to 100 μm. When the total thickness is too small, the deterioration of surface state is concerned in view of film-forming aptitude. When the total thickness is too large, deterioration of the handling property or the like is concerned. The total thickness of the stack from 40 to 100 μm is also preferred because it is close to the thickness of cellulose film currently distributed, and diversion or introduction of various techniques, for example, transportation or processing and equipment are very easily performed.

The thickness of the layer A itself may be the desired thickness and is preferably from 5 to 60 μm, more preferably from 8 to 50 μm, still more preferably from 8 to 30 μm, and particularly preferably from 10 to 25 μm.

### (Thickness of Layer B)

The thickness of the layer B itself may be the desired thickness similar to the layer A.

However, in case of producing the layer B as a support for transportation, since the layer B is necessary to have an adequate mechanical performance to support and assist other layers, it preferably has a certain thickness.

### (Embodiment of Stack)

The peelable stacked film may further comprise layer C containing a solution film-formable resin different from the resins contained in the layer A and layer B in addition to the layer A and layer B. The peelable laminated film may have an alternating layer structure including plurality of the layers A, layers B and layers C, respectively.

### <B Layer>

In the peelable stacked film, the layer B contains a solution film-formable resin different from the cellulose acylate. In the specification, the solution film-formable resin different from the cellulose acylate includes a (meth)acrylic resin (also referred to as “(meth)acryl resin” or “(meth)acrylic acid resin”), a polycarbonate resin, a polystyrene resin, a cyclo-olefin resin and the like, and may be selected from the resins described above and mixed resins of several kinds thereof.

The layer B is preferably stacked so as to have a peeling property in that the adhesion strength to the layer A is 5N/cm or less.

In order to impart the peeling property, it is preferred that the compositions of the B layer and the A layer do not have compatibility and the resin and composition thereof are appropriately selected using an SP value (solubility parameter) as the index to form the layer B.

In order to impart the peeling property in the invention, the materials used for the respective layers are selected so that the difference in the SP value of the A layer and B layer is 0.2 or more. The SP value of the layer substantially corresponds to the SP value of the resin used in the layer. Therefore, in the invention, the difference in SP value of the resin (cellulose acylate) used in the A layer and the resin used in the B layer is preferably 0.2 or more. The difference in SP value is more preferably from 0.5 to 3.5, still more preferably from 1.0 to 3.5, and most preferably from 1.5 to 3.5. The solubility parameters indicate those described, for example, in J. Brandrup et al., Polymer Handbook, 4th edition, VII/671 to VII/714.

The term “(meth)acrylic resin” is a concept including both a methacrylic resin and an acrylic resin. Further, the (meth)acrylic resin also includes a derivative of acrylate/methacrylate, particularly a (co)polymer of acrylate/methacrylate.

### ((Meth)Acrylic Resin)

The repeating structural unit of the (meth)acrylic resin is not particularly restricted. The (meth)acrylic resin preferably contains a repeating structural unit derived from a (meth)acrylic ester monomer.

The (meth)acrylic ester is not particularly restricted and includes an acrylic ester, for example, methyl acrylate, ethyl acrylate, n-butyl acrylate, isobutyl acrylate, tert-butyl acrylate, cyclohexyl acrylate or benzyl acrylate and a methacrylic ester, for example, methyl methacrylate, ethyl methacrylate, propyl methacrylate, n-butyl methacrylate, isobutyl methacrylate, tert-butyl methacrylate, cyclohexyl methacrylate or benzyl methacrylate. The (meth)acrylic esters may be used only one kind or may be used in combination of two or more kinds thereof. Of the (meth)acrylic esters, methyl methacrylate is preferred from the standpoint of excellent heat resistance and transparency.

In the case of using the (meth)acrylic ester, the content thereof in the monomer component to be used in the polymerization step is preferably from 10 to 100% by weight, more preferably from 20 to 100% by weight, still more preferably from 40 to 100% by weight, particularly preferably from 50 to 100% by weight, in view of sufficiently exhibiting the effect of the invention.

The monomer component may form a lactone ring after polymerization. In this case, it is preferred to obtain a polymer having a hydroxy group and an ester group in the molecular chain by polymerizing the monomer component.

As the mode of polymerization reaction for obtaining a polymer having a hydroxy group and an ester group in the molecular chain by polymerizing the monomer component, a mode of polymerization using a solvent is preferred, and a solution polymerization is particularly preferred.

As the (meth)acrylic resin, an (meth)acrylic resin containing an alicyclic alkyl group as a copolymerization component or an (meth)acrylic resin having a cyclic structure in the molecular main chain formed by intramolecular cyclization may also be used. One preferred embodiment of the (meth)acrylic resin having a cyclic structure in the molecular main chain is a (meth)acrylic thermoplastic resin containing a lactone ring-containing polymer, and the preferred resin composition and synthetic method are described in JP-A-2006-171464. Another preferred embodiment of the (meth)acrylic resin is a resin containing glutaric anhydride as a copolymerization component, and the copolymer component and specific synthetic method are described in JP-A-2004-70296.

There is no limitation on the combination of a weight average molecular weight of the resin for forming the layer B and a weight average molecular weight of the resin of the layer A. The weight average molecular weight of the resin for forming the layer B may be appropriately selected so as to be optimal in the process of film formation.

The (meth)acrylic resin having a molecular weight of approximately 100,000 is ordinarily used for the film formation. More specifically, formation of a (meth)acrylic resin film having high molecular weight by melt film formation is intrinsically impossible. The (meth)acrylic resin film is able to be formed by a solution film formation, but in this case, it is necessary to prepare a dope having viscosity for conducting solution casting easily. A (meth)acrylic resin having a molecular weight of 300,000 or more is easy to prepare a dope having high casting aptitude and such a (meth)acrylic resin has been used in the film formation.

On the contrary, in the peelable stacked film, it is preferred to conduct film formation by using a (meth)acrylic resin having a higher weight average molecular weight in order to perform co-casting with cellulose acylate of the layer A. Specifically, the resin for forming the layer B for use in the peelable stacked film according to the invention preferably has a weight average molecular weight (Mw) from 600,000 to 4,000,000, more preferably from 800,000 to 2,000,000, still more preferably higher than 1,000,000 to 2,000,000, particularly preferably higher than 1,000,000 to 1,800,000, from the standpoint of brittleness as an optical film and self-film forming property. In the case of using the (meth)acrylic resin, the weight average molecular weight of the (meth)acrylic resin as the main component is preferably from 600,000 to 4,000,000, and more preferably from 800,000 to 2,000,000. The term “main component” means a component having the highest content (% by weight) of the components constituting the layer.

The weight average molecular weight of the resin for forming the layer B can be measured by gel permeation chromatography.

The resin for forming the layer B is particularly preferably a (meth)acrylic resin having a weight average molecular weight from 800,000 to 2,000,000 and containing 50% by weight or more of a methyl methacrylate unit in the molecule.

The resin for forming the layer B preferably has glass transition temperature (Tg) of 90° C. or higher, more preferably 100° C. or higher, and still more preferably 110° C. or higher.

The peeling strength of the layer A from the layer B is preferably adjusted by adding an additive described below to the layer B, and the peeling strength is controlled by controlling the hydrophilicity and hydrophobicity of the additive with respect to the balance of hydrophilicity and hydrophobicity of the main polymer resins of the layer A and layer B. It can also be appropriately adjusted by changing the solvent composition of the solvent used.

### (Polycarbonate Resin)

As the layer B according to the invention, a commercially available polycarbonate resin to which an additive is added for the purpose of appropriately controlling the peeling strength or toughness is used.

### (Polystyrene Resin)

As the layer B according to the invention, a commercially available polystyrene resin to which an additive is added for the purpose of appropriately controlling the peeling strength or toughness is used.

### (Cyclic Polyolefin Resin)

A cyclic polyolefin resin may be used in the layer B according to the invention. The term “cyclic polyolefin resin” (also referred to as a “cyclic polyolefin” or a “cyclic polyolefin polymer”) means a polymer resin having a cyclic olefin structure.

Examples of the polymer resin having a cyclic olefin structure for use in the invention include (1) a norbornene polymer, (2) a monocyclic olefin polymer, (3) a cyclic conjugated diene polymer, (4) a vinyl alicyclic hydrocarbon polymer, and hydrides of (1) to (4).

(Other Thermoplastic Resin which May be Contained in Layer B)

The layer B according to the invention may contain a thermoplastic resin other than the resin described above. The other thermoplastic resin is not particularly restricted as long as it is not contrary to the spirit of the invention. The thermoplastic resin thermodynamically compatible is preferred from the standpoint of improving mechanical strength and desired physical property.

The other thermoplastic resin described above includes, for example, an olefin polymer, for example, polyethylene, polypropylene, an ethylene-propylene copolymer or poly(4-methyl-1-pentene); a halogen-containing polymer, for example, vinyl chloride or a chlorinated vinyl resin; an acrylic polymer, for example, polymethyl methacrylate; a styrene polymer, for example, polystyrene, a styrene-methyl methacrylate copolymer, a styrene-acrylonitrile copolymer or an acrylonitrile-butadiene-styrene block copolymer; a polyester, for example, polyethylene terephthalate, polybutylene terephthalate or polyethylene naphthalate; a polyamide, for example, nylon 6, nylon 66 or nylon 610; a polyacetal; a polycarbonate; a polyphenylene oxide; a polyphenylene sulfide; a polyetheretherketone; a polysulfone; a polyether sulfone; a polyoxybenzylene; a polyamideimide; and a rubber polymer, for example, an ABS resin or ASA resin obtained by blending polybutadiene rubber or acrylic rubber. The rubber polymer preferably has a graft portion compatible with the lactone ring polymer on the surface. The average particle size of the rubber polymer is preferably 100 nm or less, more preferably 70 nm or less, from the standpoint of increasing transparency when a film is formed.

As the thermoplastic resin thermodynamically compatible with the resin for forming the layer B, a copolymer containing a vinyl cyanide monomer unit and an aromatic vinyl monomer unit, specifically, an acrylonitrile-styrene copolymer, a polyvinyl chloride resin or a polymer containing 50% by weight or more of a methacrylic acid ester is preferably used. By using the acrylonitrile-styrene copolymer, the layer B having the glass transition temperature of 120° C. or higher, the retardation per 100 μm in the plane direction of 20 nm or less, and the total light transmittance of 85% or more can be easily obtained.

In the case where the layer B contains the other thermoplastic resin described above, the content ratio of the resin for forming the layer B and the other thermoplastic resin is preferably 60 to 99:1 to 40% by weight, more preferably 70 to 97:3 to 30% by weight, and still more preferably 80 to 95:5 to 20% by weight. When the layer B is also used as an optical film, in view of polymer blend, it is preferred not to contain the other thermoplastic resin described above as long as the compatibility thereof is not considerably high.

### (Residual Solvent Amount)

As to the peelable stacked film, the film formation is preferably conducted by stacking using co-casting or sequential casting. By forming the layer B containing a solution film-formable resin different from the cellulose acylate according to the solution film formation, the surface state of the layer A can be improved in comparison with the case where the layer containing a solution film-formable resin different from the cellulose acylate is formed according to the melt film formation.

### <Additive>

Into the peelable stacked film, in each of the layer A and the layer B, an additive, for example, a plasticizer, a brittle improving agent, an interlayer peeling accelerator between the layer A and the layer B, an antistatic agent, a filler, an ultraviolet absorbing agent, a free acid, a radical trapping agent or a particle may be incorporated together with one or two or more of the thermoplastic resins as the main raw material as long as the additive is not contrary to the spirit of the invention.

### (Thickness)

The thickness of the protective film for polarizing plate is preferably from 5 to 60 μm, more preferably from 5 to 45 μm, and still more preferably from 5 to 35 urn.

### (Saponification Treatment)

The protective film for polarizing plate is subjected to an alkali saponification treatment to impart the adhesion property to a material, for example, polyvinyl alcohol of the polarizer and it is preferably used as the protective film for polarizing plate. As to the method for saponification, method described in Paragraph Nos. [0211] and [0212] of JP-A-2007-86748 can be used.

The alkali saponification treatment of the protective film for polarizing plate is preferably performed, for example, according to a cycle of immersing the film surface in an alkali solution, neutralizing it with an acid solution, washing it with water and drying it. The alkali solution includes a potassium hydroxide solution and a sodium hydroxide solution, in which the hydroxide ion concentration preferably falls within a range from 0.1 to 5.0 mol/liter, and more preferably from 0.5 to 4.0 mol/liter. The alkali solution temperature is preferably from room temperature to 90° C., and more preferably from 40 to 70° C.

In place of the alkali saponification treatment, an easy adhesion process as described in JP-A-6-94915 and JP-A-6-118232 may be applied.

### <Polarizer>

The polarizer for use in the polarizing plate according to the invention is described below.

The polarizer which can be used in the polarizing plate according to the invention is preferably composed of polyvinyl alcohol (PVA) and a dichroic molecule. A polyvinylene polarizer prepared by dehydrating or dechlorinating PVA or polyvinyl chloride to form a polyene structure and orienting it as described in JP-A-11-248937 can also be used.

### (PVA)

PVA is preferably a polymer material obtained by saponification of polyvinyl acetate and may contain a component copolymerizable with vinyl acetate, for example, an unsaturated carboxylic acid, an unsaturated sulfonic acid, an olefin or a vinyl ether. Further, a modified PVA containing, for example, an acetoactyl group, a sulfonic acid group, a carboxyl group or an oxyalkylene group can be used.

In addition, for the polarizing plate according to the invention, a PVA film having a 1,2-glycol binding amount of not more than 1.5% by mole described in Japanese Patent No. 3,021,494, a PVA film having the number of optical foreign matters having 5 μm or more of not more than 500 per 100 cm² described in JP-A-2001-316492, a PVA film having an unevenness in hot-water cutting temperature of not more than 1.5° C. in the TD direction of the film described in JP-A-2002-30163, a PVA film formed from a solution of PVA containing from 1 to 100 parts by weight of a trihydric to hexahydric polyhydric alcohol, for example, glycerin, mixed therewith, and a PVA film formed from a solution of PVA containing not less than 15% by weight of a plasticizer mixed therewith described in JP-A-6-289225 can be preferably used.

### (Dichroic Molecule)

As the dichroic molecule, a high-order iodine ion, for example, I₃⁻ or I₃⁻ or a dichroic dye can be preferably used.

In the invention, a high-order iodine ion is particularly preferably used. The high-order iodine ion can be formed by immersing PVA in a solution prepared by dissolving iodine in an aqueous potassium iodide solution and/or an aqueous boric acid solution, thereby adsorbing and orienting in PVA as described in Henkoban no Oyo (Applications of Polarizing Plate), edited by Ryo Nagata, published by CMC Publishing Co., Ltd. and Kogyo Zairyo (Industrial Materials), Vol. 28, No. 7, pages 39 to 45.

In the case of using a dichroic dye as the dichroic molecule, an azo dye is preferred, and a bisazo dye or a trisazo is particularly preferred. The dichroic dye is preferably a water-soluble dichroic dye. Therefore, a hydrophilic substituent, for example, a sulfonic acid group, an amino group or a hydroxy group is preferably introduced into the dichroic molecule to use as a free acid or an alkali metal salt, an ammonium salt or an amine salt. Specific examples of the dichroic dye include those described in JP-A-2007-86748.

### (Boric Acid)

The polarizing plate according to the invention preferably contains boric acid as a crosslinking agent in the polarizer thereof. By crosslinking the polarizer with boric acid, stability of the complex formed from a dichroic molecule and PVA increases to prevent degradation of the polarization performance under high temperature and high humidity conditions. The content of boric acid in the polarizer of the polarizing plate according to the invention is preferably from 1 to 100 parts by weight, more preferably from 5 to 50 parts by weight, based on 100 parts by weight of the polarizer. By controlling the content of boric acid in the range described above, a polarizer having a good balance of tint can be produced.

In the polarizing plate according to the invention, a decrease rate of boric acid in the polarizer before and after storage at 60° C. and relative humidity of 95% for 1,000 hours is preferably 50% or less, more preferably 40% or less, and still more preferably 30% or less.

### (Thickness of Polarizer)

The film thickness of the polarizer before stretching is not particularly restricted, and it is preferably from 1 μm to 1 mm, particularly preferably from 10 to 200 μm from the standpoints of stability of film retention and uniformity of stretching. A thin PVA film in which a stress generated at the time of stretching in water by from 4 to 6 times becomes 10 N or less as described in JP-A-2002-236212 may be used.

The thickness of the polarizer after stretching according to the invention is preferably from 3 to 25 μm, more preferably from 3 to 15 μm, and most preferably from 3 to 10 μm. By controlling the thickness of the polarizer as described above, warp or distortion of a liquid crystal panel due to environmental humidity can be reduced.

### <Production Method of Polarizer>

The method of producing the polarizer in the method of producing the polarizing plate according to the invention is not particularly restricted. For example, a film of PVA is formed and a dichroic molecule is introduced therein to constitute a polarizer. The production of PVA film can be conducted with reference to methods described, for example, in Paragraph Nos. [0213] to [0237] of JP-A-2007-86748, Japanese Patent No. 3,342,516, JP-A-9-328593, 2001-302817 and 2002-144401.

Specifically, it is preferred that the method of producing the polarizer is successively performed a preparing step of PVA resin solution, a casting step, a swelling step, a dyeing step, a curing step, a stretching step and a drying step in this order. During the steps or after the steps, an on-line surface state inspecting step may be provided.

### (Preparation of PVA Resin Solution)

In the preparing step of PVA resin solution, a stock solution is preferably prepared by dissolving a PVA resin in water or an organic solvent. The concentration of the polyvinyl alcohol resin in the stock solution is preferably from 5 to 20% by weight. For example, a method is preferred wherein a wet cake of PVA is put in a dissolution tank, if desired, a plasticizer and water are added thereto, and stirred with introducing water vapor thereinto from the bottom of the tank. The internal resin temperature is preferably from 50 to 150° C., and the system may be pressurized.

An acid may be added or may not be added to the polarizer and in case of adding the acid, it is preferably added in this step. In the case where an acid is added to the polarizer, the acid may be the same as the compound (A) contained in the protective film for polarizing plate.

### (Casting)

In the casting step, a method where the PVA resin stock solution prepared above is cast to form a film is preferably used. The casting method is not particularly restricted. Preferably, the PVA resin stock solution heated is fed into a double-screw extruder and cast on a support through a discharge means (preferably a die, more preferably a T-type slit die) by a gear pump to form a film. The temperature of the resin solution to be discharged through the die is not particularly restricted.

The support is preferably a cast drum, and the diameter, width, rotating speed and surface temperature of the drum are not particularly restricted.

Subsequently, the film formed is preferably subjected to drying by alternately bringing the rear surface and the front surface thereof into contact with a drying roll.

### (Swelling)

Although the swelling step is preferably carried out using only water, a polarizing plate base material may be swelled with an aqueous boric acid solution to regulate the swelling degree of polarizing plate base material in order to stabilize the optical performance and prevent the occurrence of crease in the polarizing plate base material in the production line as described in JP-A-10-153709.

The temperature and time of the swelling step may be appropriately decided and are preferably from 10 to 60° C. and from 5 to 2,000 seconds.

The film may be slightly stretched at the time of swelling step and, for example, it may be preferably stretched to about 1.3 times.

### (Dyeing)

The dyeing step may be conducted using a method described in JP-A-2002-86554. As the dyeing method, not only immersing, but also an appropriate means, for example, coating or spraying of an iodine or dye solution may be used. Further, a dyeing method may be used where the concentration of iodine, temperature of dyeing bath and stretching ratio in the bath are controlled while stirring the solution in the bath as described in JP-A-2002-290025.

In the case of using a higher order iodine ion as the dichroic molecule, a solution prepared by dissolving iodine in an aqueous potassium iodide solution is preferably used in the dyeing step in order to obtain a high-contrast polarizing plate. With respect to the weight ratio of iodine and potassium iodide in the iodine-potassium iodide solution, an embodiment described in JP-A-2007-86748 may be used.

Also, a boron compound, for example, boric acid or borax may be added to the dyeing solution as described in Japanese Patent No. 3,145,747.

### (Curing)

In the curing step, the film is preferably immersed in a crosslinking agent solution or coated with the solution, thereby introducing the crosslinking agent into the film. The curing step may be separately carried out in several steps as described in JP-A-11-52130.

As the crosslinking agent, those described in U.S. Reissue Pat. 232,897 may be used. Although a polyvalent aldehyde may be used as the crosslinking agent in order to improve the dimension stability as described in Japanese Patent No. 3,357,109, a boric acid compound is most preferably used. In the case of using boric acid as the crosslinking agent in the curing step, a metal ion may be added to an aqueous boric acid-potassium iodide solution. A compound containing the metal ion is preferably zinc chloride, and a zinc salt, for example, zinc halide, e.g., zinc iodide, zinc sulfate or zinc acetate may be used in place of zinc chloride as described in JP-A-2000-35512.

Also, an aqueous boric acid-potassium iodide solution containing zinc chloride is prepared and a PVA film is immersed in the solution to cure, and method described in JP-A-2007-86748 may be used.

An immersion treatment in an acidic solution which is known as a method for increasing durability in a high temperature environment may be or may not be conducted. As to the treatment with an acidic solution, methods described, for example, in JP-A-2001-83329, JP-A-6-254958 and WO 2006/095815 are exemplified.

### (Stretching)

In the stretching step, a vertical monoaxial stretching method as described, for example, in U.S. Pat. No. 2,454,515 or a tenter method as described in JP-A-2002-86554 can be preferably used. The stretching ratio is preferably from 2 to 12 times, and more preferably from 3 to 10 times. It is also preferred that the relation between a stretching ratio, a thickness of original film and a thickness of polarizer satisfies the condition of (Thickness of polarizer after attaching protective film/Thickness of original film)×(Total stretching ratio)>0.17 as described in JP-A-2002-40256, and that the relation between a width of polarizer taken from a final bath and a width of polarizer after attaching a protective film satisfies the condition of 0.80≦(Width of polarizer after attaching protective film/Width of polarizer taken from final bath)≦0.95 as described in JP-A-2002-40247.

### (Drying)

In the drying step, a known method described in JP-A-2002-86554 may be used, and the drying temperature is preferably from 30 to 100° C. and the drying time is preferably from 30 seconds to 60 minutes. It is also preferred that a heat treatment for controlling an in-water discoloring temperature at 50° C. or higher is conducted as described in Japanese Patent No. 3,148,513, and that an aging treatment in a controlled temperature and humidity environment is conducted as described in JP-A-7-325215 or JP-A-7-325218.

According to the steps, a polarizer having a thickness from 10 to 200 μm is preferably produced. The thickness of film can be controlled by a known method. For example, the thickness may be controlled by appropriately setting the die slit width in the casting step or the stretching conditions.

### <Stacking Method of Polarizer and Protective Film for Polarizing Plate>

In the method for producing a polarizing plate according to the invention, the protective film for polarizing plate is stacked on only one surface of the polarizer through an adhesive layer.

In the method for producing a polarizing plate according to the invention, preferably, the protective film for polarizing plate is subjected to an alkali treatment and then stuck to one surface of the polarizer which is prepared by immersing a polyvinyl alcohol film in an iodine solution and stretching, using an aqueous solution of completely saponified polyvinyl alcohol, thereby producing the polarizing plate.

The adhesive used for sticking the treated surface of the protective film for polarizing plate to the polarizer includes, for example, a polyvinyl alcohol adhesive, e.g., polyvinyl alcohol or polyvinyl butyral and a vinyl latex, e.g., butyl acrylate.

For the sticking of the protective film for polarizing plate to the polarizer in the polarizing plate according to the invention, it is preferred to be stuck each other so that the transmission axis of the polarizer is substantially parallel to the slow axis of the protective film for polarizing plate.

The term “substantially parallel” as used herein means that the difference between the direction of the main refractive index nx of the protective film for polarizing plate and the direction of the transmission axis of the polarizer is within 5°. The difference is preferably within 1°, and more preferably within 0.5°. The difference within 1° is preferred because the polarization performance of the polarizing plate under cross Nicol hardly decreases and light leakage hardly occurs.

### [Adhesive Layer]

The adhesive layer which is used for sticking the polarizer and the transparent protective film is not particularly restricted as long as it is optically transparent. Various kinds of adhesives including an aqueous type, a solvent type, a hot melt type and a radical curable type may be used and an aqueous adhesive or a radical curable adhesive is preferred.

The aqueous adhesive for forming the adhesive layer is not particularly restricted and includes, for example, a vinyl polymer type, a gelatin type, a vinyl latex type, a polyurethane type, an isocyanate type, a polyester type and an epoxy type. The adhesive layer comprising the aqueous adhesive may be formed by coating and drying of an aqueous solution of the aqueous adhesive. At the preparation of the aqueous solution, a crosslinking agent, other additives, a catalyst, for example, an acid may be blended, if desired. As the aqueous adhesive, for example, an adhesive containing a vinyl polymer is preferably used. As the vinyl polymer, a polyvinyl alcohol resin is preferred.

Also, a water-soluble crosslinking agent, for example, boric acid, borax, glutaraldehyde, melamine or oxalic acid may be incorporated into the polyvinyl alcohol resin. In the case where a polymer film of polyvinyl alcohol type is used as a polarizer, it is preferred to use an adhesive containing the polyvinyl alcohol resin in view of adhesiveness. Further, an adhesive containing a polyvinyl alcohol resin having an acetoacetyl group is more preferred in view of improvement in durability.

The polyvinyl alcohol resin includes polyvinyl alcohol obtained by saponification of polyvinyl acetate; its derivative; a saponification product of copolymer between vinyl acetate and a copolymerizable monomer; and a modified polyvinyl alcohol prepared by acetalization, urethanation, etherification, grafting or phosphorylation of polyvinyl alcohol. The monomer includes an unsaturated carboxylic acid, for example, maleic acid (anhydride), fumaric acid, crotonic acid, itaconic acid or (meth)acrylic acid, its ester, an α-olefin, for example, ethylene or propylene, (meth)allylsulfonic acid (its sodium salt), sodium sulfonate (its monoalkyl maleate), sodium disulfonate alkyl maleate, N-methylolacrylamide, alkali salt of acrylamidoalkylsulfonate, N-vinylpyrrolidone and an N-vinylpyrrolidone derivative. The polyvinyl alcohol resins may be used individually or in combination of two or more thereof.

The polyvinyl alcohol resin is not particularly restricted and the average polymerization degree thereof is ordinarily approximately from 100 to 5,000, preferably from 1,000 to 4,000 and the average saponification degree thereof is ordinarily approximately from 85 to 100% by mole, preferably from 90 to 100% by mole from the standpoint of adhesiveness.

The polyvinyl alcohol resin having an acetoacetyl group is obtained by reacting a polyvinyl alcohol resin with diketene according to a known method. Specific examples thereof include a method of adding diketene to a dispersion in which a polyvinyl alcohol resin is dispersed in a solvent, for example, acetic acid, a method of adding diketene to a solution in which a polyvinyl alcohol resin is dissolved in a solvent, for example, dimethylformamide or dioxane, and a method of bringing diketene gas or liquid diketene into direct contact with a polyvinyl alcohol resin.

The acetoacetyl group modification degree of the polyvinyl alcohol resin having an acetoacetyl group is not particularly restricted as long as it is 0.1% by mole or more. The acetoacetyl group modification degree of less than 0.1% by mole is not appropriate, because water resistance of the adhesive layer is insufficient. The acetoacetyl group modification degree is preferably approximately from 0.1 to 40% by mole, more preferably from 1 to 20% by mole, and particularly preferably from 2 to 7% by mole. When the acetoacetyl group modification degree exceeds 40% by mole, the effect of increasing water resistance is small. The acetoacetyl group modification degree is a value measured by NMR.

As the crosslinking agent, a crosslinking agent which is used in the polyvinyl alcohol adhesive may be used without any particular restriction. The amount of crosslinking agent blended may appropriately designed depending on the kind of polyvinyl alcohol resin or the like and is ordinarily approximately from 4 to 60 parts by weight, preferably approximately from 10 to 55 parts by weight, more preferably from 20 to 50 parts by weight, based on 100 parts by weight of the polyvinyl alcohol resin. In the range described above, good adhesiveness is obtained.

To improve the durability, the polyvinyl alcohol resin having an acetoacetyl group is used. In this case, the crosslinking agent is used ordinarily approximately from 4 to 60 parts by weight, preferably approximately from 10 to 55 parts by weight, more preferably from 20 to 50 parts by weight, based on 100 parts by weight of the polyvinyl alcohol resin as described above. When the amount of crosslinking agent blended is too large, the reaction of crosslinking agent proceeds in a short period of time to tends to cause gelation of the adhesive. As a result, a usable time limitation (pot life) is extremely decreased as the adhesive and industrial use becomes difficult.

As the adhesive, a resin solution containing a polyvinyl alcohol resin and a crosslinking agent is preferably used. The resin solution is ordinarily used as an aqueous solution. The concentration of resin solution is not particularly restricted and is ordinarily from 0.1 to 15% by weight, preferably from 0.5 to 10% by weight, considering the coating property and storage stability.

In the case where the adhesive layer is formed by the aqueous adhesive or the like, the thickness of adhesive layer is approximately from 10 to 300 nm. From the viewpoint of obtaining a uniform in-plane thickness and obtaining a sufficient adhesiveness, the thickness of adhesive layer is preferably from 10 to 200 nm, and more preferably from 20 to 150 nm.

After coating the aqueous adhesive, the polarizer and transparent protective film are stuck using a roll laminator or the like. The coating of the adhesive may be performed on either the transparent protective film or the polarizer or both of them. After the sticking, a drying step is conducted to form an adhesive layer made of the coating and drying layer. The drying temperature is ordinarily approximately from 5 to 150° C., preferably from 30 to 120° C., for 120 seconds or more, preferably 300 seconds or more.

As the radical curable adhesive, various kinds of adhesives including an active energy ray-curable type, for example, an electron beam-curable type or an ultraviolet ray-curable type, and a heat-curable type are exemplified. The active energy ray-curable type which can be cured in a short time is preferred. In particular, the electron beam-curable type is preferred. The electron beam-curable adhesive is used. By using an electron beam (that is, dry lamination) in the curing method of the adhesive which is used for sticking the polarizer and transparent protective film, the heating step as in the ultraviolet ray curing method becomes unnecessary so that the productivity can be extremely increased.

On the other hand, in the case where the adhesive layer is formed by the radical curable adhesive (electron beam-curable adhesive), the thickness of the adhesive layer is preferably from 0.1 to 20 μm, more preferably from 0.2 to 10 μm, and still more preferably from 0.3 to 8 μm. When the thickness is too small, the cohesive force of the adhesive itself is not obtained to tend not to achieve the adhesive strength. When the thickness of the adhesive layer exceeds 20 μm, the effect of the cure shrinkage of the adhesive itself occurs to tend to cause adverse effects on the optical property of the polarizing plate in addition to the problem of cost-up.

### [Cohesive Agent Layer]

The cohesive agent layer can be formed, for example, from a cohesive agent composition containing a cohesive polymer and a radiation-curable or heat-curable component. In the case where the cohesive agent composition contains the radiation-curable component, when an electron beam or the like is used as the radiation, the cohesive agent composition is not needed to contain a radiation cleavage polymerization initiator, but when an ultraviolet ray is used as the radiation, the cohesive agent composition contains a radiation cleavage polymerization initiator. On the other hand, in the case where the cohesive agent composition contains the heat-curable component, the cohesive agent composition contains a heat cleavage polymerization initiator.

### <Cohesive Polymer>

The cohesive polymer is not particularly restricted as long as it is a polymer having stickiness which is ordinarily used as a base polymer of cohesive agent. From the standpoint of easy control of stickiness balance, a polymer having Tg of −20° C. or less (ordinarily −100° C. or more) is preferred. Of the cohesive polymers, an acrylic polymer and a polyester polymer is preferably used, particularly considering compatibility with the radiation-curable component.

The acrylic polymer contains a monomer unit of alkyl(meth)acrylate as the main skeleton. The alkyl(meth)acrylate means an alkyl acrylate and/or an alkyl methacrylate and the term “(meth)” has the same meaning as the term “(meth)” used in the invention. The alkyl(meth)acrylate constituting the main skeleton of the acrylic polymer includes those containing a straight-chain or branched alkyl group having from 1 to 20 carbon atoms. The alkyl(meth)acrylate includes, for example, methyl(meth)acrylate, ethyl(meth)acrylate, propyl(meth)acrylate, butyl(meth)acrylate, 2-ethylhexyl(meth)acrylate, isooctyl(meth)acrylate, isononyl(meth)acrylate, isomyristyl(meth)acrylate and lauryl(meth)acrylate. The alkyl(meth)acrylates may be used individually or in combination. The average carbon number of the alkyl group is preferably from 3 to 9.

One or more kinds of copolymerizable monomers may be introduced into the acrylic polymer by copolymerization for the purpose of improving the adhesiveness and heat resistance. Specific examples of the copolymerizable monomer include a hydroxy group-containing monomer, for example, 2-hydroxyethyl(meth)acrylate, 2-hydroxypropyl(meth)acrylate, 4-hydroxybutyl(meth)acrylate, 6-hydroxyhexyl(meth)acrylate, 8-hydroxyoctyl(meth)acrylate, 10-hydroxydecyl(meth)acrylate, 12-hydroxylauryl(meth)acrylate or (4-hydroxymethylcyclohexyl)methyl acrylate; a carboxyl group-containing monomer, for example, (meth)acrylic acid, carboxyethyl(meth)acrylate, carboxypentyl(meth)acrylate, itaconic acid, maleic acid, fumaric acid or crotonic acid; an acid anhydride group-containing monomer, for example, maleic anhydride or itaconic anhydride; a caprolactone adduct of acrylic acid; a sulfonic acid group-containing monomer, for example, styrenesulfonic acid, allylsulfonic acid, 2-(meth)acrylamido-2-methylpropane sulfonic acid, (meth)acrylamidopropanesulfonic acid, sulfopropyl(meth)acrylate or (meth)acryloyloxynaphthalenesulfonic acid; and a phosphoric acid group-containing monomer, for example, 2-hydroxyethylacryloylphosphate.

Also, an (N-substitution)amide monomer, for example, (meta)acrylamide, N-hydroxy(meta)acrylamide, N,N-dimethyl(meta)acrylamide, N-butyl(meta)acrylamide, N-methylol(meta)acrylamide or N-methylolpropane(meta)acrylamide; an alkylaminoalkyl(meth)acrylate monomer, for example, aminoethyl(meth)acrylate, N,N-dimethylaminoethyl(meth)acrylate or tert-butylaminoethyl(meth)acrylate; an alkoxyalkyl(meth)acrylate monomer, for example, methoxyethyl(meth)acrylate or ethoxyethyl(meth)acrylate; a succinimide monomer, for example, N-(meta)acryloyloxymethylenesuccinimide, N-(meta)acryloyl-6-oxyhexamethylenesuccinimide, N-(meta)acryloyl-8-oxyoctamethylenesuccinimide or N-acryloylmorpholine; a maleimide monomer, for example, N-cyclohexylmaleimide, N-isopropylmaleimide, N-laurylmaleimide or N-pnenylmaleimide; and an itaconimide monomer, for example, N-methylitaconimide, N-ethylitaconimide, N-butylitaconimide, N-octylitaconimide, N2-ethylhexylitaconimide, N-cyclohexylitaconimide or N-laurylitaconimide are exemplified as a monomer for the purpose of property modification.

Further, as the monomer for property modification, a vinyl monomer, for example, vinyl acetate, vinyl propionate, N-vinylpyrrolidone, methylvinylpyrrolidone, vinylpyridine, vinylpiperidone, vinylpyrimidine, vinylpiperazine, vinylpyrazine, vinylpyrrole, vinylimidazole, vinyloxazole, vinylmorpholine, N-vinylcarboxylic acid amide, styrene, α-methylstyrene or N-vinylcaprolactam; a cyanoacrylate monomer, for example, acrylonitrile or methacrylonitrile; an epoxy group-containing acrylic monomer, for example, glycidyl(meth)acrylate; a glycol acrylate monomer, for example, polyethylene glycol(meth)acrylate, polypropylene glycol(meth)acrylate, methoxymethylene glycol(meth)acrylate or methoxypolypropylene glycol(meth)acrylate; and an acrylate ester monomer, for example, tetrahydrofurfuryl(meth)acrylate, fluorine(meth)acrylate, silicone(meth)acrylate or 2-methoxyethyl acrylate may be used.

The acrylic polymer contains the alkyl(meth)acrylate as the main component relative to the weight ratio in the total constituting monomers, and the ratio of the copolymerizable monomer in the acrylic polymer is not particularly restricted and preferably approximately from 0 to 30% by weight, more preferably approximately from 0.1 to 25% by weight, still more preferably approximately from 0.5 to 20% by weight, relative to the weight ratio in the total constituting monomers.

Of the copolymerizable monomers, the hydroxy group-containing monomer or carboxyl group-containing monomer is preferably used in view of the adhesiveness and durability. The monomer acts as a reaction point with a crosslinking agent. Since the hydroxy group-containing monomer, carboxyl group-containing monomer or the like has a high reactivity with an intermolecular crosslinking agent, it is preferably used in order to increase the cohesion property and heat resistance of the cohesive agent layer formed.

The average molecular weight of the acrylic polymer is not particularly restricted, and the weight average molecular weight is preferably approximately from 300,000 to 2,500,000. The acrylic polymer can be produced by various known means, and a radical polymerization method, for example, a bulk polymerization method, a solution polymerization method or a suspension polymerization method can be appropriately selected. As a radical polymerization initiator, various known azo and peroxide initiators can be used. The reaction temperature is ordinarily approximately from 50 to 80° C., and the reaction time is from 1 to 8 hours. Of the production methods described above, the solution polymerization method is preferred. As a solvent for the acrylic polymer, ethyl acetate, toluene or the like is ordinarily used. The solution concentration is ordinarily approximately from 20 to 80% by weight.

As the polyester polymer, a saturated polyester or copolyester of a polyhydric alcohol and a polyvalent carboxylic acid is ordinarily used.

The polyhydric alcohol includes a diol, for example, ethylene glycol, propylene glycol, hexamethylene glycol, neopentyl glycol, 1,2-cyclohexane dimethanol, 1,4-cyclohexane dimethanol, decamethylene glycol, 1,3-propanediol, 1,4-butanediol, 1,5-pentanediol, 1,6-hexadiol, 2,2-bis(4-hydroxyphenyl)propane and bis(4-hydroxyphenyl)sulfone.

The polyvalent carboxylic acid includes an aromatic dicarboxylic acid, for example, terephthalic acid, isophthalic acid, orthophthalic acid, 2,5-naphthalene dicarboxylic acid, 2,6-naphthalene dicarboxylic acid, 1,4-naphthalene dicarboxylic acid, 1,5-naphthalene dicarboxylic acid, diphenyl carboxylic acid, diphenoxyethane dicarboxylic acid, diphenylsulfone carboxylic acid or anthracene dicarboxylic acid; an alicyclic dicarboxylic acid, for example, 1,3-cyclopentane dicarboxylic acid, 1,3-cyclohexane dicarboxylic acid, 1,4-cyclohexane dicarboxylic acid, hexahydroterephthalic acid or hexahydroisophthalic acid; an aliphatic dicarboxylic acid, for example, malonic acid, dimethylmalonic acid, succinic acid, 3,3-diethylsuccinic acid, glutaric acid, 2,2-dimethylglutaric acid, adipic acid, 2-methyladipic acid, trimethyladipic acid, pimelic acid, azelaic acid, dimer acid, sebacic acid, suberic acid or dodeca dicarboxylic acid. As to the polyvalent carboxylic acid, two or more dicarboxylic acids, for example, a combination of an aromatic dicarboxylic acid and an aliphatic dicarboxylic acid are often used.

As the polyvalent alcohol and polyvalent carboxylic acid for use in the polyester polymer, various polyvalent alcohols and polyvalent carboxylic acids may be used without particular restriction, and a polymer polyol, for example, polycarbonate diol may be used as the polyvalent alcohol. The polyester polymer can be obtained from the diol component described above and a tri-valent or higher valent polyhydric alcohol and/or a tri-valent or higher valent carboxylic acid. The weight average molecular weight of the polyester polymer used is ordinarily 11,000 or more.

### <Curable Component>

As the radiation-curable or heat-curable component, a monomer and/or oligomer component capable of being radically polymerized upon radiation or heat is used.

The monomer and/or oligomer component capable of being radically polymerized upon radiation or heat includes a monomer and/or oligomer component having an unsaturated double bond, for example, a vinyl group, and in particular, a monomer and/or oligomer component having a (meth)acryloyl group is preferably used because of advantage in the excellent reactivity.

Specific examples of the monomer component having a (meth)acryloyl group include, for example, the monomers used for the acrylic polymer described above.

As the oligomer component having a (meth)acryloyl group capable of being radically polymerized, a polyester(meth)acrylate, epoxy(meth)acrylate, urethane(meth)acrylate or the like obtained by adding two or more unsaturated double bonds, for example, a (meth)acryloyl group or a vinyl group, as the functional group same as in the monomer component, to a skeleton of polyester, epoxy, urethane or the like is used. The number of the unsaturated double bonds is 2 or more, preferably 4 or more, and still more preferably 6 or more. The larger the number of the unsaturated double bonds, the amount of the curable component incorporated into the cohesive polymer becomes smaller.

Specific examples of the oligomer component having a (meth)acryloyl group include an ester compound between (meth)acrylic acid and a polyhydric alcohol, for example, tripropylene glycol di(meth)acrylate, tetraethylene glycol di(meth)acrylate, 1,6-hexanediol di(meth)acrylate, bisphenol A diglycidyl ether di(meth)acrylate, neopentyl glycol di(meth)acrylate, trimethylolpropane tri(meth)acrylate, pentaerythritol tri(meth)acrylate, pentaerythritol tetra(meth)acrylate, dipentaerythritol penta(meth)acrylate, dipentaerythritol hexa(meth)acrylate or caprolactone-modified dipentaerythritol hexa(meth)acrylate.

Other examples of the monomer and/or oligomer component capable of being radically polymerized include a cyanurate or isocyanurate compound, for example, 2-propenyl-di-3-butenyl cyanurate, 2-hydroxyethyl bis(2-acryloxyethyl) cyanurate, tris(2-acryloxyethyl) isocyanurate or tris(2-methacryloxyethyl) isocyanurate.

As to the blend ratio of the curable component to the cohesive polymer, the amount of the curable component is preferably from 20 to 200 parts by weight, more preferably from 50 to 150 parts by weight, still more preferably from 60 to 120 parts by weight, relative to 100 parts by weight of the cohesive polymer from the standpoints of the balance between stickiness before curing and hardness after curing and retention of shape as the cohesive agent layer before curing. In particular, in the case of using the curable component having 6 or more unsaturated double bonds, the effects of the invention are achieved even when the curable component is used at a small ratio of 100 parts by weight or less, further 90 parts by weight or less, still further 80 parts by weight or less, relative to 100 parts by weight of the cohesive polymer.

### <Polymerization Initiator>

The cohesive agent composition may be used as a radiation-curable or heat-curable cohesive agent composition. In the case of using radiation-curable cohesive agent composition, when an electron beam is adopted as the radiation, a radiation cleavage polymerization initiator is not particularly needed, but when an ultraviolet ray is adopted as the radiation, the radiation cleavage polymerization initiator is used. Further, in the case where the cohesive agent composition is the heat-curable cohesive agent component, a heat cleavage polymerization initiator is used.

The radiation cleavage polymerization initiator is appropriately selected depending on the radiation and an ultraviolet ray cleavage polymerization initiator is used in the case of curing with an ultraviolet ray. Examples of the ultraviolet ray cleavage polymerization initiator include a benzophenone compound, for example, benzyl, benzophenone, benzoyl benzoic acid or 3,3′-dimethyl-4-methoxybenzophenone; an aromatic ketone compound, for example, 4-(2-hydroxyethoxy)phenyl (2-hydroxy-2-propyl) ketone, α-hydroxy-α,α′-dimethylacetophenone, 2-methyl-2-hydroxypropiophenone or α-hydroxycyclohexyl phenyl ketone; an acetophenone compound, for example, methoxy acetophenone, 2,2-dimethoxy-2-phenylacetophenone, 2,2-diethoxy acetophenone or 2-methyl-1-[4-(methylthio)phenyl]-2-morpholinopropane-1; a benzoin ether compound, for example, benzoin methyl ether, benzoin ethyl ether, benzoin isopropyl ether, benzoin isobutyl ether or anisoin methyl ether; an aromatic ketal compound, for example, benzyl dimethyl ketal; an aromatic sulfonyl chloride, for example, 2-naphthalenesulfonyl chloride; a photoactive oxime compound, for example, 1-phenone-1,1-propanedion-2-(o-ethoxycarbonyl)oxime; a thioxanthone compound, for example, thioxanthone, 2-chlorothioxanthone, 2-methylthioxanthone, 2,4-dimethylthioxanthone, isopropylthioxanthone, 2,4-dichlorothioxanthone, 2,4-diethylthioxanthone, 2,4-diisopropylthioxanthone or dodecylthioxanthone; camphorquinone; a ketone halide; an acylphosphinoxide; and an acylphosphonate.

The amount of the radiation cleavage polymerization initiator blended is preferably 20 parts by weight or less relative to 100 parts by weight of the cohesive polymer. In the case of using an ultraviolet ray as the radiation, the amount of the radiation cleavage polymerization initiator blended is preferably from 0.01 to 20 parts by weight, more preferably from 0.05 to 10 parts by weight, still more preferably from 0.1 to 5 parts by weight, relative to 100 parts by weight of the cohesive polymer.

As the heat cleavage polymerization initiator, a heat cleavage polymerization initiator which does not initiate polymerization by heat cleavage at the time of formation of the cohesive agent layer is preferred. For example, the heat cleavage polymerization initiator having a 10-hour half-life temperature of 65° C. or more is preferred, and the heat cleavage polymerization initiator having a 10-hour half-life temperature from 75 to 90° C. is more preferred. The half-life is an index denoting decomposition rate of the polymerization initiator and means and refers to the time required for the amount of the polymerization initiator to reach one half of its original value. The decomposition temperature required for a certain half-life and the half-life time obtained at a certain temperature are shown in catalogs furnished by manufacturers, for example, Yuukikasankabutu Catalog (Organic Peroxide Catalog), 9th Edition, May, 2003 furnished by NOF Corp.

Examples of the heat cleavage polymerization initiator include an organic peroxide, for example, lauroyl peroxide (10-hour half-life temperature: 64° C.), benzoyl peroxide (10-hour half-life temperature: 73° C.), 1,1-bis(tert-butylperoxy)-3,3,5-trimethylcyclohexane (10-hour half-life temperature: 90° C.), di(2-ethylhexyl)peroxydicarbonate (10-hour half-life temperature: 49° C.), di(4-tert-butylcycloexyl)peroxydicarbonate, di-sec-butylperoxydicarbonate (10-hour half-life temperature: 51° C.), tert-butylperoxyneodecanoate (10-hour half-life temperature: 48° C.), tert-hexylperoxypivalate, tert-butylperoxypivalate, dilauroylperoxide (10-hour half-life temperature: 64° C.), di-n-octanoylperoxide, 1,1,3,3-tetramethylbutylperoxy-2-ethylhexanoate (10-hour half-life temperature: 66° C.), di(4-methylbenzoyl)peroxide, dibenzoylperoxide (10-hour half-life temperature: 73° C.), tert-butylperoxyisobutylate (10-hour half-life temperature: 81° C.) and 1,1-di(tert-hexylperoxy)cyclohexane.

Examples of the heat cleavage polymerization initiator also include an azo compound, for example, 2,2′-azobisisobutyronitrile (10-hour half-life temperature: 67° C.), 2,2′-azobis(2-methylisobutyronitrile) (10-hour half-life temperature: 67° C.) or 1,1′-azobiscyclohexane-1-carbonitrile (10-hour half-life temperature: 87° C.).

The amount of the heat cleavage polymerization initiator blended is preferably from 0.01 to 20 parts by weight, more preferably from 0.05 to 10 parts by weight, still more preferably from 0.1 to 3 parts by weight, relative to 100 parts by weight of the cohesive polymer.

In addition to the cohesive agent layers described above, the cohesive agent layer may be formed from a cohesive agent composition prepared by blending the radiation cleavage or heat cleavage polymerization initiator in a cohesive polymer having a carbon-carbon double bond in its side chain or main chain or at a terminal of the main chain, as the cohesive polymer (base polymer). The amount of the radiation cleavage or heat cleavage polymerization initiator blended is preferably from 0.01 to 20 parts by weight relative to 100 parts by weight of the cohesive polymer as same as described above. The radiation cleavage polymerization initiator is blended, if desired, depending on the kind of radiation. The cohesive agent composition is preferred because a monomer and/or oligomer component or the like which is a low molecular component is not necessary to be contained or is not contained in a large amount in the cohesive agent composition and thus, the monomer and/or oligomer component or the like does not migrate in the cohesive agent composition with the lapse of time, thereby forming the cohesive agent layer having the stable layer structure.

As the base polymer having a carbon-carbon double bond, those having a carbon-carbon double bond and stickiness may be used without particular restriction. The base polymer preferably contains an acrylic polymer as the base skeleton. As the acrylic polymer as the base skeleton, the acrylic polymer described above is exemplified.

The method for introducing a carbon-carbon double bond into the acrylic polymer is not particularly restricted and various methods may be adopted. To introduce the carbon-carbon double bond into a side chain of the polymer is easy in view of molecular design. For example, there is a method where a monomer having a functional group is copolymerized to prepare an acrylic polymer and then a compound having a functional group which is capable of reacting with the functional group of the monomer and a carbon-carbon double bond is subjected to a condensation reaction or an addition reaction while maintaining the radiation curable property of the carbon-carbon double bond.

Examples of the combination of functional groups include a carboxylic acid group and an epoxy group, a carboxylic acid group and an aziridyl group, and a hydroxy group and an isocyanate group. Of the combinations of functional groups, the combination of a hydroxy group and an isocyanate group is preferred from the standpoint of the easiness of reaction trace. In the combination of the functional groups, the functional groups may be present in any of the acrylic polymer and the compound described above as long as the combination can form the acrylic polymer having a carbon-carbon double bond. In the preferred combination described above, it is preferred that the acrylic polymer has the hydroxy group and the compound described above has the isocyanate group. Examples of the isocyanate compound having a carbon-carbon double bond used include methacryloyl isocyanate, 2-methacryloyloxyethyl isocyanate and m-isopropenyl-α,α-dimethylbenzyl isocyanate. As the acrylic polymer, an acrylic polymer copolymerized with the hydroxy group-containing monomer exemplified above or an ether compound, for example, 2-hydroxyethyl vinyl ether, 4-hydroxybutyl vinyl ether or diethylene glycol monovinyl ether may be used.

The curable component (monomer component or oligomer component) described above may also be blended in the cohesive agent composition containing the base polymer having a carbon-carbon double bond to such an extent that the characteristics are not deteriorated. The amount of curing component blended is ordinarily 200 parts by weight or less, preferably 100 parts by weight or less, relative to 100 parts by weight of the base polymer.

### <Crosslinking Agent>

The cohesive agent composition may contain a crosslinking agent in order to increase cohesion force or the like and to achieve heat resistance. Examples of the crosslinking gent include an organic polyfunctional compound, for example, a polyisocyanate compound, a melamine resin, a urea resin, an epoxy compound (resin), a polyamine compound, an imine compound, an aziridine compound or a carboxyl group-containing polymer, and a polyfunctional metal chelate. From the standpoint of flexibility and adhesiveness, the amount of the crosslinking agent blended is preferably 30 parts by weight or less, preferably from 0.01 to 30 parts by weight, more preferably from 0.05 to 20 parts by weight, still more preferably from 0.1 to 10 parts by weight, relative to 100 parts by weight of the cohesive polymer.

To the cohesive agent composition may appropriately further added, depending on the intended use, various additives, for example, a stickiness imparting agent, an antistatic agent, a surface lubricant, a leveling agent, an antioxidant, a corrosion inhibitor, a light stabilizer, an ultraviolet absorbing agent, a polymerization inhibitor, a silane coupling agent, an inorganic or organic filler, powder, for example, metal powder or pigment, or a particulate or foil-like material.

The cohesive agent layer is stacked on the surface of the polarizer opposite to the surface on which the protective film for polarizing plate is stuck. The method for stacking the cohesive agent layer is not particularly restricted and includes, for example, a method of coating and drying a solution of the cohesive agent composition and a method of transferring the cohesive agent layer from a release sheet having the cohesive agent layer. The solution of the cohesive agent composition is prepared as a solution of approximately from 10 to 40% by weight by dissolving or dispersing the cohesive agent composition in a solvent comprising an appropriate solvent, for example, toluene or ethyl acetate, alone or a mixture thereof. As the coating method, a roll coating method, for example, reverse coating or gravure coating, a spin coating method, a screen coating method, a fountain coating method, a dipping coating method, a spray coating method or the like is adopted. The formation of the cohesive agent layer is performed so that curing of the curable component in the cohesive agent composition does not proceed. For example, in the case where the cohesive agent composition contains a heat cleavage polymerization initiator, the drying temperature is controlled to a lower range than the cleavage temperature of the heat cleavage polymerization initiator. The drying temperature of the solution of the cohesive agent composition is ordinarily from 30 to 60° C., and preferably from 40 to 50° C.

The thickness of the cohesive agent layer is ordinarily approximately from 3 to 100 μm, preferably from 5 to 50 μm, and more preferably from 10 to 40 μm.

Examples of constituent material of the release sheet includes an appropriate thin sheet material, for example, paper, a film of synthetic resin, for example, polyethylene, polypropylene or polyethylene terephthalate, a rubber sheet, paper, cloth, nonwoven fabric, net, foamed sheet, metal foil, and a laminate thereof. In order to enhance releasability from the cohesive agent layer, the surface of the release sheet may be subjected to a release treatment of low adhesiveness, for example, a silicone treatment, a long chain alkyl treatment or a fluorine treatment, if desired.

### <Functionalization of Polarizing Plate>

The polarizing plate according to the invention may be preferably used as a functionalized polarizing plate by combining with an antireflection film for increasing visibility of display, a brightness increasing film, or an optical film having a functional layer, for example, a hardcoat layer, a forward scattering layer or an antiglare layer (antidazzle layer). The antireflection film, brightness increasing film, other functional optical film, hardcoat layer, forward scattering layer and antiglare layer used for the functionalization are described in Paragraph Nos. [0257] to [0276] of JP-A-2007-86748, and according to the descriptions the functionalized polarizing plate can be manufactured.

### [Liquid Crystal Display Device]

The liquid crystal display device according to the invention is described below.

The liquid crystal display device according to the invention contains at least one sheet of the polarizing plate according to the invention.

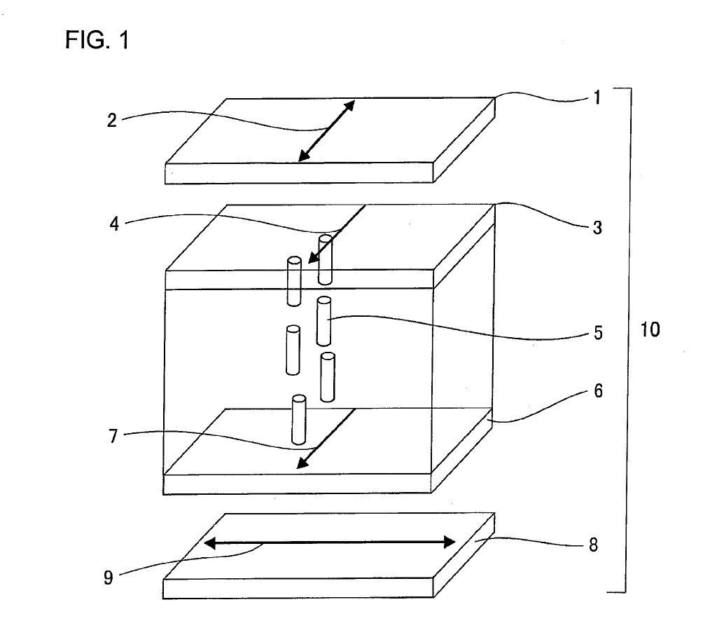

FIG. 1 is a view schematically showing an example of the liquid crystal display device according to the invention. In FIG. 1, a liquid crystal display device 10 comprises a liquid crystal cell containing a liquid crystal layer 5 and a liquid crystal cell upper electrode substrate 3 and a liquid crystal cell lower electrode substrate 6 respectively provided thereabove and therebelow, and an upper polarizing plate 1 and a lower polarizing plate 8 provided on the both sides of the liquid crystal cell. A color filter may be provided between the liquid crystal cell and each of the polarizing plates. In the case where the liquid crystal display device 10 is employed as a transmission type device, it is equipped with a backlight using a light source, for example, a cold or hot cathode fluorescent tube, a light emitting diode, a field emission device or an electroluminescent device on the back side.

At least one of the upper polarizing plate 1 and the lower polarizing plate 8 is the polarizing plate according to the invention, and the polarizing plate has a structure wherein the protective film for polarizing plate is stacked on only one surface of the polarizer. The polarizing plate according to the invention is preferably disposed so that the polarizer side (in case of having the cohesive agent layer, the cohesive agent layer side) is faced to the liquid crystal cell side and the protective film for polarizing plate is faced to the side far from the liquid crystal cell. Specifically, the liquid crystal display device 10 according to the invention is preferably stacked from the outside (side far from the liquid crystal cell) of the device in order of the protective film for polarizing plate, the adhesive layer and the polarizer.

The liquid crystal display device 10 includes an image direct-view type, an image projection type and a light modulation type. The invention can be effectively applied to an active matrix liquid crystal display device using a 3-terminal or 2-terminal semiconductor element, for example, a TFT or an MIM. Needless to say, it is also effectively applicable to a passive matrix liquid crystal display device represented by an STN mode called time division driving.

The driving mode of the liquid crystal display device is effective in any known driving mode, for example, a TN mode or an IPS mode and in particular, a VA mode liquid crystal display device described in Paragraph Nos. [0245] to [0260] of JP-A-2012-82235 is preferably used as the liquid crystal display device according to the invention.

### EXAMPLES

The invention will be described in more detail with reference to the examples below. The materials, reagents, amounts, proportions, operations and the like described in the examples can be appropriately altered as long as the gist of the invention is not exceeded. Therefore, the scope of the invention should not be construed as being limited to the specific examples described below.

### Reference Example 101

### (1) Film Formation of Cellulose Acylate Film

### <Preparation of Cellulose Acylate>

Cellulose acylate having an acetyl substitution degree of 2.87 was prepared. Specifically, as a catalyst, sulfuric acid (in an amount of 7.8 parts by weight relative to 100 parts by weight of cellulose) was added, and a carboxylic acid serving as a raw material for an acyl substituent was added to conduct an acylation reaction at 40° C. After the acylation, ripening was conducted at 40° C. Further, the low-molecular weight ingredient of the cellulose acylate was removed by washing with acetone.

### [Production of Protective Film for Polarizing Plate]

### <Preparation of Dope 101 for Air Side Surface Layer>

### (Preparation of Cellulose Acylate Solution)

The composition shown below was put into a mixing tank and stirred to dissolve the components, thereby preparing Cellulose acylate solution 1.

### Composition of Cellulose Acylate Solution 1

| | |
|---|---|
| Cellulose acetate having acetyl substitution | 100.0 parts by weight |
| degree of 2.87 and polymerization degree of 370 | |
| Sucrose benzoate having average benzoyl | 11.0 parts by weight |
| substitution degree of 4.5 | |
| Polarizer durability-improving agent (2-3) | 4.0 parts by weight |
| Methylene chloride (first solvent) | 353.9 parts by weight |
| Methanol (second solvent) | 89.6 parts by weight |
| n-Butanol (third solvent) | 4.5 parts by weight |

### (Preparation of Matting Agent Solution 2)

The composition shown below was put into a disperser and stirred to dissolve the components, thereby preparing Matting agent solution 2.

### Composition of Matting Agent Solution 2

| | |
|---|---|
| Silica particle having average particle size of | 2.0 parts by weight |
| 20 nm (AEROSIL R 972, produced by Nippon | |
| Aerosil Co., Ltd.) | |
| Methylene chloride (first solvent) | 69.3 parts by weight |
| Methanol (second solvent) | 17.5 parts by weight |
| n-Butanol (third solvent) | 0.9 parts by weight |
| Cellulose acylate solution 1 | 0.9 parts by weight |

Using an in-line mixer, 1.3 parts by weight of Matting agent solution 2 and 98.7 parts by weight of Cellulose acylate solution 1 were mixed, thereby preparing Dope 101 for air side surface layer.

### <Preparation of Dope 101 for Substrate Layer>

### (Preparation of Cellulose Acylate Solution)

The composition shown below was put into a mixing tank and stirred to dissolve the components, thereby preparing Dope 101 for substrate layer.

### Composition of Dope 101 for Substrate Layer (Cellulose Acylate Solution 2)

| | |
|---|---|
| Cellulose acetate having acetyl substitution degree | 100.0 parts by weight |
| of 2.87 and polymerization degree of 370 | |
| Sucrose octabenzoate | 11.0 parts by weight |
| Polarizer durability-improving agent (2-3) | 4.0 parts by weight |
| Ultraviolet absorbing agent C shown below | 2.0 parts by weight |
| Methylene chloride (first solvent) | 297.7 parts by weight |
| Methanol (second solvent) | 75.4 parts by weight |
| n-Butanol (third solvent) | 3.8 parts by weight |

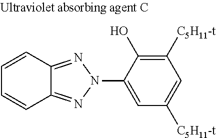

### <Preparation of Dope 101 for Support Side Surface Layer>

Using an in-line mixer, 1.3 parts by weight of Matting agent solution 2 prepared in the production of Dope 101 for air side surface layer and 99.3 parts by weight of Cellulose acylate solution 2 were mixed, thereby preparing Dope 101 for support side surface layer.

### (Casting)

Using a drum casting apparatus, three layers consisting of the dope (dope for substrate layer) and the dopes for surface layer to be disposed on both sides of the dope for substrate layer were uniformly cast simultaneously from a casting aperture onto a stainless casting support (support temperature: −9° C.). The resulting film was peeled from the support in the state where the amount of remaining solvent in the dope of each layer was approximately 70% by weight, and then both ends in the width direction of the film were fixed with a pin tenter and the film was dried while stretching it 1.28 times in the transverse direction in the state where the amount of remaining solvent was from 3 to 5% by weight. Thereafter, the film was further dried by transporting it between rolls of a heat treatment apparatus, thereby obtaining the cellulose acylate film for Reference Example 101. The thickness and the width of the cellulose acylate film obtained were 30 μm (air side surface layer: 3 μm, substrate layer: 24 μm, support side surface layer: 3 μm) and 1,480 mm, respectively.

### Reference Examples 102 to 118 and 201 to 207

The protective films for polarizing plate for Reference Examples 102 to 118 and 201 to 207 were produced in the same manner as in the production of the protective film for polarizing plate for Reference Examples 101 except for changing the kind and amount of the polarizer durability-improving agent and the thickness of the film to those shown in Table 1 below, respectively. The kind and amount added (parts by weight relative to 100 parts by weight of cellulose acylate) of the polarizer durability-improving agent were same in all three layers of the air side surface layer, substrate layer and support side surface layer.

TABLE 1

| | Polarizer Durability-Improving Agent | | | | | | | | | |
|---|---|---|---|---|---|---|---|---|---|---|
| | | | | | Number of | | | | | |
| | | | | Molecular | Hydrogen | | Thickness (μm) | | | |
| | | | Number | Weight/ | Bond-Forming | Amount | | | Support | |
| | | | of | Number | Hydrogen- | added* | Air Side | | Side | |
| | | Molecular | Aromatic | of Aromatic | Donating | (parts by | Surface | Substrate | Surface | |
| | Kind | Weight | Ring | Ring | Group | weight) | Layer | Layer | Layer | Total |
| Reference | (2-3) | 294 | 2 | 147 | 2 | 4.0 | 3.0 | 24.0 | 3.0 | 30 |
| Example 101 | | | | | | | | | | |
| Reference | (2-3) | 294 | 2 | 147 | 2 | 4.0 | 3.0 | 37.0 | 3.0 | 43 |
| Example 102 | | | | | | | | | | |
| Reference | (2-3) | 294 | 2 | 147 | 2 | 2.0 | 3.0 | 24.0 | 3.0 | 30 |
| Example 103 | | | | | | | | | | |
| Reference | (2-3) | 294 | 2 | 147 | 2 | 6.0 | 3.0 | 24.0 | 3.0 | 30 |
| Example 104 | | | | | | | | | | |
| Reference | (2-3) | 294 | 2 | 147 | 2 | 8.0 | 3.0 | 24.0 | 3.0 | 30 |
| Example 105 | | | | | | | | | | |
| Reference | (2-2) | 294 | 2 | 147 | 2 | 4.0 | 3.0 | 24.0 | 3.0 | 30 |
| Example 106 | | | | | | | | | | |
| Reference | (2-4) | 308 | 2 | 154 | 2 | 4.0 | 3.0 | 24.0 | 3.0 | 30 |
| Example 107 | | | | | | | | | | |
| Reference | (2-5) | 280 | 2 | 140 | 2 | 4.0 | 3.0 | 24.0 | 3.0 | 30 |
| Example 108 | | | | | | | | | | |
| Reference | (2-1) | 329 | 2 | 165 | 2 | 4.0 | 3.0 | 24.0 | 3.0 | 30 |
| Example 109 | | | | | | | | | | |
| Reference | (2-3) | 294 | 2 | 147 | 2 | 6.0 | 2.0 | 21.0 | 2.0 | 25 |
| Example 110 | | | | | | | | | | |
| Reference | (1-5) | 511 | 5 | 102 | 1 | 4.0 | 3.0 | 24.0 | 3.0 | 30 |
| Example 111 | | | | | | | | | | |
| Reference | (1-11) | 348 | 3 | 116 | 3 | 4.0 | 3.0 | 24.0 | 3.0 | 30 |
| Example 112 | | | | | | | | | | |
| Reference | (1-15) | 407 | 4 | 102 | 1 | 4.0 | 3.0 | 24.0 | 3.0 | 30 |
| Example 113 | | | | | | | | | | |
| Reference | Triazine | 412 | 4 | 103 | 3 | 4.0 | 3.0 | 24.0 | 3.0 | 30 |
| Example 114 | Compound | | | | | | | | | |
| | F | | | | | | | | | |
| Reference | A-2 | 370 | 3 | 123 | 1 | 6.0 | 2.0 | 21.0 | 2.0 | 25 |
| Example 115 | | | | | | | | | | |
| Reference | A-4 | 384 | 3 | 128 | 1 | 6.0 | 2.0 | 21.0 | 2.0 | 25 |
| Example 116 | | | | | | | | | | |
| Reference | A-1 | 356 | 3 | 119 | 1 | 6.0 | 2.0 | 21.0 | 2.0 | 25 |
| Example 117 | | | | | | | | | | |
| Reference | A-6 | 398 | 3 | 133 | 1 | 6.0 | 2.0 | 21.0 | 2.0 | 25 |
| Example 118 | | | | | | | | | | |
| Reference | None | — | — | — | — | 0.0 | 3.0 | 24.0 | 3.0 | 30 |
| Example 201 | | | | | | | | | | |
| Reference | (2-3) | 294 | 2 | 147 | 2 | 4.0 | 4.0 | 53.0 | 4.0 | 61 |
| Example 202 | | | | | | | | | | |
| Reference | Plasticizer | 404 | 3 | 135 | 0 | 4.0 | 3.0 | 24.0 | 3.0 | 30 |
| Example 203 | A | | | | | | | | | |
| Reference | Plasticizer | 280 | 1 | 280 | 0 | 4.0 | 3.0 | 24.0 | 3.0 | 30 |
| Example 204 | B | | | | | | | | | |
| Reference | Plasticizer | 326 | 3 | 109 | 0 | 4.0 | 3.0 | 24.0 | 3.0 | 30 |
| Example 205 | C | | | | | | | | | |
| Reference | Plasticizer | 553 | 4 | 138 | 0 | 4.0 | 3.0 | 24.0 | 3.0 | 30 |
| Example 206 | D | | | | | | | | | |
| Reference | Phenol | 395 | 2 | 198 | 1 | 4.0 | 3.0 | 24.0 | 3.0 | 30 |
| Example 207 | Compound | | | | | | | | | |
| | E | | | | | | | | | |

*The amount of polarizer durability-improving agent added relative to 100 parts by weight of cellulose acylate.

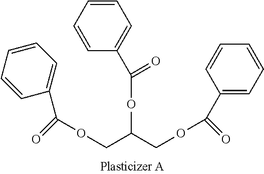 [SMILES: O=C(OCC(COC(=O)c1ccccc1)OC(=O)c1ccccc1)c1ccccc1]

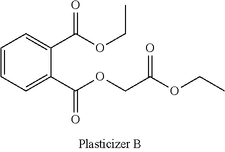 [SMILES: CCOC(=O)COC(=O)c1ccccc1C(=O)OCC]

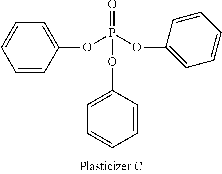 [SMILES: O=P(Oc1ccccc1)(Oc1ccccc1)Oc1ccccc1]

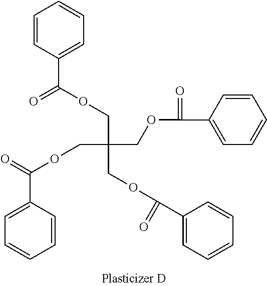 [SMILES: O=C(OCC(COC(=O)c1ccccc1)(COC(=O)c1ccccc1)COC(=O)c1ccccc1)c1ccccc1]

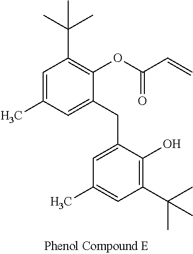 [SMILES: C=CC(=O)Oc1c(Cc2cc(C)cc(C(C)(C)C)c2O)cc(C)cc1C(C)(C)C]

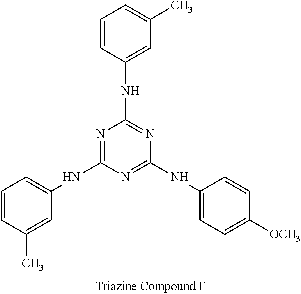 [SMILES: COc1ccc(Nc2nc(Nc3cccc(C)c3)nc(Nc3cccc(C)c3)n2)cc1]

### Reference Example 301

### (1) Film Formation of Cellulose Acylate Film

### <Preparation of Cellulose Acylate>

Cellulose acylate having an acetyl substitution degree of 2.87 was prepared. Specifically, as a catalyst, sulfuric acid (in an amount of 7.8 parts by weight relative to 100 parts by weight of cellulose) was added, and a carboxylic acid serving as a raw material for an acyl substituent was added to conduct an acylation reaction at 40° C. After the acylation, ripening was conducted at 40° C. Further, the low-molecular weight ingredient of the cellulose acylate was removed by washing with acetone.

### (Preparation of Cellulose Acylate Solution 301)

The composition shown below was put into a mixing tank and stirred to dissolve the components, thereby preparing Cellulose acylate solution 301.

### Composition of Cellulose Acylate Solution 301

| | |
|---|---|
| Cellulose acetate having acetyl substitution degree of 2.87 | 100.0 parts |
| and polymerization degree of 370 | by weight |
| Hydrophobizing agent 1 (AA-1) | 6.5 parts by |
| | weight |
| Hydrophobizing agent 2 (B-1) | 4.0 parts by |
| | weight |
| Ultraviolet absorbing agent D | 1.5 parts by |
| | weight |
| Methylene chloride (first solvent) | 412.2 parts |
| | by weight |
| Ethanol (second solvent) | 35.8 parts |
| | by weight |

Hydrophobizing agents 1 and 2 are Aromatic-terminal ester compounds AA-1 and B-1, respectively.

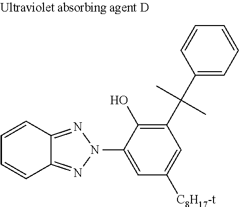

### (Preparation of Matting Agent Solution 302)

The composition shown below was put into a disperser and stirred to dissolve the components, thereby preparing Matting agent solution 302.

### Composition of Matting Agent Solution 302

| | |
|---|---|
| Silica particle having average particle size of 20 nm | 2.0 parts by |
| (AEROSIL R 972, produced by Nippon Aerosil Co., Ltd.) | weight |
| Methylene chloride (first solvent) | 79.9 parts by |
| | weight |
| Ethanol (second solvent) | 6.9 parts by |
| | weight |
| Cellulose acylate solution 301 | 0.9 parts by |
| | weight |

### (Preparation of Polarizer Durability-Improving Agent Solution 303)

The composition shown below was put into a mixing tank and stirred with heating to dissolve the components, thereby preparing Polarizer durability-improving agent solution 303.

### Composition of Polarizer Durability-Improving Agent Solution 303

| | |
|---|---|
| Polarizer durability-improving agent (1-11) | 20.0 parts by weight |
| Methylene chloride (first solvent) | 73.6 parts by weight |
| Ethanol (second solvent) | 6.4 parts by weight |

### <Casting>

After filtering each of 1.3 parts by weight of Matting agent solution 302 and 3.4 parts by weight of Polarizer durability-improving agent solution 303, they are mixed using an in-line mixer, further 95.3 parts by weight of Cellulose acylate solution 301 was added thereto, followed by mixing using an in-line mixer. Using a band casting apparatus, the dope prepared above was cast onto a stainless casting support (support temperature: 22° C.). The resulting film was peeled from the support in the state where the amount of remaining solvent in the dope was approximately 20% by weight, and then both ends in the width direction of the film were grasped with a tenter and the film was dried at temperature of 120° C. while stretching it 1.10 times (10%) in the width direction in the state where the amount of remaining solvent was from 5 to 10% by weight. Thereafter, the film was further dried by transporting it between rolls of a heat treatment apparatus, thereby obtaining the cellulose acylate film for Reference Example 301. The thickness and the width of the cellulose acylate film obtained were 20 μm and 1,480 mm, respectively.

### Reference Examples 302 to 310 and 401 to 404

The protective films for polarizing plate for Reference Examples 302 to 310 and 401 to 404 were produced in the same manner as in the production of the protective film for polarizing plate for Reference Examples 301 except for changing the kind and amount of the polarizer durability-improving agent and the thickness of the film to those shown in Table 2 below, respectively.

TABLE 2

| | Polarizer Durability-Improving Agent | | | | | | |
|---|---|---|---|---|---|---|---|
| | | | | Molecular | Number of | | |
| | | | | Weight/ | Hydrogen | | |
| | | | | Number | Bond-Forming | | |
| | | Molecular | Number of | of Aromatic | Hydrogen-Donating | Amount added* | |
| | Kind | Weight | Aromatic Ring | Ring | Group | (parts by weight) | Thickness (μm) |
| Reference | (1-11) | 348 | 3 | 116 | 3 | 4.0 | 20 |
| Example 301 | | | | | | | |
| Reference | (1-12) | 274 | 3 | 91 | 1 | 4.0 | 20 |
| Example 302 | | | | | | | |
| Reference | (1-13) | 364 | 4 | 91 | 1 | 4.0 | 20 |
| Example 303 | | | | | | | |
| Reference | (1-14) | 274 | 3 | 91 | 1 | 4.0 | 20 |
| Example 304 | | | | | | | |
| Reference | (1-15) | 407 | 4 | 102 | 1 | 4.0 | 20 |
| Example 305 | | | | | | | |
| Reference | (1-6) | 511 | 5 | 102 | 1 | 4.0 | 20 |
| Example 306 | | | | | | | |
| Reference | (2-2) | 294 | 2 | 147 | 2 | 4.0 | 20 |
| Example 307 | | | | | | | |
| Reference | (1-13) | 364 | 4 | 91 | 1 | 6.0 | 20 |
| Example 308 | | | | | | | |
| Reference | (1-13) | 364 | 4 | 91 | 1 | 8.0 | 20 |
| Example 309 | | | | | | | |
| Reference | (1-13) | 364 | 4 | 91 | 1 | 8.0 | 15 |
| Example 310 | | | | | | | |
| Reference | None | — | — | — | — | 0.0 | 20 |
| Example 401 | | | | | | | |
| Reference | Plasticizer F | 449 | 4 | 112 | 0 | 4.0 | 20 |
| Example 402 | | | | | | | |
| Reference | Plasticizer G | 421 | 4 | 105 | 0 | 4.0 | 20 |
| Example 403 | | | | | | | |
| Reference | Phenol | 395 | 2 | 198 | 1 | 4.0 | 20 |
| Example 404 | Compound E | | | | | | |

*The amount of polarizer durability-improving agent added relative to 100 parts by weight of cellulose acylate.

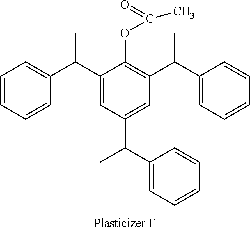 [SMILES: CC(=O)Oc1c(C(C)c2ccccc2)cc(C(C)c2ccccc2)cc1C(C)c1ccccc1]

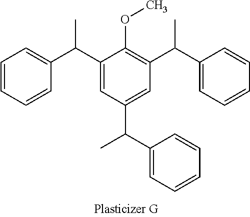 [SMILES: COc1c(C(C)c2ccccc2)cc(C(C)c2ccccc2)cc1C(C)c1ccccc1]

### Reference Example 501

### (Preparation of Acrylic Solution 501)

The composition shown below was put into a mixing tank and stirred to dissolve the components, thereby preparing Acrylic solution 501.

### Composition of Acrylic Solution 501

| | |
|---|---|
| DIANAL BR 88 produced by Mitsubishi Rayon Co., Ltd. | 100.0 parts |
| (solvent type thermoplastic acrylic resin) | by weight |
| Sucrose benzoate having average benzoyl substitution | 11.0 parts |
| degree of 5.0 | by weight |
| Ultraviolet absorbing agent C | 2.0 parts |
| | by weight |
| Polarizer durability-improving agent (1-13) | 6.0 parts |
| | by weight |
| Methylene chloride (first solvent) | 393.0 parts |
| | by weight |
| Methanol (second solvent) | 59.0 parts |
| | by weight |

### (Preparation of Cellulose Acylate Solution 502)

The composition shown below was put into a mixing tank and stirred to dissolve the components, thereby preparing Cellulose acylate solution 502.

Composition of Cellulose Acylate Solution 502

| | |
|---|---|
| Cellulose acetate having acetyl substitution degree of | 100.0 parts |
| 2.86 and polymerization degree of 350 | by weight |
| Sucrose benzoate having average benzoyl substitution | 5.0 parts |
| degree of 5.0 | by weight |
| Ultraviolet absorbing agent C | 2.0 parts |
| | by weight |
| Polarizer durability-improving agent (1-13) | 8.0 parts |
| | by weight |
| Methylene chloride (first solvent) | 414.0 parts |
| | by weight |
| Methanol (second solvent) | 62.0 parts |
| | by weight |

### <Production of Stacked Film>

Acrylic solution 501 and Cellulose acylate solution 502 were cast on a metal support through a casting giesser capable of conducting 3 layer co-casting so as to form a constitution of acrylic layer/cellulose acylate layer/acrylic layer=30 μm/10 μm/30 μm on near side from the metal support. The dope was dried with drying wind at 40° C. while it was on the metal support to form a film, and the film was peeled from the metal support, both ends of the film were fixed with pins and the film was dried with drying wind at 105° C. for 5 minutes while maintaining the same distance between the pins. After removing the pins, the film was further dried at 130° C. for 20 minutes and rolled up in the state of a stacked film.

From the stacked film thus-produced were removed the upper and lower acrylic layers by peeling, a cellulose acylate film having a thickness of 10 μm.

### Reference Examples 502 to 504

The protective films for polarizing plate for Reference Examples 502 to 504 were produced in the same manner as in the production of the protective film for polarizing plate for Reference Example 501 except for changing the thickness of the film to the values shown in Table 3 below, respectively.

TABLE 3

| Protective Film | Thickness of Film |
|---|---|
| for Polarizing Plate | (μm) |
| Reference Example 501 | 10 |
| Reference Example 502 | 15 |
| Reference Example 503 | 6 |
| Reference Example 504 | 20 |

### Reference Example 701

### (Preparation of Acrylic Solution 701)

The composition shown below was put into a mixing tank and stirred to dissolve the components, thereby preparing Acrylic solution 701.

### Composition of Acrylic Solution 701

| | |
|---|---|
| DIANAL BR 88 produced by Mitsubishi Rayon Co., Ltd. | 100.0 parts by |
| (solvent type thermoplastic acrylic resin) | weight |
| Polarizer durability-improving agent (2-3) | 6.0 parts by |
| | weight |
| Methylene chloride (first solvent) | 393.0 parts by |
| | weight |
| Methanol (second solvent) | 59.0 parts by |
| | weight |

### <Casting>

Using a band casting apparatus, the dope prepared above (Acrylic solution 701) was cast onto a stainless casting support (support temperature: 22° C.). The resulting film was peeled from the support in the state where the amount of remaining solvent in the dope was approximately 20% by weight, and then both ends in the width direction of the film were grasped with a tenter and the film was dried at temperature of 100° C. while stretching it 1.05 times (5%) in the width direction in the state where the amount of remaining solvent was from 5 to 10% by weight. Thereafter, the film was further dried by transporting it between rolls of a heat treatment apparatus, thereby obtaining the acrylic film for Reference Example 701. The thickness and the width of the acrylic film obtained were 40 μm and 1,480 mm, respectively.

### <Production of Polarizer A>

An aqueous solution prepared by dissolving PVA powder having an average polymerization degree of 2,400 and a saponification degree of 99.9% in pure water so as to adjust concentration to 10% by weight was coated on a polyester film and dried at 40° C. for 3 hours, and then at 110° C. for 60 minutes to obtain a PVA film having a thickness of 50 μm. The PVA film was swollen with warm water of 30° C. for one minute, immersed in an aqueous solution of potassium iodide/iodine (10:1 by weight ratio) at 30° C. and uniaxially longitudinally stretched to 1.5 times. The concentration of the aqueous solution of potassium iodide/iodine (10:1 by weight ratio) was set 0.38% by weight in terms of iodine concentration. The film was then uniaxially longitudinally stretched so as to have the total stretching rate of 7 times in an aqueous boric acid solution having a concentration of 4.25% by weight, washed with water by immersing it in a water bath of 30° C., and dried at 50° C. for 4 minutes, thereby preparing Polarizer A having a thickness of 12.5 μm.

### <Production of Polarizer B>

An aqueous solution prepared by dissolving PVA powder having an average polymerization degree of 2,400 and a saponification degree of 99.9% in pure water so as to adjust concentration to 12% by weight was coated on a polyester film and dried at 40° C. for 3 hours, and then at 110° C. for 60 minutes to obtain a PVA film having a thickness of 50 μm. The PVA film was swollen with warm water of 30° C. for one minute, immersed in an aqueous solution of potassium iodide/iodine (10:1 by weight ratio) at 30° C. and uniaxially longitudinally stretched to 2 times. The concentration of the aqueous solution of potassium iodide/iodine (10:1 by weight ratio) was set 0.38% by weight in terms of iodine concentration. The film was then uniaxially longitudinally stretched so as to have the total stretching rate of 6.5 times in an aqueous boric acid solution having a concentration of 4.25% by weight, washed with water by immersing it in a water bath of 30° C., and dried at 50° C. for 4 minutes, thereby preparing Polarizer B having a thickness of 16 μm.

### <Production of Polarizer C>

Polarizer C was prepared in the same manner as in Polarizer A except for changing the thickness of original film to 32 μm. The thickness of Polarizer C was 8 μm.

### <Production of Polarizer D>

Polarizer D was prepared in the same manner as in Polarizer A except for changing the thickness of original film to 16 μm. The thickness of Polarizer D was 4 μm.

### <Production of Polarizer E>

Polarizer E was prepared in the same manner as in Polarizer A except for changing the thickness of original film to 77 μm. The thickness of Polarizer E was 19 μm.

### [Saponification Treatment of Protective Film for Polarizing Plate]

The protective film for polarizing plate for Reference Example 101 produced above was immersed in an aqueous 2.3 mol/L sodium hydroxide solution at 55° C. for 3 minutes. The film was washed in a water washing bath tank at room temperature and neutralized using 0.05 mol/L of sulfuric acid. The film was again washed in a water washing bath tank at room temperature and dried by hot air of 100° C. Thus, the saponification treatment of the surface of the protective film for polarizing plate for Example B-101 was performed.

### [Preparation of Adhesive]

In pure water were dissolved 50 parts by weight of methylolmelamine relative to 100 parts by weight of polyvinyl alcohol resin having an acetoacetyl group (average polymerization degree: 1,200, saponification degree: 98.5%, acetoacetyl group modification degree: 5% by mole) under the temperature condition of 30° C. to prepare an aqueous solution having a solid content concentration of 3.7% by weight. Relative to 100 parts by weight of the aqueous solution, 18 parts by weight of aqueous solution containing alumina colloid having a positive charge (average particle size: 15 nm) having a solid content concentration of 10% by weight was added to prepare a metal colloid-containing aqueous adhesive solution. The viscosity of the aqueous adhesive solution was 9.6 mPa·s, the pH thereof was in a range from 4 to 4.5, and the amount of the alumina colloid blended was 74 parts by weight relative to 100 parts by weight of the polyvinyl alcohol resin. The average particle size of the alumina colloid was measure by a particle size analyzer (NANOTRAC UPA 150, produced by Nikkiso Co., Ltd.) according to the dynamic light scattering method (photon correlation method).

### [Production of Polarizing Plate]

The adhesive described above was coated on the air side surface layer of Protective film for polarizing plate 101 so as to have a thickness of the adhesive layer after drying of 80 nm, and the protective film was stuck onto one surface of Polarizer B described above through the adhesive layer using a roll machine, followed by drying at 70° C. for 6 minutes, thereby producing Polarizer 101 having the protective film for polarizing plate on one surface thereof. The polarizer and protective film for polarizing plate were stuck so that the transmitting axis of the polarizer was parallel to the width direction of the protective film for polarizing plate.

### [Preparation of Curable Cohesive Agent]

In toluene, 90 parts by weight of butyl acrylate and 10 parts by weight of acrylic acid were copolymerized according to a conventional method to prepare a solution containing an acrylic copolymer having a weight average molecular weight of 500,000. Relative to 100 parts by weight of the solution (solid content), 85 parts by weight of dipentaerythritol hexaacrylate having 6 unsaturated double bonds (KAYARAD DPHA, produced by Nippon Kayaku Co., Ltd.) as the curable component, 5 parts by weight of ultraviolet ray cleavage polymerization initiator (IRGACURE 369, produced by Ciba Specialty Chemicals Corp.) and one part by weight of a polyisocyanate compound (CORONATE L, produced by Nippon Polyurethane Industry Co., Ltd.) were added to prepare an acrylic ultraviolet ray curable cohesive agent solution.

### [Formation of Cohesive Agent Layer]

The acrylic ultraviolet ray curable cohesive agent solution prepared above was coated on a surface of a release sheet composed of polyethylene terephthalate film (thickness: 38 μm) which had been subjected to a release treatment so as to have a thickness of 25 μm after drying and dried at 70° C. for 10 minutes, thereby forming an ultraviolet ray curable cohesive agent layer.

### [Production of Cohesive Polarizing Plate]

The cohesive agent layer formed on the release-treated surface of the release sheet described above was stuck on the surface (surface of the polarizer on which the protective film for polarizing plate was not provided) of the Polarizer 101 described above and was transferred onto the surface of the polarizing plate, thereby producing a cohesive polarizing plate for Example B-101. [Production of polarizing plates for Examples B-102 to B-118, B-701, A-301 to A-310, C-501 to C-504, D-501 and E-101 and Comparative Examples B-201 to B-202, C-203 to C-207, C-401 and B-402 to 404]

The polarizing plates for the examples and polarizing plates for the comparative examples were produced in the same manner as in Example B-101 except for changing the polarizer and protective film for polarizing plate used in Example B-101 to those shown in Table 4 below, respectively

In Example B-701, the acryl film was not subjected to the saponification treatment and stuck onto the polarizer using SK cohesive sheet produced by Soken Chemical & Engineering Co., Ltd.

### (Evaluation of Durability of Polarizing Plate)

With respect to the polarizing plate for each of the examples and comparative examples produced above, the orthogonal transmittance of polarizer at a wavelength of 410 nm was measured according to the method shown below.

The orthogonal transmittance CT of the polarizing plate was measured using automatic polarizing film measuring device VAP-7070 produced by JASCO Corp. at a wavelength of 410 nm according to the method shown below.

Two samples (5 cm×5 cm) in which the polarizing plate was stuck on a glass through a cohesive agent were prepared. In this case, the protective film for polarizing plate was stuck so that it faced on the opposite side of the glass (on the air interface side). The orthogonal transmittance measurement was carried out by setting the glass side of the sample so as to face a light source. The two samples were measured, respectively, and the average value thereof was taken as the orthogonal transmittance.

Further, after preservation of the polarizing plate in an environment of 60° C. and 90% relative humidity for 1,000 hours, the orthogonal transmittance of the polarizing plate was measured in the same manner as described above. The variation amount of orthogonal transmittance before and after the preservation was determined to evaluate according to the criteria described below. The results obtained are shown in Table 4 below as the polarizer durability.

A: Variation amount of orthogonal transmittance at a wavelength of 410 nm was less than 0.5%.
B: Variation amount of orthogonal transmittance at a wavelength of 410 nm was from 0.5% to less than 1%.
C: Variation amount of orthogonal transmittance at a wavelength of 410 nm was from 1% to less than 3%.
D: Variation amount of orthogonal transmittance at a wavelength of 410 nm was 3% or more.

TABLE 4

| | | | | | Polarizer Durability | |
|---|---|---|---|---|---|---|
| | Polarizer | | Protective Film for Polarizing Plate | | (variation amount of orthogonal | Display Unevenness |
| | | Thickness | | Thickness | transmittance)(%) | <50° C. and 95% RH |
| | No. | (μm) | No. | (μm) | <60° C. and 90% RH for 1,000 hours> | for 48 hours> |
| Example B-101 | B | 16 | Reference Example 101 | 30 | A | A |
| Example B-102 | B | 16 | Reference Example 102 | 43 | A | B |
| Example B-103 | B | 16 | Reference Example 103 | 30 | A | A |
| Example B-104 | B | 16 | Reference Example 104 | 30 | A | A |
| Example B-105 | B | 16 | Reference Example 105 | 30 | A | A |
| Example B-106 | B | 16 | Reference Example 106 | 30 | A | A |
| Example B-107 | B | 16 | Reference Example 107 | 30 | A | A |
| Example B-108 | B | 16 | Reference Example 108 | 30 | A | A |
| Example B-109 | B | 16 | Reference Example 109 | 30 | A | A |
| Example B-110 | B | 16 | Reference Example 110 | 25 | A | A |
| Example B-111 | B | 16 | Reference Example 111 | 30 | B | A |
| Example B-112 | B | 16 | Reference Example 112 | 30 | B | A |
| Example B-113 | B | 16 | Reference Example 113 | 30 | B | A |
| Example B-114 | B | 16 | Reference Example 114 | 30 | B | A |
| Example B-115 | B | 16 | Reference Example 115 | 25 | A | A |
| Example B-116 | B | 16 | Reference Example 116 | 25 | A | A |
| Example B-117 | B | 16 | Reference Example 117 | 25 | A | A |
| Example B-118 | B | 16 | Reference Example 118 | 25 | A | A |
| Example B-701 | B | 16 | Reference Example 701 | 40 | A | A |
| Example A-301 | A | 12.5 | Reference Example 301 | 20 | A | A |
| Example A-302 | A | 12.5 | Reference Example 302 | 20 | A | A |
| Example A-303 | A | 12.5 | Reference Example 303 | 20 | A | A |
| Example A-304 | A | 12.5 | Reference Example 304 | 20 | A | A |
| Example A-305 | A | 12.5 | Reference Example 305 | 20 | A | A |
| Example A-306 | A | 12.5 | Reference Example 306 | 20 | A | A |
| Example A-307 | A | 12.5 | Reference Example 307 | 20 | A | A |
| Example A-308 | A | 12.5 | Reference Example 308 | 20 | A | A |
| Example A-309 | A | 12.5 | Reference Example 309 | 20 | A | A |
| Example A-310 | A | 12.5 | Reference Example 310 | 15 | B | A |
| Example C-501 | C | 8 | Reference Example 501 | 10 | C | A |
| Example C-502 | C | 8 | Reference Example 502 | 15 | B | A |
| Example C-503 | C | 8 | Reference Example 503 | 6 | C | A |
| Example C-504 | C | 8 | Reference Example 504 | 20 | A | A |
| Example D-501 | D | 4 | Reference Example 501 | 10 | C | A |
| Example E-101 | E | 19 | Reference Example 101 | 30 | A | B |
| Comparative | B | 16 | Reference Example 201 | 30 | D | A |
| Example B-201 | | | | | | |
| Comparative | B | 16 | Reference Example 202 | 61 | A | C |
| Example B-202 | | | | | | |
| Comparative | B | 16 | Reference Example 203 | 30 | D | A |
| Example B-203 | | | | | | |
| Comparative | B | 16 | Reference Example 204 | 30 | D | A |
| Example B-204 | | | | | | |
| Comparative | B | 16 | Reference Example 205 | 30 | D | A |
| Example B-205 | | | | | | |
| Comparative | B | 16 | Reference Example 206 | 30 | D | A |
| Example B-206 | | | | | | |
| Comparative | B | 16 | Reference Example 207 | 30 | D | A |
| Example B-207 | | | | | | |
| Comparative | A | 12.5 | Reference Example 401 | 20 | D | B |
| Example A-401 | | | | | | |
| Comparative | A | 12.5 | Reference Example 402 | 20 | D | B |
| Example A-402 | | | | | | |
| Comparative | A | 12.5 | Reference Example 403 | 20 | D | B |
| Example A-403 | | | | | | |
| Comparative | A | 12.5 | Reference Example 404 | 20 | D | B |
| Example A-404 | | | | | | |

From the results shown in Table 4, it can be seen that the polarizing plate using the protective film for polarizing plate containing the polarizer durability-improving agent according to the invention is preferred in comparison with the polarizing plate for the comparative example because the variation of orthogonal transmittance at a wavelength of 410 nm between before and after the preservation in an environment of 60° C. and 90% relative humidity for 1,000 hours is small.

### Example 501

### Production of Liquid Crystal Display Device

Two polarizing plates were peeled away from a commercially-available liquid crystal television set (BRAVIA J5000, produced by Sony Corporation), and Polarizing plates B-101 according to the invention were stuck to the viewer side and the backlight side of the device, respectively, in such a manner that the cohesive agent layer of the polarizing plate faced the liquid crystal cell in the device. The polarizing plates were arranged in a cross-Nicol configuration where the transmission axis of the polarizing plate on the viewer side was set in the vertical direction and the transmission axis of the polarizing plate on the backlight side was set in the horizontal direction.

With respect to other polarizing plates shown in Table 4, they were stuck to the viewer side and the backlight side of the device, respectively, in such a manner that the cohesive agent layer of the polarizing plate faced the liquid crystal cell in the device.

### (Evaluation of Display Unevenness)

After preservation of the liquid crystal display device in an environment of 50° C. and 95% relative humidity for 48 hours, the display unevenness of the panel was visually observed and evaluated according the criteria described below. The results obtained are shown in Table 4.

A: The unevenness was not observed.
B: The area where the unevenness observed was less than 10%.
C: The area where the unevenness observed was 10% or more.

From the results shown in Table 4, it can be seen that the liquid crystal display device using the polarizing plate according to the invention is preferred because the display unevenness hardly occurs even when used in a high temperature and high humidity environment.

What is claimed is:

1. A polarizing plate comprising, in the following order: a transparent protective film; an adhesive layer; and a polarizer, wherein the transparent protective film has a thickness of from 5 to 60 μm and comprises at least one resin and a compound (A) having at least one hydrogen bond-forming hydrogen-donating group and a ratio of a molecular weight to an aromatic ring number of 190 or less.

2. The polarizing plate as claimed in claim 1, wherein an aromatic ring in the compound (A) is a hydrocarbon aromatic ring.

3. The polarizing plate as claimed in claim 1, wherein the compound (A) is a compound represented by the following formula (1): 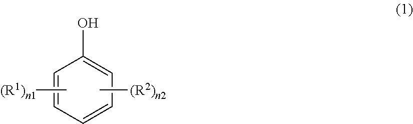
wherein R¹ represents a substituent, R² represents a substituent represented by the following formula (1-2), n1 represents an integer of from 0 to 4, when n1 represents 2 or more, plural R¹s may be same or different from each other, and n2 represents an integer of from 1 to 5, when n2 represents 2 or more, plural R²s may be same or different from each other; 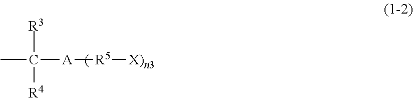
wherein A represents a substituted or unsubstituted aromatic ring, R³ and R⁴ each independently represents a hydrogen atom, an alkyl group having from 1 to 5 carbon atoms or a substituent represented by the following formula (1-3), R⁵ represents a single bond or an alkylene group having from 1 to 5 carbon atoms, X represents a substituted or unsubstituted aromatic ring, and n3 represents an integer of from 0 to 10, when n3 represents 2 or more, plural R⁵s may be same or different from each other and plural Xs may be same or different from each other; 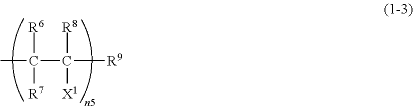
wherein X¹ represents a substituted or unsubstituted aromatic ring, R⁶, R⁷, R⁸ and R⁹ each independently represents a hydrogen atom or an alkyl group having from 1 to 5 carbon atoms, and n5 represents an integer of from 1 to 11, when n5 represents 2 or more, plural R⁶s may be same or different from each other, plural R⁷s may be same or different from each other, plural R⁸s may be same or different from each other and plural X¹s may be same or different from each other.

4. The polarizing plate as claimed in claim 3, wherein the substituent represented by formula (1-2) is a group represented by the following formula (1-2′): 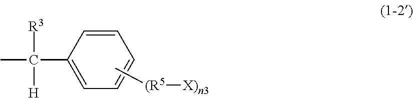
wherein R³ represents a hydrogen atom, an alkyl group having from 1 to 5 carbon atoms or the substituent represented by the formula (1-3), R⁵ represents a single bond or an alkylene group having from 1 to 5 carbon atoms, X represents a substituted or unsubstituted aromatic ring, and n3 represents an integer of from 0 to 5, when n3 represents 2 or more, plural R⁵s may be same or different from each other and plural Xs may be same or different from each other.

5. The polarizing plate as claimed in claim 1, wherein the compound (A) is a compound represented by the following formula (2): 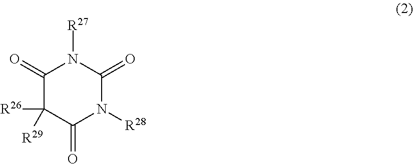
wherein R²⁶ represents an alkyl group, an alkenyl group or an aryl group, R²⁷ and R²⁸ each independently represents a hydrogen atom, an alkyl group, an alkenyl group, an aryl group or a heteroaryl group, and R²⁹ represents a hydrogen atom, in which R²⁶, R²⁷ and R²⁸ each may have a substituent, and at least one of R²⁶, R²⁷ and R²⁸ comprises an aromatic ring.

6. The polarizing plate as claimed in claim 1, wherein the resin contained in the transparent protective film is cellulose acylate.

7. The polarizing plate as claimed in claim 2, wherein the resin contained in the transparent protective film is cellulose acylate.

8. The polarizing plate as claimed in claim 3, wherein the resin contained in the transparent protective film is cellulose acylate.

9. The polarizing plate as claimed in claim 4, wherein the resin contained in the transparent protective film is cellulose acylate.

10. The polarizing plate as claimed in claim 5, wherein the resin contained in the transparent protective film is cellulose acylate.

11. The polarizing plate as claimed in claim 1, wherein the transparent protective film comprises a hydrophobizing agent.

12. The polarizing plate as claimed in claim 2, wherein the transparent protective film comprises a hydrophobizing agent.

13. The polarizing plate as claimed in claim 3, wherein the transparent protective film comprises a hydrophobizing agent.

14. The polarizing plate as claimed in claim 4, wherein the transparent protective film comprises a hydrophobizing agent.

15. The polarizing plate as claimed in claim 5, wherein the transparent protective film comprises a hydrophobizing agent.

16. The polarizing plate as claimed in claim 1, which further comprises a cohesive agent layer so that the transparent protective film, the adhesive layer, the polarizer and the cohesive agent layer are provided in this order.

17. The polarizing plate as claimed in claim 1, wherein the ratio of a molecular weight to an aromatic ring number is 160 or less.

18. The polarizing plate as claimed in claim 1, wherein the ratio of a molecular weight to an aromatic ring number is 130 or less.

19. The polarizing plate as claimed in claim 1, wherein the transparent protective film comprises the compound (A) in an amount of from 1 to 20 parts by weight based on 100 parts by weight of the at least one resin.

20. A liquid crystal display device comprising at least one of the polarizing plates as claimed in claim 1.
